(19) United States
(12) Patent Application Publication
(10) Pub. No.: US 2010/0055356 A1
(43) Pub. Date: Mar. 4, 2010

(54) CELLULOSE ACYLATE LAMINATE FILM, METHOD FOR PRODUCING SAME, POLARIZER AND LIQUID CRYSTAL DISPLAY DEVICE

(75) Inventors: Jun Takeda, Minami-ashigara-shi (JP); Hiromichi Tachikawa, Minami-ashigara-shi (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Minato-ku (JP)

(21) Appl. No.: 12/551,984

(22) Filed: Sep. 1, 2009

(30) Foreign Application Priority Data
Sep. 2, 2008 (JP) 2008-224959

(51) Int. Cl. C09K 19/52; B32B 7/02; B32B 23/00; B29C 41/22

(52) U.S. Cl. 428/1.31; 428/213; 428/532; 264/171.1

(57) ABSTRACT

A stretched cellulose acylate laminate film having a skin layer containing a cellulose acylate with a total degree of acyl substitution of more than 2.7 and a core layer containing a cellulose acylate with a total degree of acyl substitution of 2.0-2.7 wherein the core layer is thicker than the skin B layer and at least one of these layers contains a retardation-controlling agent, is excellent in high expressibility, little optical unevenness and good releasability from a support.

### BACKGROUND OF THE INVENTION

1. Field of the Invention

The present invention relates to a cellulose acylate laminate film, its production method, a polarizer and a liquid-crystal display device. More precisely, the invention relates to a laminate film produced by co-casting a cellulose acylate having a low degree of substitution and a cellulose acylate having a high degree of substitution, its production method, a polarizer and a liquid-crystal display device.

2. Description of the Related Art

For broadening the viewing angle and for removing a trouble of color change in a liquid-crystal display device, used is a retardation film having a specific retardation value, or a combination of such retardation films.

It is known that a cellulose acylate is advantageous for the main material of the retardation film and that the optical properties of the film depend on the degree of acyl substitution of the cellulose acylate. In particular, a cellulose acylate having a low degree of substitution has a high intrinsic birefringence, and therefore it is considered that a cellulose acylate can realize good optical expressibility suitable, for example, as VA-use retardation films by reducing the degree of acyl substitution thereof. However, reducing the degree of acyl substitution of a cellulose acylate may bring about various problems in forming the cellulose acylate into its films, and heretofore the technique could not be applicable to practical use. Concretely, it is known that, when a cellulose acylate having a reduced degree of acyl substitution is cast as a solution thereof onto a support, the releasability of the formed film from the support is poor, therefore causing various problem in that the film is difficult to release from the support, and even when the film can be released, it may have some streaks running in the surface of the released film in the direction perpendicular to the machine direction of the film.

On the other hand, in the field of photosensitive materials, for removing troubles of poor releasability and streaky unevenness of a film of a cellulose acylate having a reduced degree of acyl substitution, there is proposed a method of producing a laminate film according to a co-casting process (for example, JP-A 6-134933). JP-A 6-134933 proposes a method for producing a cellulose triacetate laminate film, which comprises co-casting a dope containing a cellulose triacetate prepared from cotton and a dope containing a cellulose triacetate prepared from pulp in such a manner that the dope containing a cellulose acetate prepared from cotton can be in direct contact with a casting support. JP-A 6-134933 discloses a possibility of improving the releasability of the formed film by employing the co-casting method and by providing a cellulose triacetate layer having a lower releasing power produced from cotton on the side of the support. However, in JP-A 6-134933, a cellulose triacetate produced from pulp is used as the core layer, and nothing is suggested therein relating to using a cellulose acylate having a low degree of substitution as the core layer.

JP-A 8-207210 proposes a cellulose acetate laminate film having a core part formed of a cellulose acetate having a degree of substitution of at most 2.7, and having, on at least one surface of the core part, a surface layer having a thickness of from 0.5 μm to 15 μm and formed of a cellulose acetate having a degree of substitution of at least 2.8. This patent reference discloses the possibility of reducing the solvent ingredient remaining inside the film by co-casting cellulose acylates that differ from each other in degree of substitution thereof. However, this refers to nothing at all relating to a technique of stretching the laminate film for making it express optical properties necessary for retardation films and relating to the optical properties of the obtained film.

On the other hand, JP-A 2007-283763 discloses an embodiment of using a cellulose acylate having a high degree of substitution for both a core layer and a skin layer and adding a retardation-controlling agent to each layer. However, this refers to nothing at all relating to the effect of the retardation-controlling agent added to the layers and relating to the optical properties of the obtained film.

### SUMMARY OF THE INVENTION

The present inventors produced a retardation film by co-casting a cellulose acylate having a low degree of substitution and a cellulose acylate having a high degree of substitution and excellent in the releasability from a support, but found that the fluctuation of the optical properties of the produced film is great and the film is unsuitable for retardation film. The present inventors have further made assiduous studies and, as a result, have clarified that, in co-casting, it is extremely difficult to make the film thickness distribution of each layer uniform in the cross direction thereof, and that the film thus having such a fluctuated film thickness distribution also has a fluctuated optical expressibility distribution. In particular, the inventors have found that, when there occurs a difference in the optical expressibility depending on the draw ratio in stretching the film, then the fluctuation of the optical properties of the film is further increased. Specifically, in case where a retardation film is produced according to a co-casting process of using a cellulose acylate having a low degree of substitution for the purpose of realizing the optical expressibility that could not be realized by the use of conventional cellulose acylate-type optical films, the releasability of the formed film could be enhanced but the fluctuation of the optical properties thereof also increases.

The present inventors tried using a cellulose acylate having a high degree of substitution for both a core layer and a skin layer and adding a retardation-controlling agent to each layer, but the expressibility of the optical properties of the film produced is still low and the film is still unsatisfactory for optical compensatory films for use in polarizers and liquid-crystal display devices.

To that effect, the current fact is that a cellulose acylate film satisfying both good releasability from a support and good optical properties could not be produced.

Taking the current fact as above into consideration, a first object of the present invention is to provide a cellulose acylate laminate film having high expressibility, little optical unevenness and good releasability from a support. A second object of the invention is to provide a method for producing the cellulose acylate laminate film, and to provide a polarizer and a liquid-crystal display device comprising the cellulose acylate laminate film.

The inventors have assiduously studied and, as a result, have found that the following cellulose acylate laminate film could solve the above problems, and have provided the invention described below.
[1] A cellulose acylate laminate film containing a core layer and a skin B layer, in which:

the core layer is thicker than the skin B layer

the core layer contains a cellulose acylate satisfying the following formula (1):

2.0<Z1<2.7, (1)

wherein Z1 means a total degree of acyl substitution of the cellulose acylate of the core layer,

the skin B layer contains cellulose acylate satisfying the following formula (2):

2.7<Z2, (2)

wherein Z2 means a total degree of acyl substitution of the cellulose acylate of the skin layer,

at least one of the core layer and the skin B layer contains a retardation-controlling agent, and

the film is stretched.
[2] The cellulose acylate laminate film of [1], wherein the skin B layer contains a retardation enhancer.
[3] The cellulose acylate laminate film of [1] or [2], wherein the core layer contains a retardation enhancer, and the skin B layer contains a retardation enhancer having a retardation-enhancing ability higher than that of the retardation enhancer in the core layer.
[4] The cellulose acylate laminate film of any one of [1] to [3], wherein the core layer contains a retardation reducer.
[5] The cellulose acylate laminate film of any one of [2] to [4], wherein the skin B layer contains a retardation reducer.
[6] The cellulose acylate laminate film of any one of [1] to [5], which has a skin A layer containing a cellulose acylate satisfying the following formula (2), on the side of the core layer opposite to the skin layer B:

2.7<Z2, (2)

wherein Z2 means a total degree of acyl substitution of the cellulose acylate of the skin layer.
[7] The cellulose acylate laminate film of any one of [1] to [6], wherein the in-plane retardation, Re, at a wavelength of 590 nm satisfies 25 nm≦|Re|≦100 nm, and the thickness-direction retardation, Rth, at a wavelength of 590 nm satisfies 50 nm≦|Rth|≦250 nm.
[8] The cellulose acylate laminate film of any one of [1] to [7], wherein at least one skin layer contains at least one in-plane retardation enhancer (Re enhancer).
[9] The cellulose acylate laminate film of any one of [1] to [8], wherein the core layer contains at least one thickness-direction retardation reducer (Rth reducer).
[10] The cellulose acylate laminate film of any one of [1] to [9], wherein at least one skin layer contains at least one Re enhancer and the core layer contains at least one Rth reducer.
[11] The cellulose acylate laminate film of any one of [1] to [10], wherein the core layer has a mean thickness of from 30 to 100 μm, and at least one of the skin A layer and the skin B layer has a mean thickness of from 0.2% to less than 25% of the mean thickness of the core layer.
[12] The cellulose acylate laminate film of any one of [1] to [11], wherein the film width is from 700 to 3000 mm and the fluctuation of the in-plane retardation (Re) of the film in the film width direction is at most 10 nm.
[13] The cellulose acylate laminate film of any one of [1] to [12], wherein the fluctuation of the thickness-direction retardation (Rth) of the film in the film width direction is at most 10 nm.
[14] The cellulose acylate laminate film of any one of [1] to [13], wherein at least one of the skin A layer and the skin B layer contains a matting agent.
[15] The cellulose acylate laminate film of any one of [1] to [14], wherein the cellulose acylate of the core layer satisfies the following formulae (3) and (4):

1.0<X1<2.7, (3)

wherein X1 means a degree of acetyl substitution of the cellulose acylate of the core layer,

0≦Y1<1.5, (4)

wherein Y1 means a total degree of substitution with acyl having at least 3 carbon atoms of the cellulose acylate of the core layer.
[16] The cellulose acylate laminate film of any one of [1] to [15], wherein the cellulose acylate of the skin A layer and the cellulose acylate of the skin B layer satisfy the following formulae (5) and (6):

1.2<X2<3.0, (5)

wherein X2 means a degree of acetyl substitution of the cellulose acylate of each skin layer,

0≦Y2<1.5, (6)

wherein Y2 means a total degree of substitution with acyl having at least 3 carbon atoms of the cellulose acylate of each skin layer.
[17] The cellulose acylate laminate film of any one of [1] to [16], wherein the acyl group of the cellulose acylate has from 2 to 4 carbon atoms.
[18] The cellulose acylate laminate film of any one of [1] to [17], which has an Nz factor represented by the following formula (7) of at most 7:

Nz factor=(Rth/Re)+0.5. (7)
[19] The cellulose acylate film of any one of [1] to [18], wherein the cellulose acylate is a cellulose acetate.
[20] The cellulose acylate laminate film of any one of [1] to [19], wherein the skin B layer contains a release promoter.
[21] A method for producing a cellulose acylate laminate film, comprising:

simultaneously or successively multilayer-casting a dope for a skin B layer containing a cellulose acylate satisfying the following formula (2) and a dope for a core layer containing a cellulose acylate satisfying the following formula (1) on a support in that order,

drying the multilayer-cast dope and peeling it from the support, and

stretching the peeled film,

wherein at least one of the dope for the core layer and the dope for the skin B layer contains a retardation-controlling agent:

2.0<Z1<2.7, (1)

wherein Z1 means a total degree of acyl substitution of the cellulose acylate of the core layer,

2.7<Z2, (2)

wherein Z2 means a total degree of acyl substitution of the cellulose acylate of the skin layer.
[22] The method for producing a cellulose acylate laminate film of [21], which comprises stretching the film again after peeling and stretching the film.
[23] A cellulose acylate laminate film, produced by the method for producing the cellulose acylate laminate film of [21] or [22].
[24] A polarizer comprising the cellulose acylate laminate film of any one of [1] to [20] and [23].
[25] A liquid crystal display device comprising the cellulose acylate laminate film of any one of [1] to [20] and [23].

According to the invention, there is provided a cellulose acylate laminate film having broad optical properties that could not be realized by conventional cellulose acylate films. There is also provided a cellulose acylate laminate film by solution-casting of cellulose acylates having a low degree of substitution followed by stretching the cast film. Further, there is provided a retardation film having uniform optical properties. The invention has made it possible to improve the releasability of a cast film from a support thereby removing a film formation trouble in a peeling process, especially dramatically removing a trouble of streaky unevenness of the film in the direction perpendicular to the machine direction of the film. Further, in a preferred embodiment of the invention where the film has a skin layer on both surfaces of a core layer, the physical properties of the film (e.g., curling resistance) can be bettered. The film and also a polarizer comprising the film are favorably used in a liquid-crystal display device, especially in a VA-mode liquid-crystal display device.

### BRIEF DESCRIPTION OF THE DRAWINGS

FIG. 1 is an outline view of one example of the constitution of a casting die and therearound.

FIG. 2 is an explanatory view of one example of co-casting in the invention.

In the drawings, 70 is a cast film, 85 is a running casting band, 120 is a dope for a core layer, 121 is a dope for a skin A layer, 122 is a dope for a skin B layer, 120a is a core layer, 121a is a skin A layer, 122a is a skin B layer, 150 is a die for a skin B layer (a support-facing layer), 151 is a die for a core layer (substrate layer), and 152 is a die for a skin A layer (an air-facing layer).

### BEST MODE FOR CARRYING OUT THE INVENTION

Description will now be made in detail of the invention. Although the following description of its structural features may often be made on the basis of typical embodiments of the invention, it is to be understood that the invention is not limited to any such embodiment. It is also to be noted that every numerical range as herein expressed by employing the words “from” and “to”, or simply the word “to”, or the symbol “˜” is supposed to include the lower and upper limits thereof as defined by such words or symbol, unless otherwise noted.

In this description, “retardation-controlling agent” is a compound that increases or decreases at least one of the in-plane direction retardation (hereinafter referred to as Re) of a film or a thickness-direction retardation (hereinafter referred to as Rth) of a film. “Retardation enhancer” is a compound that increases at least one of Re or Rth; and “retardation reducer” is a compound that decreases at least one of Re or Rth.

In this description, “core layer” is a layer having a largest thickness; and “skin layer” is a layer thinner than the core layer and kept in contact with the core layer.

In the description and the drawings, “skin layer” indicates both “skin A layer” and “skin B layer”. The “skin A layer” may be referred to as “air-facing layer”; and the “skin B layer” may be referred to as “support-facing layer”. “core layer” may be referred to as “substrate layer”.

In the invention, “mass %” means equal to “weight %”, and “% by mass” means equal to “% by weight”.

### [Cellulose Acylate Laminate Film]

The cellulose acylate laminate film of the invention (hereinafter this may be referred to as the film of the invention) contains a skin B layer containing a cellulose acylate satisfying the following formula (2) and a core layer thicker than the skin B layer and containing a cellulose acylate satisfying the following formula (1), wherein at least one of the core layer or the skin B layer contains a retardation-controlling agent, and the film is stretched:

2.0<Z1<2.7, (1)

wherein Z1 means a total degree of acyl substitution of the cellulose acylate of the core layer,

2.7<Z2, (2)

wherein Z2 means a total degree of acyl substitution of the cellulose acylate of the skin layer.

The most characteristic feature of the invention is that a cellulose acylate having a low degree of substitution and satisfying the above formula (1) is used for the core layer and that the film has a laminate structure; and having the constitution, the cellulose acylate laminate film of the invention may have an increased expressibility of optical properties as a whole.

Further, another characteristic feature of the invention is that a retardation-controlling agent is added to at least one of the core layer or the skin layer and the film is stretched. Accordingly, in the invention, even when there occurs a partial fluctuation of the thickness of the core layer and the skin layer, as technically inevitable in co-casting, the influence thereof on the optical properties of the whole laminate film may be reduced and Re and Rth of the film may be thereby prevented from fluctuating. Therefore, as compared with conventional cellulose acylate films, the cellulose acylate laminate film of the invention has high expressibility of optical properties and the fluctuation of the optical properties of the film is extremely small.

The characteristics and preferred embodiments of the film of the invention are described below.

### (Cellulose Acylate Resin)

The cellulose acylate used in the cellulose acylate laminate film of the invention is not specifically limited in case where the cellulose acylate satisfies the formula (1) and the formula (2).

Cellulose used as a starting material in preparation for the cellulose acylate used in the invention includes cotton linter and wood pulp (broadleaf pulp, coniferous pulp), etc. Any cellulose acylate obtained from any of such a starting cellulose may be used. As the case may be, a mixture of different cellulose acylates may also be used herein. The details of the cellulose as a starting material are described, for example, in “Plastic Material Lecture (17), Cellulosic Resin” (written by Marusawa, Uda, published by Nikkan Kogyo Shinbun-sha, 1970); and Hatsumei Kyokai Disclosure Bulletin 2001-1745 (pp. 7-8).

### (Cellulose Acylate)

Description will first be made in detail of the cellulose acylate preferably used for the purpose of the invention. The glucose units having a β-1, 4 bond and forming the cellulose have free hydroxyl groups in the 2-, 3- and 6-positions thereof. The cellulose acylate is a polymer obtained by esterifying a part or all of those hydroxyl groups with an acyl group. Its acyl substitution degree means the total of the esterification degrees of cellulose in the 2-, 3- and 6-positions (an esterification degree of 100% meaning a substitution degree of 1).

The Z1 preferably satisfies:

2.1<Z1<2.6,

more preferably satisfies:

2.3<Z1<2.5.

The Z2 preferably satisfies:

2.75<Z1<2.95,

more preferably satisfies:

2.80<Z1<2.95.

From the view point of improving and increasing the expressibility of optical properties, the cellulose acylate used in the core layer of the film of the invention more preferably satisfies the following formulae (3) and (4):

1.0<X1<2.7, (3)

wherein X1 means a degree of acetyl substitution of the cellulose acylate of the core layer,

0≦Y1<1.5, (4)

wherein Y1 means a total degree of substitution with acyl having at least 3 carbon atoms of the cellulose acylate of the core layer.

The X1 preferably satisfies:

1.5<X1<2.7,

more preferably satisfies:

2.0<X1<2.7.

The Y1 preferably satisfies:

0≦Y1<1.3,

more preferably satisfies:

0≦Y1<1.0.

From the view point of improving and increasing the expressibility of optical properties and of improving the releasability from a support, the cellulose acylate used in the skin A layer and the skin B layer of the film of the invention further preferably satisfies the following formulae (5) and (6):

1.2<X2<3.0, (5)

wherein X2 means a degree of acetyl substitution of the cellulose acylate of the skin layer,

0≦Y2<1.5, (6)

wherein Y2 means a total degree of substitution with acyl having at least 3 carbon atoms of the cellulose acylate of the skin layer.

The X2 preferably satisfies:

1.5<X2<3.0,

more preferably satisfies:

1.8<X2<3.0.

The Y2 preferably satisfies:

0≦Y2<1.3,

more preferably satisfies:

0≦Y2<1.0.

The film of the invention further preferably has a skin A layer containing a cellulose acylate satisfying the following formula (2), on the side of the core layer opposite to the skin layer B from the view point of appropriately controlling the physical property (carling) of the film:

2.7<Z2, (2)

wherein Z2 means a total degree of acyl substitution of the cellulose acylate of the skin layer.

The acyl group in the cellulose used in the invention may be an aliphatic group or an aryl group, and are not particularly limited. They may be an alkylcarbonyl ester of cellulose, an alkenylcarbonyl ester of cellulose, an aromatic carbonyl ester of cellulose or an aromatic alkylcarbonyl ester of cellulose. These esters may have a substituent. Preferable examples of the substituents include an acetyl group, a propionyl group, a butanoyl group, a heptanoyl group, a hexanoyl group, an octanoyl group, a decanoyl group, a dodecanoyl group, a tridecanoyl group, a tetradecanoyl group, a hexadecanoyl group, an octadecanoyl group, an isobutanoyl group, a tert-butanoyl group, a cyclohexanecarbonyl group, an oleoyl group, a benzoyl group, a naphthylcarbonyl group and a cinnamoyl group. An acetyl group, a propionyl group, a butanoyl group, a dodecanoyl group, an octadecanoyl group, a tert-butanoyl group, an oleoyl group, a benzoyl group, a naphthylcarbonyl group and a cinnamoyl group are more preferred, and an acetyl group, a propionyl group and a butanoyl group (in case where the acyl group has from 2 to 4 carbon atoms) are particularly preferred, and the most preferred is an acetyl group (in case where the cellulose acylate is a cellulose acetate).

In acylation of cellulose, when an acid anhydride or an acid chloride is used as the acylating agent, the organic solvent as the reaction solvent may be an organic acid, such as acetic acid, or methylene chloride or the like.

When the acylating agent is an acid anhydride, the catalyst is preferably a protic catalyst such as sulfuric acid; and when the acylating agent is an acid chloride (e.g., CH₃CH₂COCl), a basic compound may be used as the catalyst.

A most popular industrial production method for a mixed fatty acid ester of cellulose comprises acylating cellulose with a fatty acid corresponding to an acetyl group and other acyl groups (e.g., acetic acid, propionic acid, valeric acid, etc.), or with a mixed organic acid ingredient containing their acid anhydride.

The cellulose acylate for use in the invention can be produced, for example, according to the method described in JP-A 10-45804.

To the film of the invention, additives may be added, for example, a retardation-controlling agent (retardation enhancer, retardation reducer); plasticizer such as phthalate, phosphate, etc.; UV absorbent; antioxidant; matting agent, etc.

### <Retardation-Controlling Agent>

The retardation-controlling agent is not specifically defined except for the above-mentioned properties thereof. In case where the above-mentioned plasticizer, UV absorbent, antioxidant, matting agent and the like additive are used as the retardation-controlling agent, these additives are within the scope of the concept of the retardation-controlling agent in the invention.

### (Retardation Reducer)

As the retardation reducer in the invention, a high-molecular-weight additive and a low-molecular-weight additive known as additives to cellulose acylate films can be widely employed. The content of the additive may be from 1 to 35% by weight of the cellulose resin, preferably from 4 to 30% by weight, more preferably from 10 to 25% by weight. When the amount of the additive added is less than 1% by weight, then the film could not follow the ambient temperature and humidity change; but when more than 30% by weight, the film may whiten. When the additive content oversteps the range, the physical properties of the film may also be poor.

The high-molecular-weight additive for use in the film of the invention as the retardation reducer is a compound having repetitive units therein, preferably having a number-average molecular weight of from 700 to 100000. The high-molecular-weight additive serves to promote the solvent vaporization speed and to reduce the residual solvent amount in a solution casting process. Further, the high-molecular-weight additive added to the film of the invention is effective from the viewpoint of reforming the film of, for example, enhancing the mechanical properties of the film, imparting flexibility and water absorption resistance to the film and reducing the moisture permeability of the film.

The high-molecular additive for use in the invention more preferably has a number-average molecular weight from 700 to 8000, further preferably from 700 to 5000, particularly preferably 1000 to 5000. The high-molecular additive having a number-average molecular weight in such range has higher compatibility with the cellulose acylate.

Description will be made in detail of the high-molecular additives used in the invention with reference to the specific examples. However, the high-molecular additives used in the invention are not limited thereto.

The high-molecular-weight additive is preferably selected from polyester-type polymers, styrenic polymers, acrylic polymers and their copolymers, more preferably from aliphatic polyesters, acrylic polymers and styrenic polymers. Also preferably, the additive contains at least one polymer having a negative intrinsic birefringence, such as styrenic polymers and acrylic polymers.

The polyester-type polymers for use in the invention is one produced by reaction of a mixture of an aliphatic dicarboxylic acid having from 2 to 20 carbon atoms, and a diol selected from the group consisting of aliphatic diols having from 2 to 12 carbon atoms and alkyl ether diols having from 4 to 20 carbon atoms, and both ends of the reaction product may be as such, or may be blocked by further reaction with a monocarboxylic acid or a monoalcohol. The terminal blocking may be effected for the reason that the absence of a free carboxylic acid in the plasticizer is effective for the storability of the plasticizer. The dicarboxylic acid for the polyester plasticizer for use in the invention is preferably an aliphatic dicarboxylic having from 4 to 20 carbon atoms.

The aliphatic dicarboxylic acids having from 2 to 20 carbon atoms preferably for use in the film of the invention include, for example, oxalic acid, malonic acid, succinic acid, maleic acid, fumaric acid, glutaric acid, adipic acid, pimelic acid, suberic acid, azelaic acid, sebacic acid, dodecanedicarboxylic acid and 1,4-cyclohexanedicarboxylic acid.

More preferred aliphatic dicarboxylic acids in these are malonic acid, succinic acid, maleic acid, fumaric acid, glutaric acid, adipic acid, azelaic acid, 1,4-cyclohexanedicarboxylic acid. Particularly preferred dicarboxylic acids are succinic acid, glutaric acid and adipic acid.

The diol used for the high-molecular additive are selected, for example, from aliphatic diols having from 2 to 20 carbon atoms, alkyl ether diols having from 4 to 20 carbon atoms.

Examples of the aliphatic diol having from 2 to 20 carbon atoms include an alkyldiol and an aliphatic diol. For example, an ethandiol, 1,2-propandiol, 1,3-propandiol, 1,2-butandiol, 1,3-butandiol, 2-methyl-1,3-propandiol, 1,4-butandiol, 1,5-pentandiol, 2,2-dimethyl-1,3-propandiol(neopentyl glycol), 2,2-diethyl-1,3-propandiol(3,3-dimethylolpentane), 2-n-buthyl-2-ethyl-1,3-propandiol(3,3-dimethylolheptane), 3-methyl-1,5-pentandiol, 1,6-hexandiol, 2,2,4-trimethyl-1,3-pentandiol, 2-ethyl-1,3-hexandiol, 2-methyl-1,8-octandiol, 1,9-nonandiol, 1,10-decandiol, 1,12-octadecandiol, etc. One or more of these glycols may be used either singly or as combined mixture.

Specific examples of preferred aliphatic diols include an ethandiol, 1,2-propandiol, 1,3-propandiol, 1,2-butandiol, 1,3-butandiol, 2-methyl-1,3-propandiol, 1,4-butandiol, 1,5-pentandiol, 3-methyl-1,5-pentandiol, 1,6-hexandiol, 1,4-cyclohexandiol, 1,4-cyclohexandimethanol. Particularly preferred examples include ethandiol, 1,2-propandiol, 1,3-propandiol, 1,2-butandiol, 1,3-butandiol, 1,4-butandiol, 1,5-pentandiol, 1,6-hexandiol, 1,4-cyclohexandiol, 1,4-cyclohexanedimethanol.

Specific examples of preferred alkyl ether diols having from 4 to 20 carbon atoms are polytetramethylene ether glycol, polyethylene ether glycol and polypropylene ether glycol, and combinations of these. The average degree of polymerization is not limited in particular, and it is preferably from 2 to 20, more preferably 2 to 10, further preferably from 2 to 5, especially preferably from 2 to 4. As these examples, Carbowax resin, Pluronics resin and Niax resin are commercially available as typically useful polyether glycols.

In the invention, especially preferred is a high-molecular additive of which the terminal is blocked with an alkyl group or an aromatic group. The terminal protection with a hydrophobic functional group is effective against aging at high temperature and high humidity, by which the hydrolysis of the ester group is retarded.

Preferably, the polyester plasticizer in the invention is protected with a monoalcohol residue or a monocarboxylic acid residue in order that both ends of the polyester plasticizer are not a carboxylic acid or a hydroxyl group. In this case, the monoalcohol residue is preferably a substituted or unsubstituted monoalcohol residue having from 1 to 30 carbon atoms, including, for example, aliphatic alcohols such as methanol, ethanol, propanol, isopropanol, butanol, isobutanol, pentanol, isopentanol, hexanol, isohexanol, cyclohexyl alcohol, octanol, isooctanol, 2-ethylhexyl alcohol, nonyl alcohol, isononyl alcohol, tert-nonyl alcohol, decanol, dodecanol, dodecahexanol, dodecaoctanol, allyl alcohol, oleyl alcohol; and substituted alcohols such as benzyl alcohol, 3-phenylpropanol.

Alcohol residues for terminal blocking that are preferred for use in the invention are methanol, ethanol, propanol, isopropanol, butanol, isobutanol, isopentanol, hexanol, isohexanol, cyclohexyl alcohol, isooctanol, 2-ethylhexyl alcohol, isononyl alcohol, oleyl alcohol, benzyl alcohol, more preferably methanol, ethanol, propanol, isobutanol, cyclohexyl alcohol, 2-ethylhexyl alcohol, isononyl alcohol, benzyl alcohol.

In blocking with a monocarboxylic acid residue, the monocarboxylic acid for use as the monocarboxylic acid residue is preferably a substituted or unsubstituted monocarboxylic acid having from 1 to 30 carbon atoms. It may be an aliphatic monocarboxylic acid or an aromatic monocarboxylic acid. Preferred aliphatic monocarboxylic acids are described. They include acetic acid, propionic acid, butanoic acid, caprylic acid, caproic acid, decanoic acid, dodecanoic acid, stearic acid, oleic acid. Preferred aromatic monocarboxylic acids are, for example, benzoic acid, p-tert-butylbenzoic acid, orthotoluic acid, metatoluic acid, paratoluic acid, dimethylbenzoic acid, ethylbenzoic acid, normal-propylbenzoic acid, aminobenzoic acid, acetoxybenzoic acid. One or more of these may be used either singly or as combined.

The high-molecular additive for use in the invention may be easily produced according to any of a thermal melt condensation method of polyesterification or interesterification of the above-mentioned dicarboxylic acid and diol and/or monocarboxylic acid or monoalcohol for terminal blocking, or according to an interfacial condensation method of an acid chloride of those acids and a glycol in an ordinary manner. The polyester additives are described in detail in Koichi Murai's “Additives, Their Theory and Application” (by Miyuki Publishing, first original edition published on Mar. 1, 1973). The materials described in JP-A 05-155809, 05-155810, 05-197073, 2006-259494, 07-330670, 2006-342227, 2007-003679 are also usable herein.

The styrenic polymers preferably have the structural units derived from aromatic vinylic monomers represented by the following formula (1):

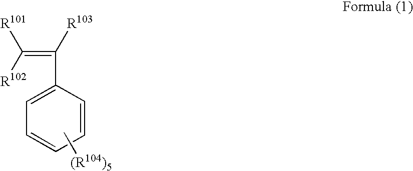

wherein R¹⁰¹ to R¹⁰⁴ each independently represent a hydrogen atom, a halogen atom, or a substituted or unsubstituted hydrocarbon group having from 1 to 30 carbon atoms and optionally having a linking group containing an oxygen atom, a sulfur atom, a nitrogen atom or a silicon atom, or a polar group; R¹⁰⁴'s may be all the same atoms or groups, or may be different atoms or groups, and they may bond to each other to form a carbon ring or a hetero ring (the carbon ring or the hetero ring may have a monocyclic structure or may have a polycyclic structure condensed with any other ring).

Specific examples of the aromatic vinylic monomer include styrene; alkyl-substituted styrenes such as α-methylstyrene, β-methylstyrene, p-methylstyrene; halogen-substituted styrenes such as 4-chlorostyrene, 4-bromostyrene; hydroxystyrenes such as p-hydroxystyrene, α-methyl-p-hydroxystyrene, 2-methyl-4-hydroxystyrene, 3,4-dihydroxystyrene; vinylbenzyl alcohols; alkoxy-substituted styrenes such as p-methoxystyrene, p-tert-butoxystyrene, m-tert-butoxystyrene; vinylbenzoic acids such as 3-vinylbenzoic acid, 4-vinylbenzoic acid; vinylbenzoates such as methyl 4-vinylbenzoate, ethyl 4-vinylbenzoate; 4-vinylbenzyl acetate; 4-acetoxystyrene; amidestyrenes such as 2-butylamidostyrene, 4-methylamidestyrene, p-sulfonamidestyrene; aminostyrenes such as 3-aminostyrene, 4-aminostyrene, 2-isopropenylaniline, vinylbenzyldimethylamine; nitrostyrenes such as 3-nitrostyrene, 4-nitrostyrene; cyanostyrenes such as 3-cyanostyrene, 4-cyanostyrene; vinylphenylacetonitrile; arylstyrenes such as phenylstyrene; indenes, etc. However, the invention should not be limited to these examples. Two or more different such monomers may be copolymerized to give copolymers for use herein. Of those, preferred are styrene and α-methylstyrene, from the viewpoint that they are easily available industrially and are inexpensive.

The acrylic polymers preferably have the structural units derived from acrylate monomers of the following formula (2):

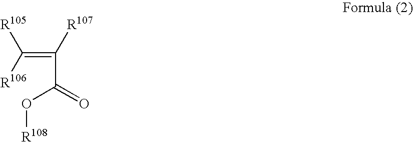

wherein R¹⁰⁵ to R¹⁰⁸ each independently represent a hydrogen atom, a halogen atom, or a substituted or unsubstituted hydrocarbon group having from 1 to 30 carbon atoms optionally having a linking group containing an oxygen atom, a sulfur atom, a nitrogen atom or a silicon atom, or a polar group.

Examples of the acrylate monomers include, for example, methyl acrylate, ethyl acrylate, (i-, n-)propyl acrylate, (n-, i-, s-, tert-)butylacrylate, (n-, i-, s-)pentyl acrylate, (n-, i-)hexyl acrylate, (n-, 1-)heptyl acrylate, (n-, i-)octyl acrylate, (n-, i-)nonyl acrylate, (n-, i-)myristyl acrylate, (2-ethylhexyl)acrylate, (ε-caprolactone)acrylate, (2-hydroxyethyl)acrylate, (2-hydoxypropyl)acrylate, (3-hydroxypropyl acrylate, (4-hydroxybutyl)acrylate, (2-hydroxybutyl)acrylate, (2-methoxyethyl)acrylate, (2-ethoxyethyl)acrylate, phenyl acrylate, phenyl methacrylate, (2 or 4-chlorophenyl)acrylate, (2 or 4-chlorophenyl)methacrylate, (2 or 3 or 4-ethoxycarbonylphenyl)acrylate, (2 or 3 or 4-ethoxycarbonylphenyl)methacrylate, (o or m or p-tolyl)acrylate, (o or m or p-tolyl)methacrylate, benzyl acrylate, benzyl methacrylate, phenethyl acrylate, phenethyl methacrylate, (2-naphthyl)acrylate, cyclohexyl acrylate, cyclohexyl methacrylate, (4-methylcyclohexyl)acrylate, (4-methylcyclohexyl)methacrylate, (4-ethylcyclohexyl)acrylate, (4-ethylcyclohexyl)methacrylate, and methacrylates corresponding to the above-mentioned acrylates. However, the invention should not be limited to these examples. Two or more such monomers may be copolymerized into copolymers for use herein. Of those, preferred are methyl acrylate, ethyl acrylate, (i-, n-)propyl acrylate, (n-, i-, s-, tert-)butyl acrylate, (n-, i-, s-)pentyl acrylate, (n-, i-)hexyl acrylate, and methacrylates corresponding to these acrylates, from the viewpoint that they are easily available industrially and are inexpensive.

As the copolymer for use herein, preferred are the structural units derived from an aromatic vinylic monomer of the following formula (1) and an acrylate monomers of the following formula (2):

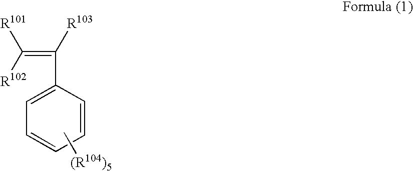

wherein R¹⁰¹ to R¹⁰⁴ each independently represent a hydrogen atom, a halogen atom, or a substituted or unsubstituted hydrocarbon group having from 1 to 30 carbon atoms and optionally having a linking group containing an oxygen atom, a sulfur atom, a nitrogen atom or a silicon atom, or a polar group; R¹⁰⁴'s may be all the same atoms or groups, or may be different atoms or groups, and they may bond to each other to form a carbon ring or a hetero ring (the carbon ring or the hetero ring may have a monocyclic structure or may have a polycyclic structure condensed with any other ring).

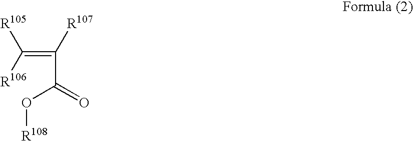

wherein R¹⁰⁵ to R¹⁰⁸ each independently represent a hydrogen atom, a halogen atom, or a substituted or unsubstituted hydrocarbon group having from 1 to 30 carbon atoms optionally having a linking group containing an oxygen atom, a sulfur atom, a nitrogen atom or a silicon atom, or a polar group. As the other structure than the above to constitute the copolymer composition, preferred are those excellent in the copolymerizability with the above-mentioned monomers, and their examples include acid anhydrides such as maleic anhydride, citraconic anhydride, cis-1-cyclohexene-1,2-dicarboxylic acid anhydride, 3-methyl-cis-1-cyclohexene-1,2-dicarboxylic acid anhydride, 4-methyl-cis-1-cyclohexene-1,2-dicarboxylic acid anhydride; nitrile group-containing radical-polymerizable monomers such as acrylonitrile, methacrylonitrile; amide bond-containing radical-polymerizable monomers such as acrylamide, methacrylamide, trifluoromethanesulfonylaminomethyl(meth)acrylate; aliphatic vinyls such as vinyl acetate; chlorine-containing radical-polymerizable monomers such as vinyl chloride, vinylidene chloride; conjugated diolefins such as 1,3-butadiene, isoprene, 1,4-dimethylbutadiene, etc. However, the invention should not be limited to these examples. Of those, especially preferred are styrene/acrylic acid copolymers, styrene/maleic anhydride copolymers and styrene/acrylonitrile copolymers.

### (Low-Molecular-Weight Additive)

The low-molecular-weight additive is described below. This may be solid or oily. In other words, the additive is not specifically defined in point of the melting point or the boiling point thereof. For example, UV absorbent materials having a melting point or a boiling point of 20° C. or higher, or higher than 20° C. may be mixed, or antioxidants may be mixed similarly. Also usable are IR-absorbing dyes as in JP-A 2001-194522. Regarding the time for its addition, the additive may be added in any stage of preparing the cellulose acylate solution (dope), but may be added in an additional step after the dope preparation. The amount of the additive material is not specifically defined, so far as the added material can express its function.

Examples of the low-molecular-weight additives include compounds represented by the following formulae (3) to (7), however the low-molecular-weight additives used in the invention is not limited thereto.

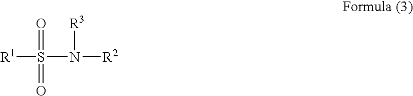

wherein R¹ represents an alkyl group or an aryl group, and each of R² and R³ represent, independently from each other, a hydrogen atom, an alkyl group or an aryl group. The total number of carbon atoms of R¹, R² and R³ is 10 or more.

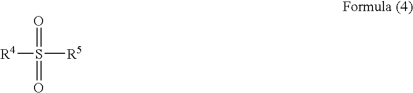

wherein each of R⁴ and R⁵ represent, independently from each other, an alkyl group or an aryl group. The total number of carbon atoms of R⁴ and R⁵ is 10 or more.

In the formulae (3) and (4), the respective alkyl and aryl groups may have a substituent. As a substituent, a fluorine atom, an alkyl group, an aryl group, an alkoxy group, a sulfone group and a sulfonamido group are preferred, and an alkyl group, an aryl group, an alkoxy group, a sulfone group and a sulfonamido group are particularly preferred. The alkyl group may be of straight chain, branched chain or cycle. Number of carbon atoms thereof is preferably 1-25, more preferably 6-25, particularly preferably 6-20 (for example, a methyl group, an ethyl group, a propyl group, an isopropyl group, a butyl group, an isobutyl group, a tert-butyl group, an amyl group, an isoamyl group, a tert-amyl group, a hexyl group, a cyclohexyl group, a heptyl group, an octyl group, a bicyclooctyl group, a nonyl group, an adamantyl group, a decyl group, a tert-octyl group, an undecyl group, a dodecyl group, a tridecyl group, a tetradecyl group, a pentadecyl group, a hexadecyl group, a heptadecyl group, an octadecyl group, a nonadecyl group and a didecyl group). Number of carbon atoms of the aryl group is preferably 6-30, particularly preferably 6-24 (for example, a phenyl group, a biphenyl group, a terphenyl group, a naphthyl group, a binaphthyl group and a triphenylphenyl group). Preferable examples of the compound represented by the formula (3) or (4) are shown below, however the invention is not restricted to these specific examples.

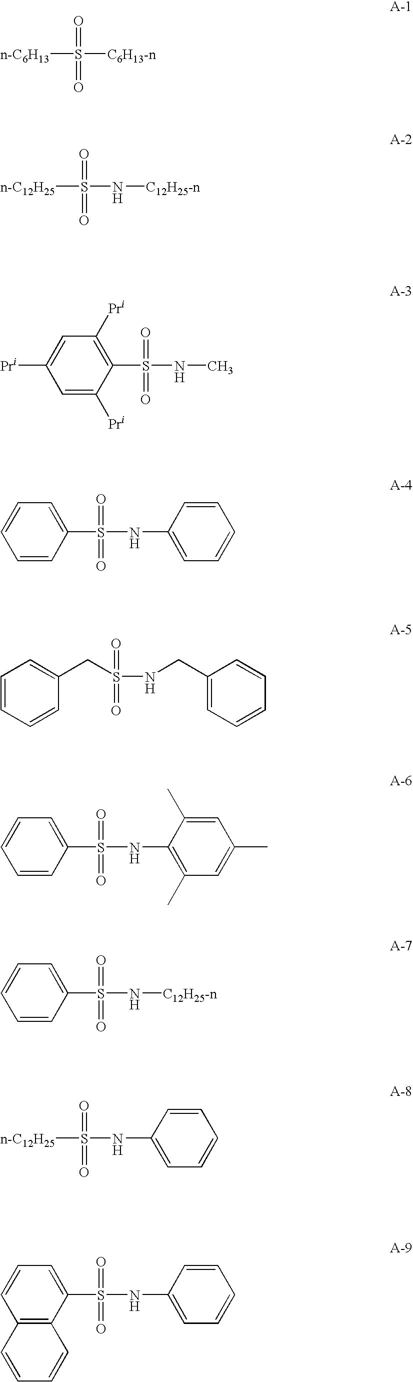

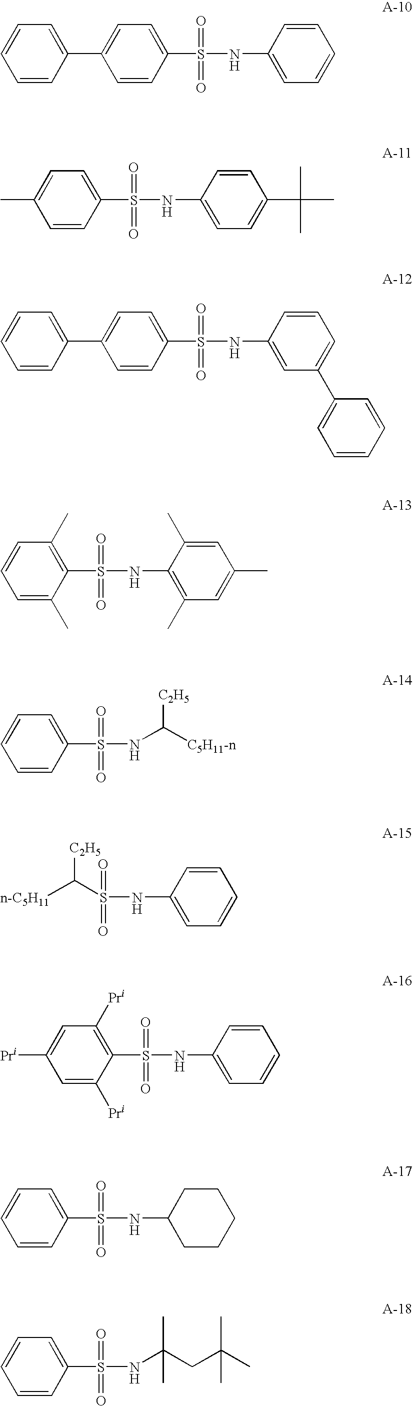

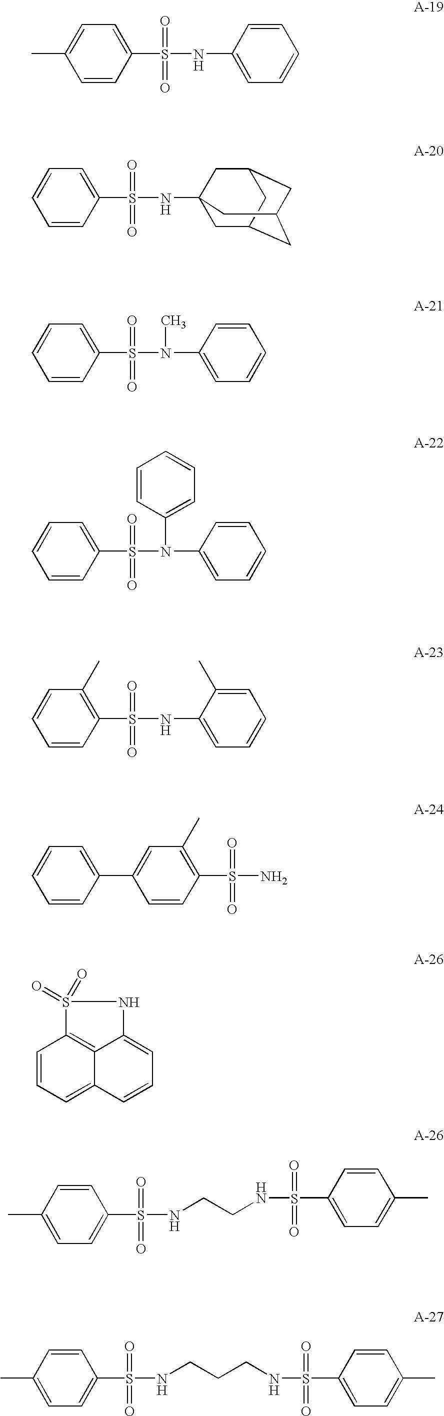

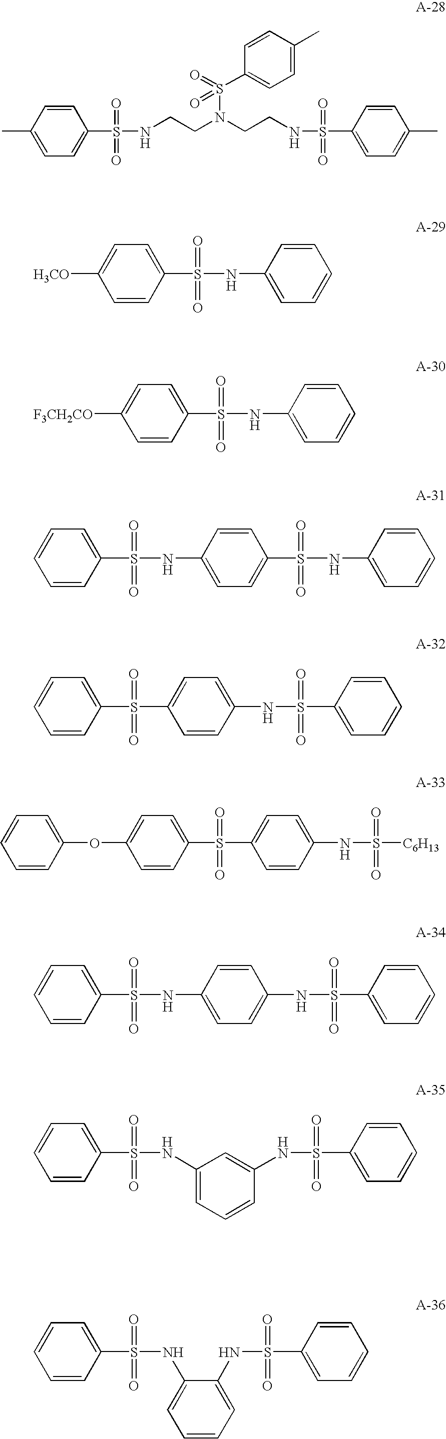

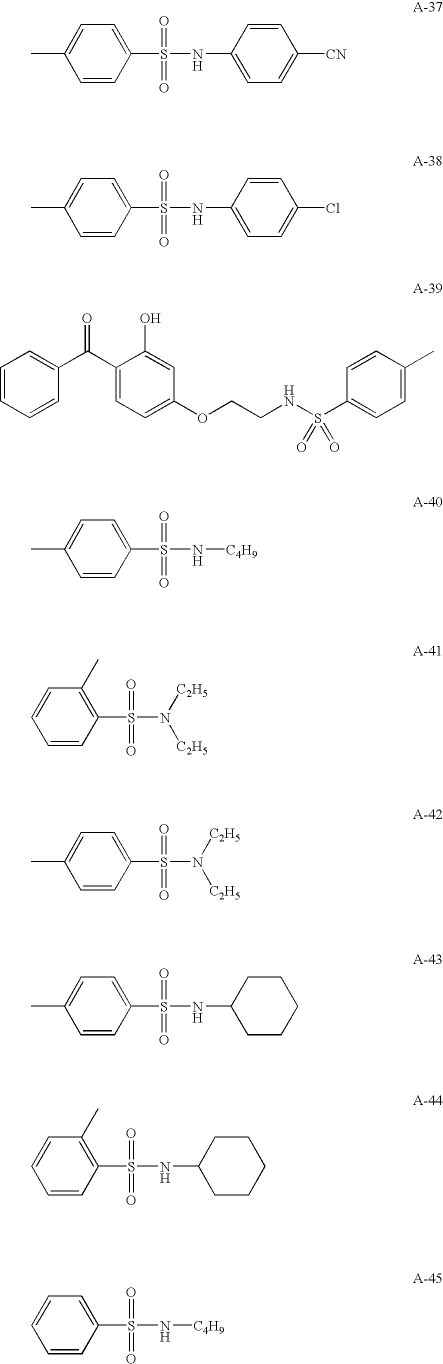

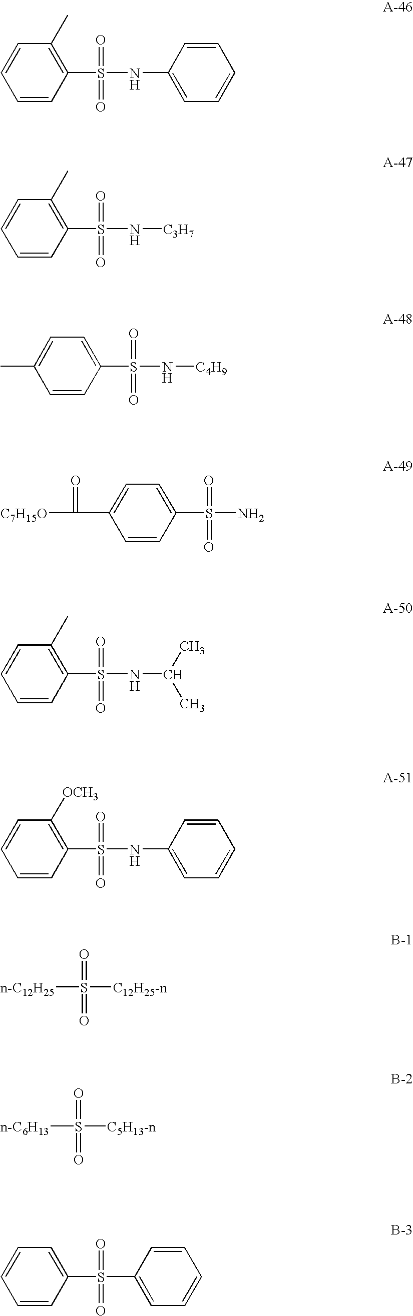

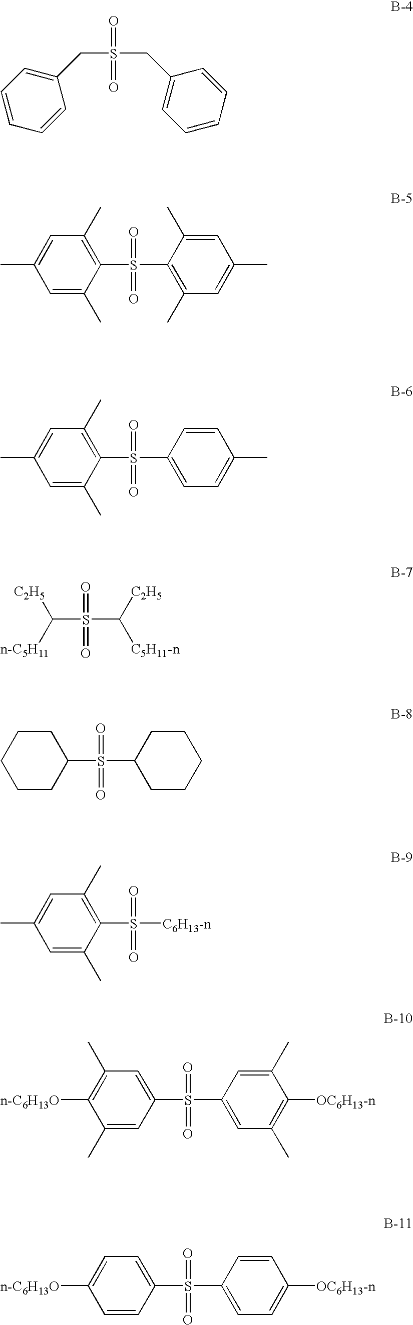

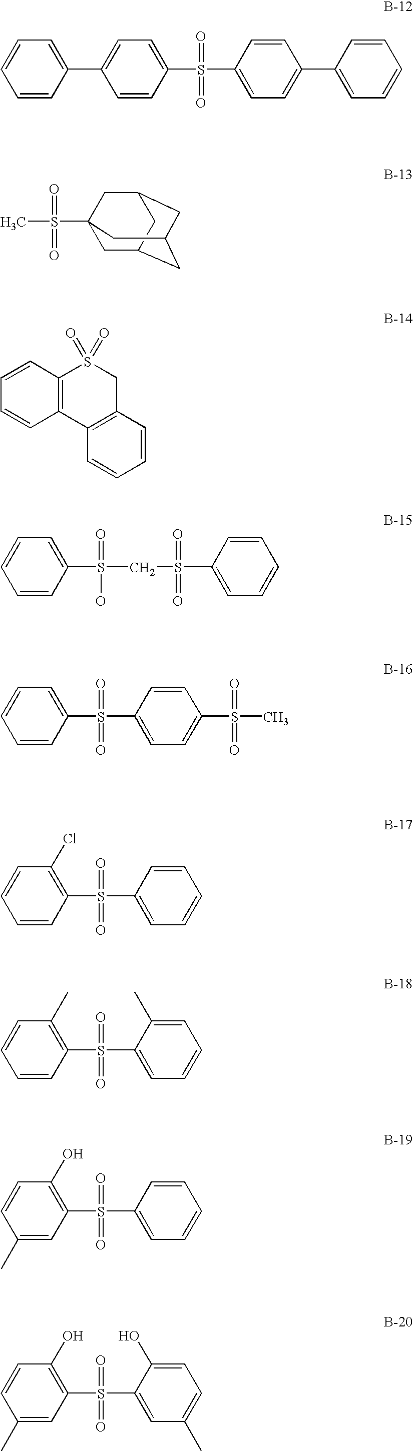

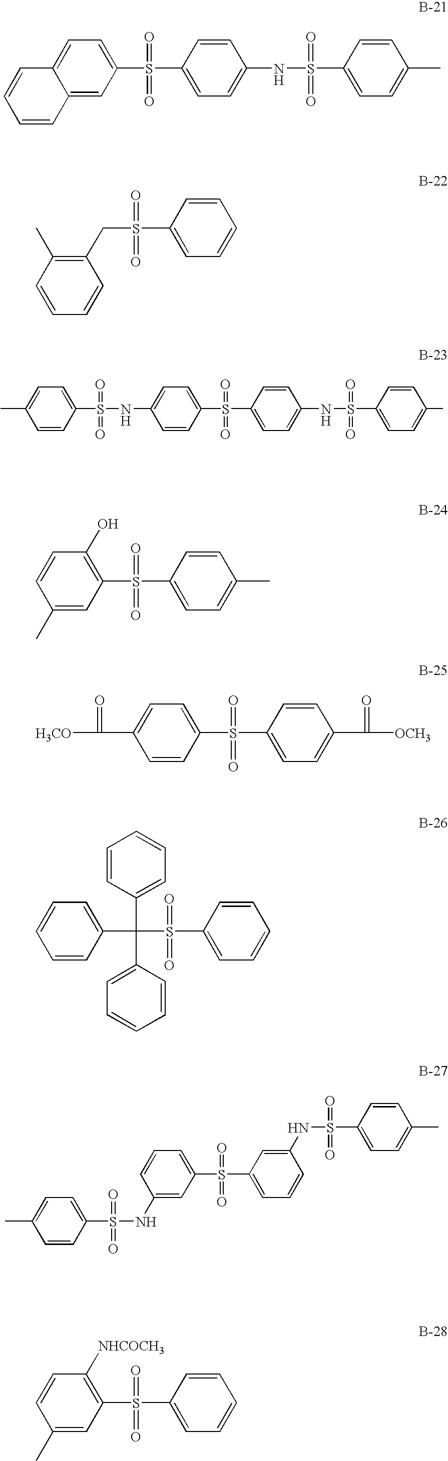

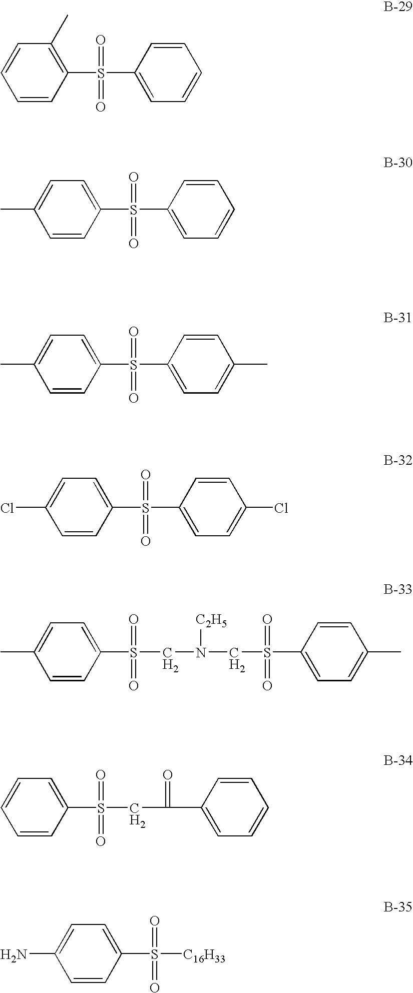

The compounds of formula (3) or formula (4) may be produced according to the following methods.

The compound of formula (3) may be produced through condensation of a sulfonyl chloride derivative and an amine derivative. The compound of formula (4) may be produced through oxidation or a sulfide or Friedel-Crafts reaction of an aromatic compound and a sulfonic acid chloride.

The compound of formula (5) is described in detail hereinunder.

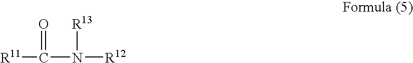

In the formula (3) and (4), R¹¹ represents an aryl group. Each of R¹² and R¹³ represent, independently from each other, an alkyl group or an aryl group, and at least one of R¹² or R¹³ is an aryl group. Where R¹² is an aryl group R¹³ may be an alkyl group or an aryl group, more preferably an alkyl group. The alkyl group may be a straight chain, branched chain or cycle, and number of carbon atoms thereof is preferably 1-20, more preferably 1-15, most preferably 1-12. Number of carbon atoms of the alkyl group is preferably 6-36, more preferably 6-24.

The compound of formula (6) is described in detail hereinunder.

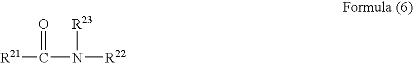

In the formula (6), each of R²¹, R²² and R²³ represent, independently from each other, an alkyl group. The alkyl group may be a straight chain, branched chain or cycle. Preferably, R²¹ is a cyclic alkyl group, and more preferably at least one of R²² or R²³ is an cyclic alkyl group. Number of carbon atoms thereof is preferably 1-20, more preferably 1-15, most preferably 1-12. As a cyclic alkyl group, a cyclohexyl group is particularly preferred.

The alkyl group and aryl group of the formulae (5) and (6) may have a substituent. Examples of the substituent include, preferably, a halogen atom (for example, chlorine, bromine, fluorine and iodine), an alkyl group, an aryl group, an alkoxy group, an aryloxy group, an acyl group, an alkoxycarbonyl group, an aryloxycarbonyl group, an acyloxy group, a sulfonylamino group, a hydroxyl group, a cyano group, an amino group and an acylamino group, more preferably a halogen atom, an alkyl group, an aryl group, an alkoxy group, an aryloxy group, a sulfonylamino group and an acylamino group, particularly preferably an alkyl group, an aryl group, a sulfonylamino group and an acylamino group.

Preferable examples of the compound represented by the formulae (5) and (6) are shown below, however compounds usable in the invention are not restricted to these specific examples.

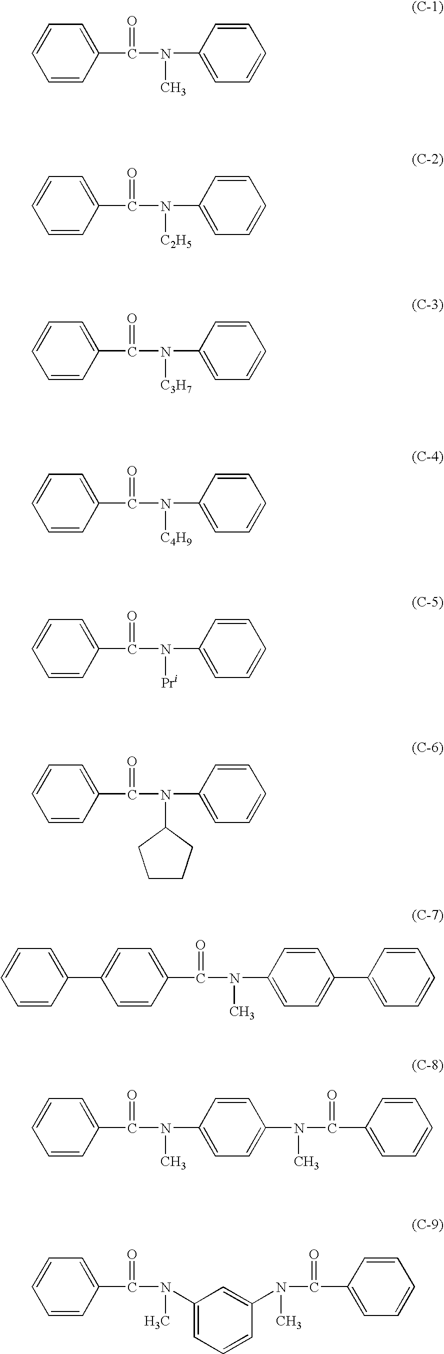

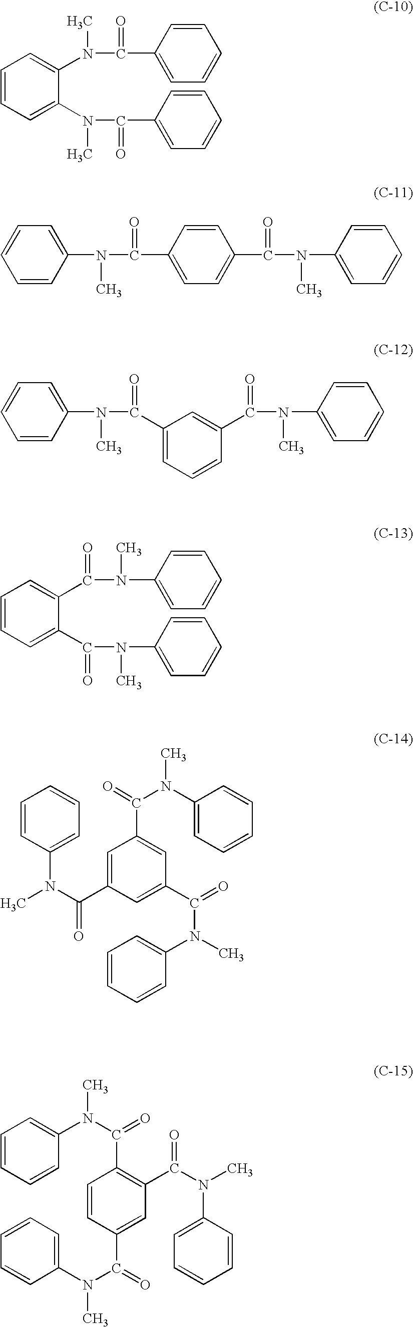

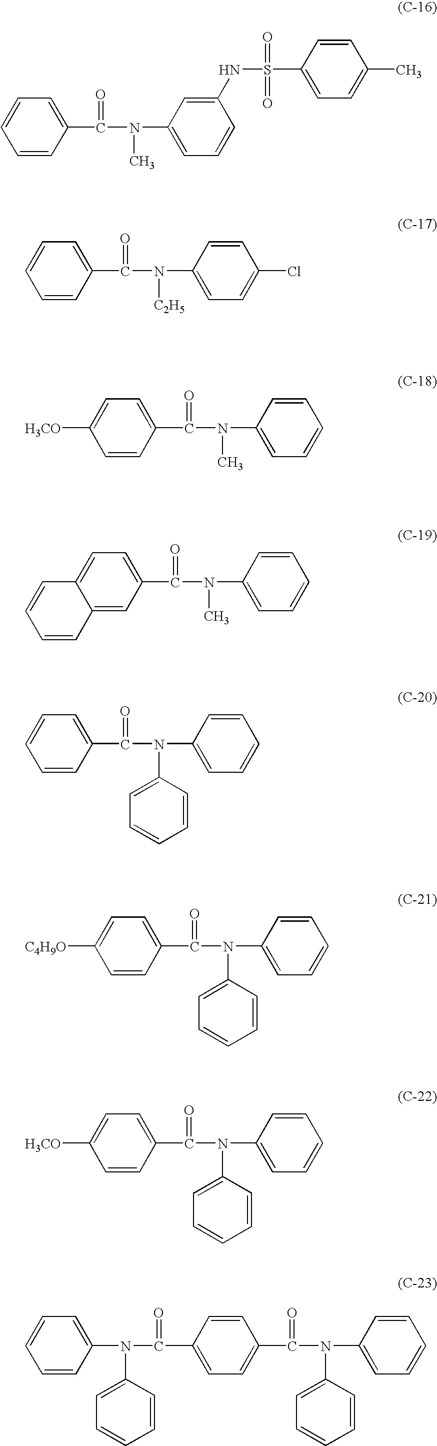

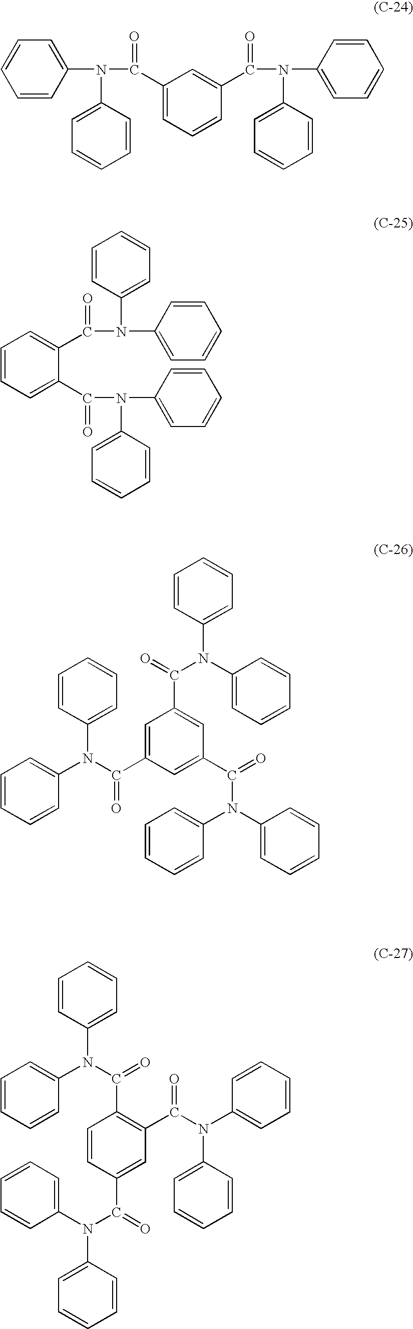

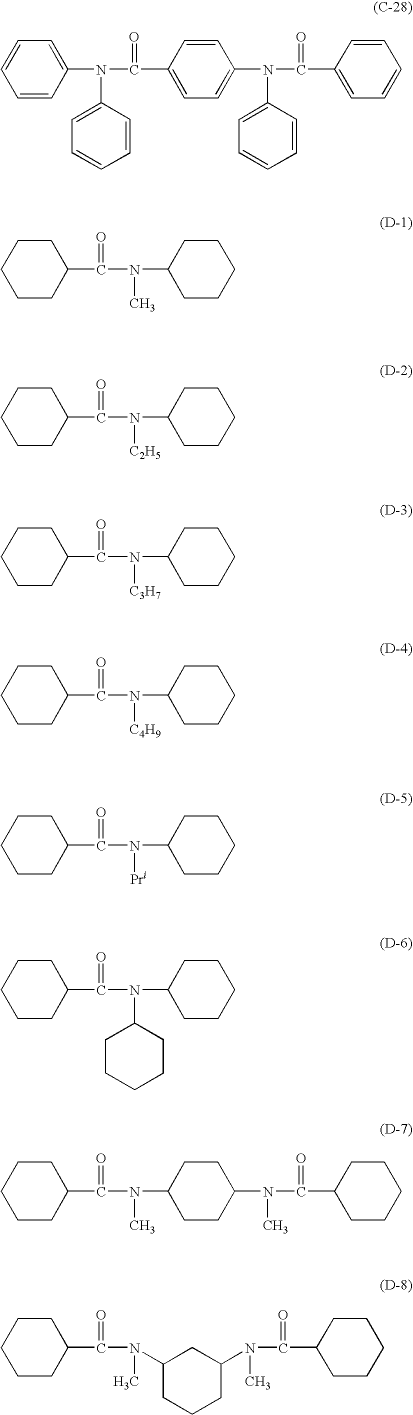

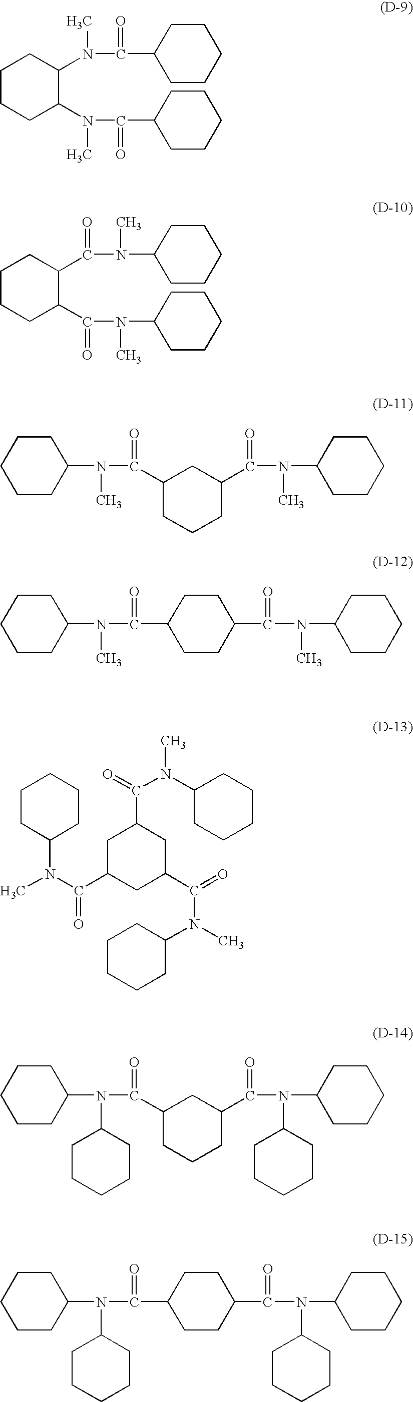

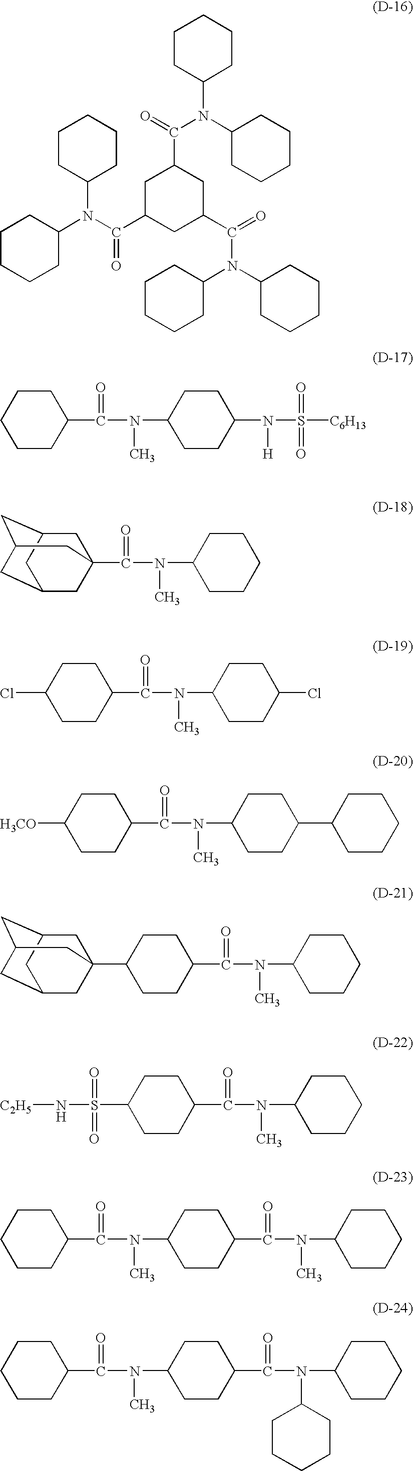

The compound of formula (7) is described in detail hereinunder.

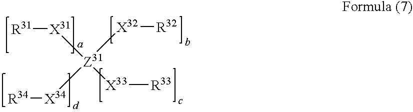

In the above formula (7), R³¹, R³², R³³ and R³⁴ each represent a hydrogen atom, a substituted or unsubstituted aliphatic group, or a substituted or unsubstituted aromatic group, preferably an aliphatic group. The aliphatic group may be linear, branched or cyclic, but is preferably cyclic. As the substituent that the aliphatic group and the aromatic group may have, mentioned are the substituents T given hereinunder; however, the groups are preferably unsubstituted.

X³¹, X³², X³³ and X³⁴ each represent a divalent linking group to be formed by at least one group selected from a single bond, —CO— and —NR³⁵— (R³⁵ represents a substituted or unsubstituted aliphatic group, or a substituted or unsubstituted aromatic group, and is preferably an unsubstituted one and/or an aliphatic group). The combination of X³¹, X³², X³³ and X³⁴ is not specifically defined, but is preferably selected from —CO— and —NR³⁵—. a, b, c and d each indicate an integer of 0 or more, and are preferably 0 or 1. a+b+c+d is 2 or more, preferably from 2 to 8, more preferably from 2 to 6, even more preferably from 2 to 4. Z³¹ represents a (a+b+c+d)-valent organic group (excluding cyclic ones). The valence of Z³¹ is preferably from 2 to 8, more preferably from 2 to 6, even more preferably from 2 to 4, most preferably 2 or 3. The organic group is a group of an organic compound.

As the compound of above formula (7), the compound of formula (7-1) is preferable.

R³¹¹—X³¹¹—Z³¹¹—X³¹²—R³¹² Formula (7-1)

In the above formula (7-1), R³¹¹ and R³¹² each represent a substituted or unsubstituted aliphatic group, or a substituted or unsubstituted aromatic group, preferably an aliphatic group. The aliphatic group may be linear, branched or cyclic, but is preferably cyclic. As the substituent that the aliphatic group and the aromatic group may have, mentioned are the substituents T given hereinunder; however, the groups are preferably unsubstituted. X³¹¹ and X³¹² each independently represent —CONR³¹³— or NR³¹⁴CO—; R³¹³ and R³¹⁴ each represent a substituted or unsubstituted aliphatic group, or a substituted or unsubstituted aromatic group, and are preferably an unsubstituted one and/or an aliphatic group. Z³¹¹ represents a divalent organic group (excluding cyclic ones) formed of one or more groups selected from —O—, —S—, —SO—, —SO₂—, —CO—, —NR³¹⁵— (R³¹⁵ represents a substituted or unsubstituted aliphatic group, or a substituted or unsubstituted aromatic group, and are preferably an unsubstituted one and/or an aliphatic group), an alkylene group and an arylene group. The combination for Z³¹¹ is not specifically defined, for which preferred are those selected from —O—, —S—, —NR³¹⁵— and an alkylene group, more preferred are those selected from —O—, —S— and an alkylene group.

As the compound of above formula (7-1), the compound of formulae (7-2) to (7-4) is preferable.

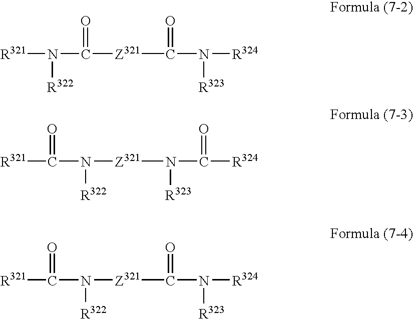

In the above formula (7-2) to (7-4), R³²¹, R³²², R³²³, and R³²⁴ each represent a substituted or unsubstituted aliphatic group, or a substituted or unsubstituted aromatic group, preferably an aliphatic group. The aliphatic group may be linear, branched or cyclic, but is preferably cyclic. As the substituent that the aliphatic group and the aromatic group may have, mentioned are the substituents T given hereinunder; however, the groups are preferably unsubstituted. Z³²¹ represents a divalent organic group (excluding cyclic ones) formed of one or more groups selected from —O—, —S—, —SO—, —SO₂—, —CO—, —NR³²⁵— (R³²⁵ represents a substituted or unsubstituted aliphatic group, or a substituted or unsubstituted aromatic group, and are preferably an unsubstituted one and/or an aliphatic group), an alkylene group and an arylene group. The combination for Z³²¹ is not specifically defined, for which preferred are those selected from —O—, —S—, —NR³²⁵— and an alkylene group, more preferred are those selected from —O—, —S— and an alkylene group, and most preferred are those selected from —O—, —S— and an alkylene group.

The substituted or unsubstituted aliphatic group is described in detail hereinunder. The aliphatic group may be a straight chain, a branch chain, or a circle, and numbers of the carbon atoms thereof is preferably 1-25, more preferably 6-25, and particularly preferably 6-20. Specific examples of the aliphatic group include, for example, methyl group, ethyl group, n-propyl group, isopropyl group, cyclopropyl group, n-butyl group, isobutyl group, tert-butyl group, amyl group, isoamyl group, tert-amyl group, n-hexyl group, cyclohexyl group, n-heptyl group, n-octyl group, bicyclooctyl group, adamantyl group, n-decyl group, tert-octyl group, dodecyl group, hexadecyl group, octadecyl group, didecyl group, etc.

The aromatic group is described in detail hereinunder.

The aromatic group may be an aromatic hydrocarbon group or an aromatic hetero ring group, and more preferably an aromatic hydrocarbon group. As the aromatic hydrocarbon group, number of carbon atoms thereof is preferably 6-24, further preferably 6-12. As an example of an aromatic hydrocarbon group, for example, benzene, naphthalene, anthracene, biphenyl, terphenyl, etc. As an aromatic hydrocarbon group, benzene, naphthalene and biphenyl are particularly preferable. As the aromatic hetero ring group, one containing at least one of an oxygen atom, a nitrogen atom, or a sulfur atom is preferable. As a specific example of the hetero ring, for example, furan, pyrrole, thiophene, imidazole, pyrazole, pyridine, and pyrazine, triazol, triazine, indole, indazole, purine, thiazoline, thiadiazol, oxazoline, oxazal, oxadiazole, quinoline, isoquinoline, phthalazine, naphthyridine, quinoxaline, quinazoline, cinnoline, pteridine, acridine, phenanthroline, phenazine, tetrazol, benzimidazole, benzoxazol, benzthiazol, benztriazol, tetrazaindene, etc. As the aromatic hetero ring group, pyridine, triazine and quinoline are particularly preferable.

The substituent T is described in detail hereinunder.

Examples of the substituent T include an alkyl group (including, preferably, 1-20 carbon atoms, more preferably 1-12 carbon atoms, particularly preferably 1-8 carbon atoms, such as a methyl group, an ethyl group, an isopropyl group, a tert-butyl group, a n-octyl group, a n-decyl group, a n-hexadecyl group, a cyclopropyl group, a cyclopentyl group and a cyclohexyl group), an alkenyl group (including, preferably, 2-20 carbon atoms, more preferably 2-12 carbon atoms, particularly preferably 2-8 carbon atoms, such as a vinyl group, an allyl group, a 2-butenyl group and a 3-pentenyl group), an alkynyl group (including, preferably, 2-20 carbon atoms, more preferably 2-12 carbon atoms, particularly preferably 2-8 carbon atoms, such as a propagyl group and a 3-pentynyl group), an aryl group (including, preferably, 6-30 carbon atoms, more preferably 6-20 carbon atoms, particularly preferably 6-12 carbon atoms, such as a phenyl group, a p-methylphenyl group and a naphthyl group), amino group (including, preferably, 0-20 carbon atoms, more preferably 0-10 carbon atoms, particularly preferably 0-6 carbon atoms, such as an amino group, a methylamino group, a dimethylamino group, a diethylamino group and a dibenzylamino group), an alkoxy group (including, preferably, 1-20 carbon atoms, more preferably 1-12 carbon atoms, particularly preferably 1-8 carbon atoms, such as a methoxy group, an ethoxy group and a butoxy group), an aryloxy group (including, preferably, 6-20 carbon atoms, more preferably 6-16 carbon atoms, particularly preferably 6-12 carbon atoms, such as a phenyloxy group and a 2-naphthyloxy group), an acyl group (including, preferably, 1-20 carbon atoms, more preferably 1-16 carbon atoms, particularly preferably 1-12 carbon atoms, such as an acetyl group, a benzoyl group, a formyl group and a pivaloyl group), an alkoxycarbonyl group (including, preferably, 2-20 carbon atoms, more preferably 2-16 carbon atoms, particularly preferably 2-12 carbon atoms, such as a methoxycarbonyl group and an ethoxycarbonyl group), an aryloxycarbonyl group (including, preferably, 7-20 carbon atoms, more preferably 7-16 carbon atoms, and particularly preferably 7-10 carbon atoms, such as a phenyloxycarbonyl group), an acyloxy group (including, preferably, 2-20 carbon atoms, more preferably 2-16 carbon atoms, particularly preferably 2-10 carbon atoms, such as an acetoxy group and a benzoyloxy group), an acylamino group (including, preferably, 2-20 carbon atoms, more preferably 2-16 carbon atoms, particularly preferably 2-10 carbon atoms, such as an acetylamino group and a benzoylamino group), an alkoxycarbonylamino group (including, preferably, 2-20 carbon atoms, more preferably 2-16 carbon atoms, particularly preferably 2-12 carbon atoms, such as a methoxycarbonylamino group), an aryloxycarbonylamino group (including, preferably, 7-20 carbon atoms, more preferably 7-16 carbon atoms, particularly preferably 7-12 carbon atoms, such as a phenyloxycarbonylamino group), a sulfonylamino group (including, preferably, 1-20 carbon atoms, more preferably 1-16 carbon atoms, particularly preferably 1-12 carbon atoms, such as a methanesulfonylamino group and a benzenesulfonylamino group), a sulfamoyl group (including, preferably, 0-20 carbon atoms, more preferably 0-16 carbon atoms, particularly preferably 0-12 carbon atoms, such as a sulfamoyl group, a methylsulfamoyl group, a dimethylsulfamoyl group and a phenylsulfamoyl group), a carbamoyl group (including, preferably, 1-20 carbon atoms, more preferably 1-16 carbon atoms, particularly preferably 1-12 carbon atoms, such as a carbamoyl group, a methylcarbamoyl group, a diethylcarbamoyl group and a phenylcarbamoyl group), an alkylthio group (including, preferably, 1-20 carbon atoms, more preferably 1-16 carbon atoms, particularly preferably 1-12 carbon atoms, such as a methylthio group and an ethylthio group), an arylthio group (including, preferably, 6-20 carbon atoms, more preferably 6-16 carbon atoms, particularly preferably 6-12 carbon atoms, such as a phenylthio group), a sulfonyl group (including, preferably, 1-20 carbon atoms, more preferably 1-16 carbon atoms, particularly preferably 1-12 carbon atoms, such as a mesyl group and a tosyl group), a sulfinyl group (including, preferably, 1-20 carbon atoms, more preferably 1-16 carbon atoms, particularly preferably 1-12 carbon atoms, such as a methanesulfinyl group and a benzenesulfinyl group), an ureide group (including, preferably, 1-20 carbon atoms, more preferably 1-16 carbon atoms, and particularly preferably 1-12 carbon atoms, such as an ureide group, a methylureide group and a phenylureide group), a phosphoric amide group (including, preferably, 1-20 carbon atoms, more preferably 1-16 carbon atoms, particularly preferably 1-12 carbon atoms, such as a diethylphosphoric amide group and a phenylphosphoric amide group), a hydroxyl group, a mercapto group, a halogen atom (such as a fluorine atom, a chlorine atom, a bromine atom, an iodine atom and etc.), a cyano group, a sulfo group, a carboxyl group, a nitro group, a hydroxamic acid group, a sulfino group, a hydrazino group, an imino group, a heteroring group (including, preferably, 1-30 carbon atoms, more preferably 1-12 carbon atoms, wherein examples of the hetero atom include a nitrogen atom, an oxygen atom and a sulfur atom, and specific examples include an imidazolyl group, a pyridyl group, a quinolyl group, a furyl group, a piperidyl group, a morphorino group, a benzoxysazolyl group, a benzimidazolyl group and a benzothiazolyl group), and a silyl group (including, preferably, 3-40 carbon atoms, more preferably 3-30 carbon atoms, particularly preferably 3-24 carbon atoms, such as a trimethylsilyl group and a triphenylsilyl group). These substituents may further have a substituent. When there are two substituents or more, they may be same with or different from each other. Further, when possible, they may be linked with each other to form a ring.

Preferable examples of the compound represented by the formula (7) are shown below, however compounds usable in the invention are not restricted to these specific examples.

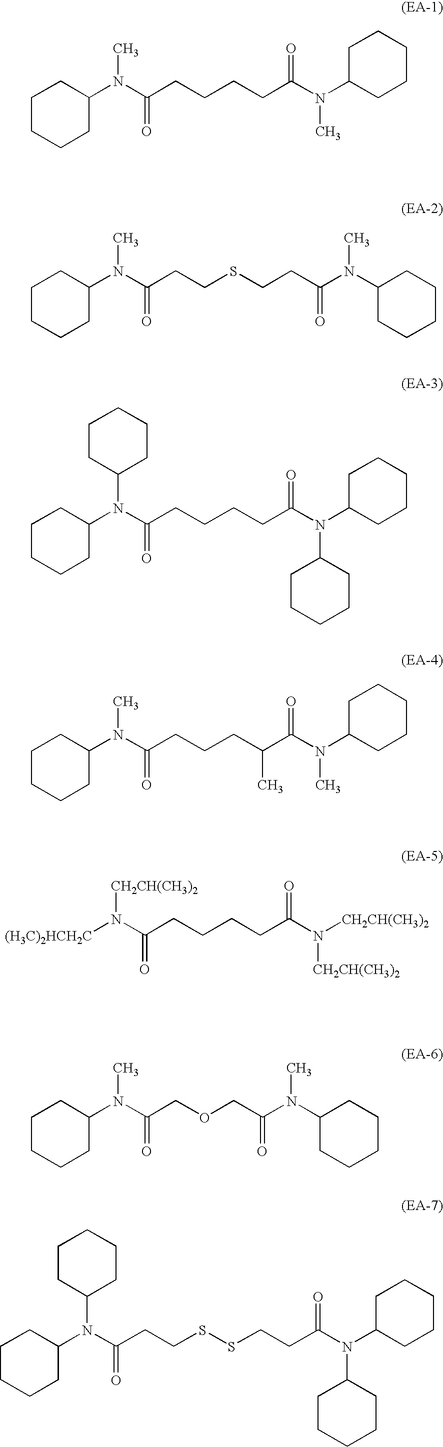

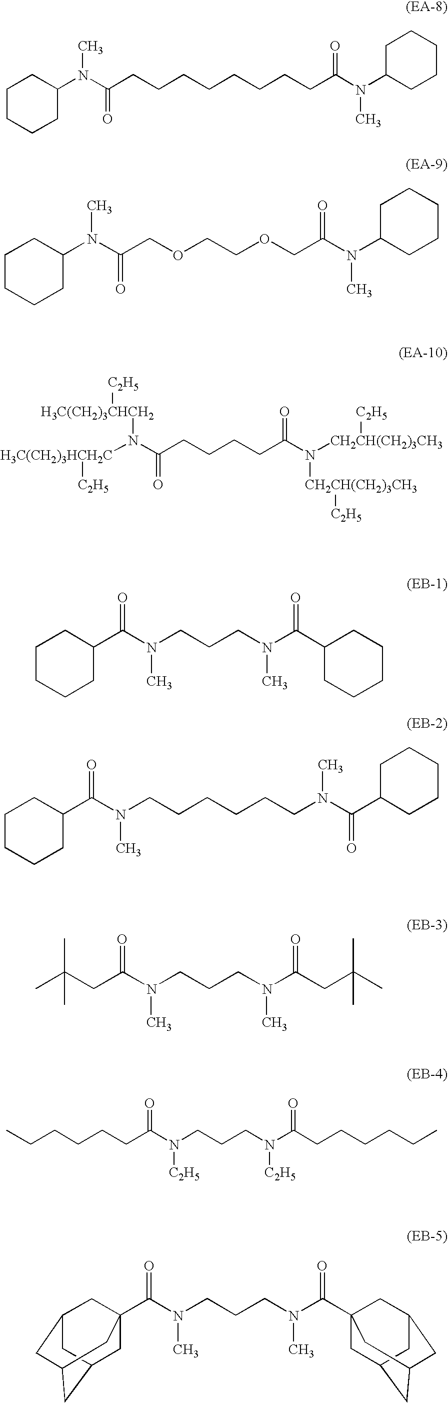

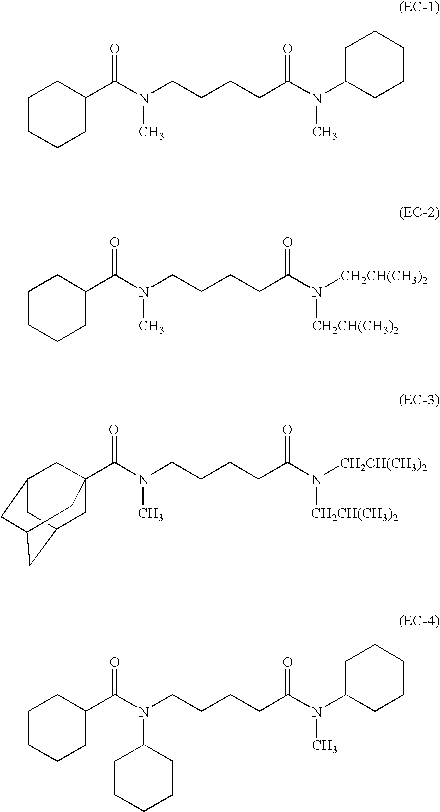

The compounds of formula (5), formula (6) and formula (7) may be obtained through dehydrating condensation of carboxylic acids and amines or substitution reaction between carboxylic acid chloride derivatives and amine derivatives, using a condensing agent (e.g., dicyclohexylcarbodiimide (DCC) or the like).

Many compounds known for a plasticizer of a cellulose acylate may be preferably used as the retardation reducer for use in the film of the invention. As the plasticizer, usable are phosphates or carboxylates. Examples of the phosphates include triphenyl phosphate (TPP) and tricresyl phosphate (TCP). The carboxylates are typically phthalates and citrates. Examples of the phthalates include dimethyl phthalate (DMP), diethyl phthalate (DEP), dibutyl phthalate (DBP), dioctyl phthalate (DOP), diphenyl phthalate (DPP) and diethylhexyl phthalate (DEHP). Examples of the citrates include triethyl O-acetylcitrate (OACTE) and tributyl O-acetylcitrate (OACTB). Examples of other carboxylates include butyl oleate, methylacetyl ricinoleate, dibutyl sebacate, and various trimellitates. Preferred for use herein are phthalate plasticizers (DMP, DEP, DBP, DOP, DPP, DEHP). More preferred are DEP and DPP.

The retardation reducer in the invention is preferably an Rth reducer from the viewpoint of realizing a favorable Nz factor. Of the retardation reducers, the Rth reducer includes, for example, aliphatic polyesters, acrylic polymers, styrenic polymers, and low-molecular-weight compounds of formulae (3) to (7). Of those, preferred are aliphatic polyesters, acrylic polymers and styrenic polymers; and more preferred are aliphatic polyesters and acrylic polymers.

The retardation reducing agent is added in an amount of preferably from 0.01 to 30% by mass of the cellulose resin, more preferably from 0.1 to 20% bymass of the cellulose resin, still more preferably from 0.1 to 10% by mass of the cellulose resin.

When the retardation reducing agent is added in an amount of at most 30% by mass, compatibility with the cellulose resin can be improved and whitening can be inhibited. When two or more retardation reducing agents are used, the sum amount of the agents is preferably within the above range.

### (Retardation Enhancer)

Preferably in the invention, a retardation enhancer is added to the film for making the film have a retardation. The retardation enhancer for use in the invention includes rod-shaped or discotic compounds. Of the rod-shaped or discotic compounds, those having at least two aromatic groups are preferred for use as the retardation enhancer in the invention.

The amount of the retardation enhancer of a rod-shaped compound to be added is preferably from 0.1 to 30 parts by mass relative to 100 parts by mass of the cellulose acylate-containing polymer ingredient, more preferably from 0.5 to 20 parts by mass.

Preferably, the amount of a discotic retardation enhancer to be added is preferably from 0.05 to 20 parts by mass relative to 100 parts by mass of the cellulose acylate resin, more preferably from 1.0 to 15 parts by mass, even more preferably from 3.0 to 10 parts by mass.

A discotic compound is superior to a rod-shaped compound as an Rth retardation enhancer, and is therefore favorably used in ace where the film requires an especially large Rth retardation. Two or more different types of retardation enhancers may be used, as combined.

Preferably, the retardation enhancer has a maximum absorption in a wavelength range of from 250 to 400 nm, and preferably, it does not have substantial absorption in a visible light region.

Description will be given about the discotic compound. As the discotic compound, a compound having at least two aromatic rings can be employed.

In the specification, an “aromatic ring” includes an aromatic heteroring, in addition to an aromatic hydrocarbon ring.

The aromatic hydrocarbon ring is particularly preferably a 6-membered ring (that is, benzene ring). Generally, the aromatic heteroring is an unsaturated heteroring. The aromatic heteroring is preferably a 5-membered ring, 6-membered ring or a 7-membered ring, more preferably a 5-membered ring or a 6-membered ring. Generally, the aromatic heteroring has the largest number of double bonds. As hetero atoms, a nitrogen atom, an oxygen atom and a sulfur atom are preferred, and a nitrogen atom is particularly preferred. Examples of the aromatic heteroring include a furan ring, a thiophene ring, a pyrrole ring, an oxazole ring, an iso-oxazole ring, a thiazole ring, an iso-thiazole ring, an imidazole ring, a pyrazole ring, a furazane ring, a triazole ring, a pyran ring, a pyridine ring, a pyridazine ring, a pyrimidine ring, a pyrazine ring and a 1,3,5-triazine ring.

As the aromatic ring, a benzene ring, a condensed benzene ring, biphenol and a 1,3,5-triazine ring are used preferably, and, in particular, a 1,3,5-triazine ring is preferably used. Specifically, compounds, for example, disclosed in JP-A-2001-166144 are used preferably as a discotic compound.

Number of aromatic rings included in the retardation enhancer is preferably 2-20, more preferably 2-12, furthermore preferably 2-8, most preferably 2-6.

Bond relation of two aromatic rings can be classified into following cases (since an aromatic ring, a spiro bond can not be formed): (a) formation of a condensed ring, (b) formation of a direct bond by a single bond, and (c) formation of a bond via a linking group. The bond relation may be any one of (a)-(c).

Examples of the (a) condensed ring (a condensed ring of two or more of aromatic rings) include an indene ring, a naphthalene ring, an azulene ring, a fluorene ring, a phenanthrene ring, an anthracene ring, an acenaphthylene ring, an biphenylene ring, a naphthacene ring, a pyrene ring, an indole ring, an iso-indole ring, a benzofuran ring, a benzothiophene ring, an indolizine ring, a benzoxazole ring, a benzothiazole ring, a benzoimidazole ring, a benzotriazole ring, a purine ring, an indazole ring, a chromene ring, a quinoline ring, an isoquinoline ring, a quinolizine ring, a quinazoline ring, a cinnoline ring, a quinoxaline ring, a phthalazine ring, a pteridine ring, a carbazole ring, an acridine ring, a phenanthridine ring, a xanthene ring, a phenazine ring, a phenothiazine ring, a phenoxthine ring, a phenoxazine ring and a thianthrene ring. A naphthalene ring, an azulene ring, an indole ring, a benzoxazole ring, a benzothiazole ring, a benzoimidazole ring, benzotriazole ring and a quinoline ring are preferred.

The single bond of (b) is preferably a carbon-carbon bond between two aromatic rings. Two aromatic rings may be bonded by two or more of single bonds to form an aliphatic ring or a non-aromatic heteroring between the two aromatic rings.

The linking group of (c) also bonds, preferably, to carbon atoms of the two aromatic rings. The linking group is preferably an alkylene group, an alkenylene group, an alkynylene group, —CO—, —O—, —NH—, —S— or combinations thereof. Examples of the linking group composed of the combination are shown below. In this connection, the relation of right and left in the following examples of linking group may be reversed.
c1: —CO—O—
c2: —CO—NH—
c3: -alkylene-O—
c4: —NH—CO—NH—
c5: —NH—CO—O—
c6: —O—CO—O—
c7: —O-alkylene-O—
c8: —CO-alkenylene-
c9: —CO-alkenylene-NH—
c10: —CO-alkenylene-O—
c11: -alkylene-CO—O-alkylene-O—CO-alkylene-
c12: —O-alkylene-CO—O-alkylene-O—CO-alkylene-O—
c13: —O—CO-alkylene-CO—O—
c14: —NH—CO-alkenylene-
c15: —O—CO-alkenylene-

The aromatic ring and the linking group may have a substituent.

Examples of the substituent include a halogen atom (F, Cl, Br, I), a hydroxyl group, a carboxyl group, a cyano group, an amino group, a nitro group, a sulfo group, a carbamoyl group, a sulfamoyl group, an ureide group, an alkyl group, an alkenyl group, an alkynyl group, an aliphatic acyl group, an aliphatic acyloxy group, an alkoxy group, an alkoxycarbonyl group, an alkoxycarbonylamino group, an alkylthio group, an alkylsulfonyl group, an aliphatic amide group, an aliphatic sulfoneamide group, an aliphatic-substituted amino group, an aliphatic-substituted carbamoyl group, an aliphatic-substituted sulfamoyl group, an aliphatic-substituted ureide group and a non-aromatic heterocyclic group.

Number of carbon atoms of the alkyl group is preferably 1-8. A chain alkyl group is preferred to a cyclic alkyl group, and a strait-chain alkyl group is particularly preferred. The alkyl group may further have a substituent (for example, a hydroxyl group, a carboxyl group, an alkoxy group, an alkyl-substituted amino group). Examples of the alkyl group (including the substituted alkyl group) include a methyl group, an ethyl group, a n-butyl group, a n-hexyl group, a 2-hydroxyethyl group, a 4-carboxybutyl group, a 2-methoxyethyl group and 2-diethylaminoethyl group.

Number of carbon atoms of the alkenyl group is preferably 2-8. A chain alkenyl group is preferred to a cyclic alkenyl group, and a straight-chain alkenyl group is particularly preferred. The alkenyl group may further have a substituent. Examples of the alkenyl group include a vinyl group, an aryl group and a 1-hexenyl group.

Number of carbon atoms of the alkynyl group is preferably 2-8. A chain alkynyl group is preferred to a cyclic alkynyl group, and a straight-chain alkynyl group is particularly preferred. The alkynyl group may further have a substituent. Examples of the alkynyl group include an ethynyl group, a 1-butynyl group and a 1-hexynyl group.

Number of carbon atoms of the aliphatic acyl group is preferably 1-10. Examples of the aliphatic acyl group include an acetyl group, a propanoyl group and a butanoyl group.

Number of carbon atoms of the aliphatic acyloxy group is preferably 1-10. Example of the aliphatic acyloxy group include an acetoxy group.

Number of carbon atoms of the alkoxy group is preferably 1-8. The alkoxy group may further have an substituent (for example, an alkoxy group). Examples of the alkoxy group (including a substituted alkoxy group) include a methoxy group, an ethoxy group, a butoxy group and a methoxyethoxy group.

Number of carbon atoms of the alkoxycarbonyl group is preferably 2-10. Examples of the alkoxycarbonyl group include a methoxycarbonyl group and an ethoxycarbonyl group.

Number of carbon atoms of the alkoxycarbonylamino group is preferably 2-10. Examples of the alkoxycarbonylamino group include a methoxycarbonylamino group and an ethoxycarbonylamino group.

Number of carbon atoms of the alkylthio group is preferably 1-12. Examples of the alkylthio group include a methylthio group, an ethylthio group and an octylthio group.

Number of carbon atoms of the alkylsulfonyl group is preferably 1-8. Examples of the alkylsulfonyl group include a methanesulfonyl group and an ethanesulfonyl group.

Number of carbon atoms of the aliphatic amide group is preferably 1-10. Example of the aliphatic amide group includes an acetamide group.

Number of carbon atoms of the aliphatic sulfonamido group is preferably 1-8. Examples of the aliphatic sulfonamido group include a methane sulfonamido group, a butane sulfonamido group and a n-octane sulfonamido group.

Number of carbon atoms of the aliphatic-substituted amino group is preferably 1-10. Examples of the aliphatic-substituted amino group include a dimethylamino group, a diethylamino group and a 2-carboxyethylamino group.

Number of carbon atoms of the aliphatic-substituted carbamoyl group is preferably 2-10. Examples of the aliphatic-substituted carbamoyl group include a methylcarbamoyl group and a diethylcarbamoyl group.

Number of carbon atoms of the aliphatic-substituted sulfamoyl group is preferably 1-8. Examples of the aliphatic-substituted sulfamoyl group include a methylsulfamoyl group and a diethylsulfamoyl group.

Number of carbon atoms of the aliphatic-substituted ureide group is preferably 2-10. Example of the aliphatic-substituted ureide group includes a methylureide group.

Examples of the non-aromatic heterocyclic group include a piperidino group and a morphorino group.

Molecular weight of the retardation enhancer composed of the discotic compound is preferably 300-800.

A compound represented by following formula (I) is preferably used for the discotic compound.

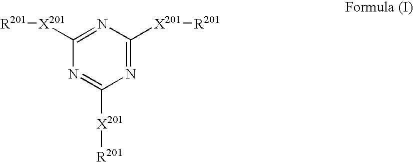

In the above formula (I):

R²⁰¹ each independently represents an aromatic ring or a hetero ring having a substituent at any of the ortho-, meta- and para-positions.

X²⁰¹ each independently represents a single bond or —NR²⁰²—. R²⁰² each independently represents a hydrogen atom, or a substituted or unsubstituted alkyl, alkenyl, aryl or heterocyclic group.

The aromatic ring represented by R²⁰¹ is preferably a phenyl ring or a naphtyl ring, particularly preferably a phenyl ring. The aromatic ring represented by R²⁰¹ may have at least one substituent in any one of substitution positions. For the example of the above-mentioned substituent, a halogen atom, a hydroxyl group, a cyano group, a nitro group, a carboxyl group, an alkyl group, an alkenyl group, an aryl group, an alkoxy group, an alkenyloxy group, an aryloxy group, an acyloxy group, an alkoxycarbonyl group, an alkenyloxycarbonyl group, an aryloxycarbonyl group, a sulfamoyl group, an alkyl substituted sulfamoyl group, an alkenyl substituted sulfamoyl group, an aryl substituted sulfamoyl group, a sulfoneamide group, a carbamoyl group, an alkyl substituted carbamoyl group, an alkenyl substituted carbamoyl group, an aryl substituted carbamoyl group, an amide group, an alkylthio group, an alkenylthio group, an arylthio group and an acyl group are included.

The hetero ring for R²⁰¹ is preferably aromatic. The aromatic hetero ring is generally an unsaturated hetero ring, and is preferably a hetero ring having maximum double bonds. The hetero ring is preferably a 5-membered ring, a 6-membered ring or a 7-membered ring, more preferably a 5-membered ring or a 6-membered ring, most preferably a 5-membered ring. The hetero atom constituting the hetero ring is preferably a nitrogen atom, a sulfur atom or an oxygen atom, more preferably a nitrogen atom. The aromatic hetero ring is especially preferably a pyridine ring (as the heterocyclic group, a 2-pyridyl or 4-pyridyl group). The heterocyclic group may have a substituent. Examples of the substituent for the heterocyclic group may be the same as those mentioned hereinabove for the substituent of the aryl moiety.

The heterocyclic group in a case where X²⁰¹ is a single bond is preferably a heterocyclic group having a chemical bond at the nitrogen atom. The heterocyclic group having a chemical bond at the nitrogen atom is preferably a 5-membered ring, a 6-membered ring or a 7-membered ring, more preferably a 5-membered ring or a 6-membered ring, most preferably a 5-membered ring. The heterocyclic group may have plural nitrogen atoms. The heterocyclic group may have any other hetero atom (e.g., O, S) than the nitrogen atom. Examples of the heterocyclic group having a chemical bond at the nitrogen atom are shown below.

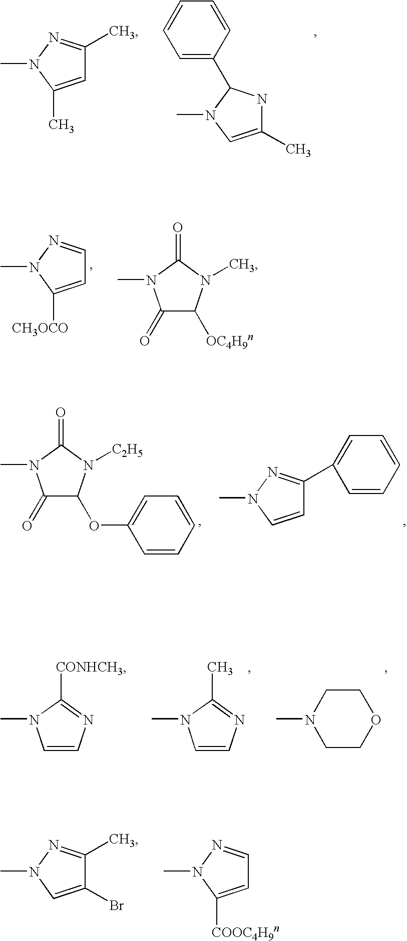

The alkyl group represented by R²⁰² may be a cyclo alkyl group or a chain alkyl group, preferably a chain alkyl group. A straight chain alkyl group is more preferred to a branched chain alkyl group. Number of the carbon atoms of the alkyl group is preferably 1-30, more preferably 1-20, further preferably 1-10, furthermore preferably 1-8, and most preferably 1-6. The alkyl group may have a substituent. An example of the substituent includes a halogen atom, an alkoxy group (for example, a methoxy group, an ethoxy group) and an acyloxy group (for example, an acryloxy group, a metacryloxy group).

The alkenyl group represented by R²⁰² may be a cyclo alkenyl group or a chain alkenyl group, preferably a chain alkenyl group. A straight chain alkenyl group is more preferred to a branched chain alkyl group. Number of the carbon atoms of the alkyl group is preferably 2-30, more preferably 2-20, further preferably 2-10, further more preferably 2-8, and most preferably 2-6. The alkenyl group may have a substituent. As the substituents, those for the above-mentioned alkyl group can be used.

The aromatic ring group and heterocyclic group represented by R²⁰² and their preferable groups are as described in R²⁰¹ above. The aromatic ring group and the heterocyclic group may have a substituent further, and examples of the substituent are the same as those for R²⁰¹.

As a discotic compound, the triphenylene compound represented by the following formula (II) can also be used preferably.

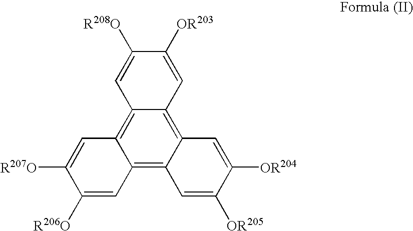

In the formula (II), R²⁰³, R²⁰⁴, R²⁰⁵, R²⁰⁶, R²⁰⁷ and R²⁰⁸ each represent independently a hydrogen atom or a substituent.

Examples of each of the substituent represented by R²⁰³, R²⁰⁴, R²⁰⁵, R²⁰⁶, R²⁰⁷ and R²⁰⁸ include an alkyl group (including, preferably, 1-40 carbon atoms, more preferably 1-30 carbon atoms, particularly preferably 1-20 carbon atoms, such as a methyl group, an ethyl group, an isopropyl group, a tert-butyl group, a n-octyl group, a n-decyl group, a n-hexadecyl group, a cyclopropyl group, a cyclopentyl group and a cyclohexyl group), an alkenyl group (including, preferably, 2-40 carbon atoms, more preferably 2-30 carbon atoms, particularly preferably 2-20 carbon atoms, such as a vinyl group, an aryl group, a 2-butenyl group and a 3-pentenyl group), an alkynyl group (including, preferably, 2-40 carbon atoms, more preferably 2-30 carbon atoms, particularly preferably 2-20 carbon atoms, such as a propagyl group and a 3-pentynyl group), an aryl group (including, preferably, 6-30 carbon atoms, more preferably 6-20 carbon atoms, particularly preferably 6-12 carbon atoms, such as a phenyl group, a p-methylphenyl group and a naphthyl group), substituted or unsubstituted amino group (including, preferably, 0-40 carbon atoms, more preferably 0-30 carbon atoms, particularly preferably 0-20 carbon atoms, such as an unsubstituted amino group, a methylamino group, a dimethylamino group, a diethylamino group and an anilino group), an alkoxy group (including, preferably, 1-40 carbon atoms, more preferably 1-30 carbon atoms, particularly preferably 1-20 carbon atoms, such as a methoxy group, an ethoxy group and a butoxy group), an aryloxy group (including, preferably, 6-40 carbon atoms, more preferably 6-30 carbon atoms, particularly preferably 6-20 carbon atoms, such as a phenyloxy group and a 2-naphthyloxy group), an acyl group (including, preferably, 1-40 carbon atoms, more preferably 1-30 carbon atoms, particularly preferably 1-20 carbon atoms, such as an acetyl group, a benzoyl group, a formyl group and a pivaloyl group), an alkoxycarbonyl group (including, preferably, 2-40 carbon atoms, more preferably 2-30 carbon atoms, particularly preferably 2-20 carbon atoms, such as a methoxycarbonyl group and an ethoxycarbonyl group), an aryloxycarbonyl group (including, preferably, 7-40 carbon atoms, more preferably 7-30 carbon atoms, and particularly preferably 7-20 carbon atoms, such as a phenyloxycarbonyl group), an acyloxy group (including, preferably, 2-40 carbon atoms, more preferably 2-30 carbon atoms, particularly preferably 2-20 carbon atoms, such as an acetoxy group and a benzoyloxy group), an acylamino group (including, preferably, 2-40 carbon atoms, more preferably 2-30 carbon atoms, particularly preferably 2-20 carbon atoms, such as an acetylamino group and a benzoylamino group), an alkoxycarbonylamino group (including, preferably, 2-40 carbon atoms, more preferably 2-30 carbon atoms, particularly preferably 2-20 carbon atoms, such as a methoxycarbonylamino group), an aryloxycarbonylamino group (including, preferably, 7-40 carbon atoms, more preferably 7-30 carbon atoms, and particularly preferably 7-20 carbon atoms, such as a phenyloxycarbonylamino group), a sulfonylamino group (including, preferably, 1-40 carbon atoms, more preferably 1-30 carbon atoms, particularly preferably 1-20 carbon atoms, such as a methanesulfonylamino group and a benzenesulfonylamino group), a sulfamoyl group (including, preferably, 0-40 carbon atoms, more preferably 0-30 carbon atoms, particularly preferably 0-20 carbon atoms, such as a sulfamoyl group, a methylsulfamoyl group, a dimethylsulfamoyl group and a phenylsulfamoyl group), a carbamoyl group (including, preferably, 1-40 carbon atoms, more preferably 1-30 carbon atoms, particularly preferably 1-20 carbon atoms, such as a carbamoyl group, a methylcarbamoyl group, a diethylcarbamoyl group and a phenylcarbamoyl group), an alkylthio group (including, preferably, 1-40 carbon atoms, more preferably 1-30 carbon atoms, particularly preferably 1-20 carbon atoms, such as a methylthio group, an ethylthio group, propylthio group, butylthio group, pentylthio group, hexylthio group, heptylthio group and octylthio group), an arylthio group (including, preferably, 6-40 carbon atoms, more preferably 6-30 carbon atoms, particularly preferably 6-20 carbon atoms, such as a phenylthio group), a sulfonyl group (including, preferably, 1-40 carbon atoms, more preferably 1-30 carbon atoms, particularly preferably 1-20 carbon atoms, such as a mesyl group and a tosyl group), a sulfinyl group (including, preferably, 1-40 carbon atoms, more preferably 1-30 carbon atoms, particularly preferably 1-20 carbon atoms, such as a methanesulfinyl group and a benzenesulfinyl group), an ureide group (including, preferably, 1-40 carbon atoms, more preferably 1-30 carbon atoms, particularly preferably 1-20 carbon atoms, such as an ureide group, a methylureide group and a phenylureide group), a phosphoric amide group (including, preferably, 1-40 carbon atoms, more preferably 1-30 carbon atoms, particularly preferably 1-20 carbon atoms, such as a diethylphosphoric amide group and a phenylphosphoric amide group), a hydroxyl group, a mercapto group, a halogen atom (such as a fluorine atom, a chlorine atom, a bromine atom, an iodine atom), a cyano group, a sulfo group, a carboxyl group, a nitro group, a hydroxamic acid group, a sulfino group, a hydrazino group, an imino group, a heteroring group (including, preferably, 1-30 carbon atoms, more preferably 1-12 carbon atoms, wherein examples of the hetero atom include a nitrogen atom, an oxygen atom and a sulfur atom, and specific examples include an imidazolyl group, a pyridyl group, a quinolyl group, a furyl group, a piperidyl group, a morphorino group, a benzoxysazolyl group, a benzimidazolyl group, a benzothiazolyl group and 1,3,5-triazyl group), and a silyl group (including, preferably, 3-40 carbon atoms, more preferably 3-30 carbon atoms, particularly preferably 3-24 carbon atoms, such as a trimethylsilyl group and a triphenylsilyl group). These substituents may further have a substituent. When there are two substituents or more, they may be same with or different from each other. Further, when possible, they may be linked with each other to form a ring.

As the substituent represented by R²⁰³, R²⁰⁴, R²⁰⁵, R²⁰⁶, R²⁰⁷ and R²⁰⁸ is preferably an alkyl group, an aryl group, a substituted or unsubstituted amino group, an alkoxy group, an alkylthio group or a halogen atoms.

Preferable examples of the compound represented by the formula (II) are shown below, however compounds usable in the invention are not restricted to these specific examples.

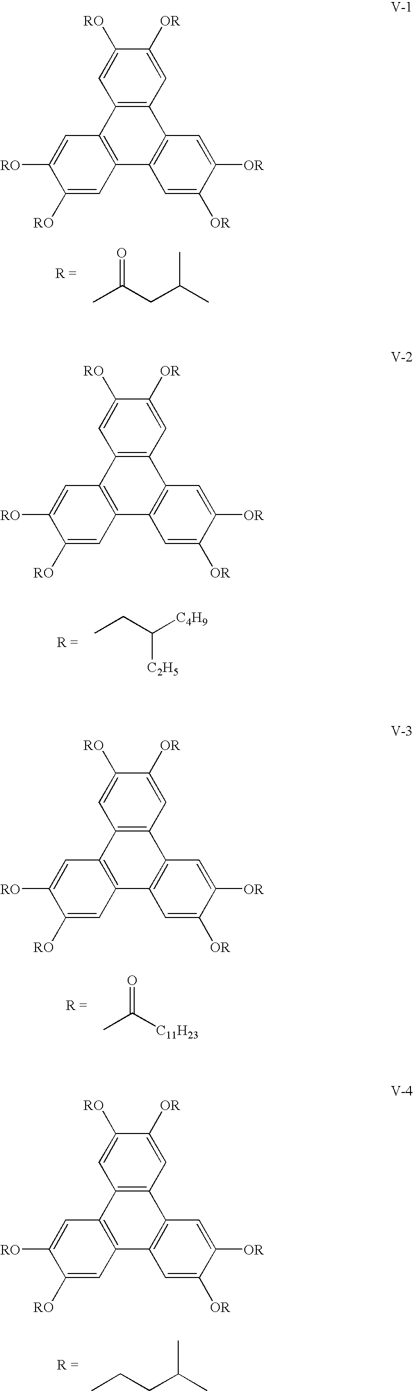

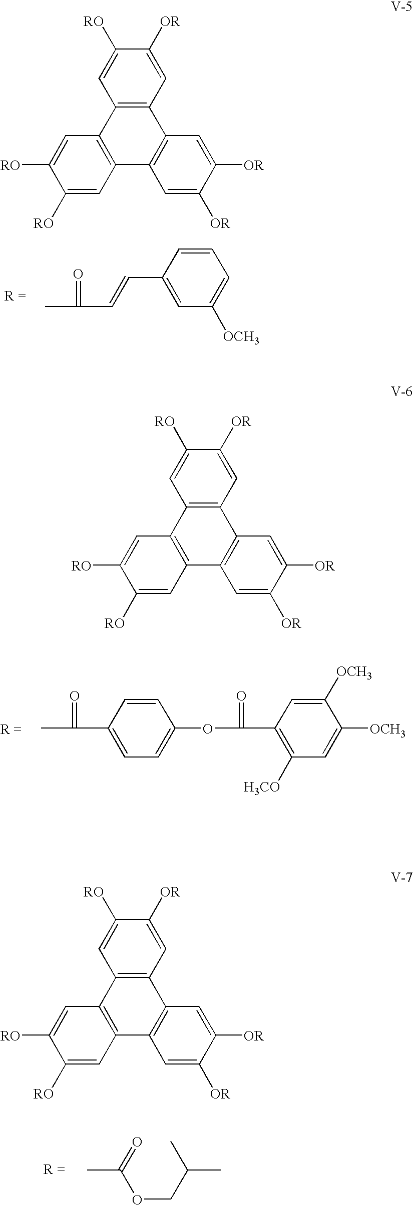

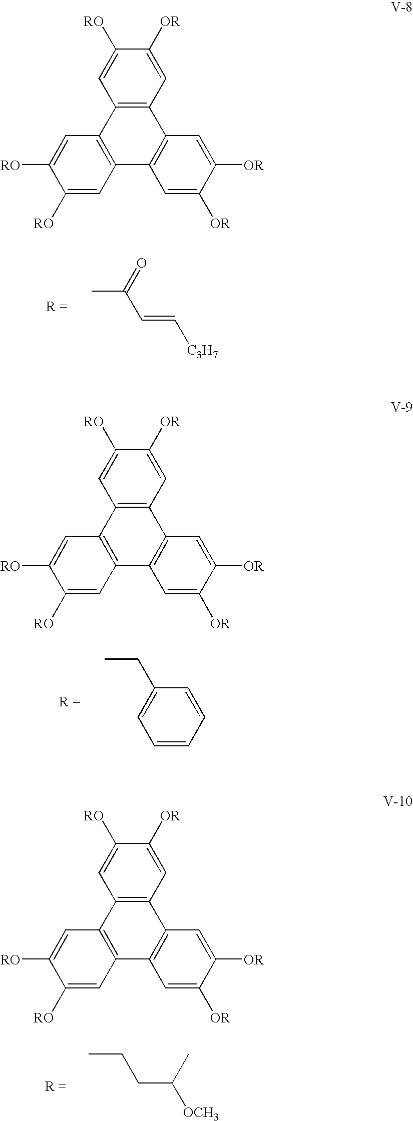

The compound represented by formula (I) can be produced by, for example, a method given in the JP-A 2003-344655 and the compound represented by formula (II) can be produced by, for example, a method given in JP-A 2005-134884. Both compounds may be produced by other well-known methods.

In the invention, rod-shaped compounds having a linear molecular structure are also usable preferably in addition to the discotic compound. “The linear molecular structure” means that molecular structure of a rod-shaped compound is linear in the thermodynamically stablest structure. The thermodynamically stablest structure can be obtained by crystal structure analysis or molecular orbital calculation. For example, molecular orbital calculation can be performed using a software for molecular orbital calculation (for example, WinMOPAC2000, manufactured by FUJITSU) to obtain the molecular structure for which heat of formation of the compound becomes least. “The linear molecular structure” means that the angle constituted by the primary chain of the molecular structure is 140 degrees or more in the thermodynamically stablest structure obtained according to the aforementioned calculation.

As the rod-shaped compound having at least two aromatic rings, compounds represented by formula (11) below are preferred.

Ar¹-L¹-Ar²: Formula (11)

wherein each of Ar¹ and Ar² represents an aromatic group independently from each other.

In the specification, the aromatic group includes an aryl group (aromatic hydrocarbon group), a substituted aryl group, an aromatic heteroring group and a substituted aromatic heteroring group.

An aryl group and a substituted aryl group are preferred to an aromatic heteroring group and a substituted aromatic heteroring group. A heteroring in the aromatic heteroring group is generally unsaturated. The aromatic heteroring is preferably a 5-membered ring, a 6-membered ring or a 7-membered ring, more preferably a 5-membered ring or a 6-membered ring. The aromatic heteroring generally has the largest number of double bonds. As for the hetero atom, a nitrogen atom, an oxygen atom or a sulfur atom is preferred, and a nitrogen atom or a sulfur atom is more preferred.

Preferable examples of the aromatic ring in the aromatic group include a benzene ring, a furan ring, a thiophene ring, a pyrrole ring, an oxazole ring, a thiazole ring, an imidazole ring, a triazole ring, a pyridine ring, a pyrimidine ring and a pyrazine ring. A benzene ring is particularly preferred.

Examples of the substituent of the substituted aryl group and substituted aromatic heteroring group include a halogen atom (F, Cl, Br, I), a hydroxyl group, a carboxyl group, a cyano group, an amino group, an alkylamino group (for example, a methylamino group, an ethylamino group, a butylamino group, a dimethylamino group), a nitro group, a sulfo group, a carbamoyl group, an alkylcarbamoyl group (for example, an N-methylcarbamoyl group, an N-ethylcarbamoyl group, an N,N-dimethylcarbamoyl group), a sulfamoyl group, an alkylsulfamoyl group (for example, an N-methylsulfamoyl group, an N-ethylsulfamoyl group, an N,N-dimethylsulfamoyl group), an ureide group, an alkylureide group (for example, an N-methylureide group, an N,N-dimethylureide group, an N,N,N′-trimethylureide group), an alkyl group (for example, a methyl group, an ethyl group, a propyl group, a butyl group, a pentyl group, a heptyl group, an octyl group, an isopropyl group, a s-butyl group, a tert-amyl group, a cyclohexyl group, a cyclopentyl group), an alkenyl group (for example, a vinyl group, an aryl group, a hexenyl group), an alkynyl group (for example, an ethynyl group, a butynyl group), an acyl group (for example, a formyl group, an acetyl group, a butyryl group, a hexanoyl group, a lauryl group), an acyloxy group (for example, an acetoxy group, a butylyloxy group, a hexanoyloxy group, a lauryloxy group), an alkoxy group (for example, a methoxy group, an ethoxy group, a propoxy group, a butoxy group, a pentyloxy group, a heptyloxy group, an octyloxy group), an aryloxy group (for example, a phenoxy group), an alkoxycarbonyl group (for example, a methoxycarbonyl group, an ethoxycarbonyl group, a propoxycarbonyl group, a butoxycarbonyl group, a pentyloxycarbonyl group, a heptyloxycarbonyl group), an aryloxycarbonyl group (for example, a phenoxycarbonyl group), an alkoxycarbonylamino group (for example, a butoxycarbonylamino group, a hexyloxycarbonylamino group), an alkylthio group (for example, a methylthio group, an ethylthio group, a propylthio group, a butylthio group, a pentylthio group, a heptylthio group, an octylthio group), an arylthio group (for example, phenylthio group), an alkylsulfonyl group (for example, a methylsulfonyl group, an ethylsulfonyl group, a propylsulfonyl group, a butylsulfonyl group, a pentylsulfonyl group, a heptylsulfonyl group, an octylsulfonyl group), an amide group (for example, an acetamide group, a butylamide group, a hexylamide group, a laurylamide group) and non-aromatic heterocyclic groups (for example, a morphoryl group, a pyrazinyl group).

Preferable examples of the substituent of the substituted aryl group and substituted aromatic heteroring group include a halogen atom, a cyano group, a carboxyl group, a hydroxyl group, an amino group, an alkyl-substituted amino group, an acyl group, an acyloxy group, an amide group, an alkoxycarbonyl group, an alkoxy group, an alkylthio group and an alkyl group.

An alkyl moiety in the alkylamino group, the alkoxycarbonyl group, the alkoxy group and the alkylthio group and the alkyl group may further have a substituent. Examples of the substituent in the alkyl moiety and the alkyl group include a halogen atom, a hydroxyl, carboxyl, cyano, amino and alkylamino groups, a nitro, sulfo, carbamoyl and alkylcarbamoyl groups, a sulfamoyl and alkylsulfamoyl groups, an ureide and alkylureide groups, an alkenyl group, an alkynyl group, an acyl group, an acyloxy group, an acylamino group, an alkoxy group, an aryloxy group, an alkoxycarbonyl group, an ayrloxycarbonyl group, an alkoxycarbonylamino group, an alkylthio group, an arylthio group, an alkylsulfonyl group, an amide group and non-aromatic heterocyclic groups. As the substituent in the alkyl moiety and the alkyl group, a halogen atom, a hydroxyl, an amino and alkylamino groups, an acyl group, an acyloxy group, an acylamino group, an alkoxycarbonyl group and an alkoxy group are preferred.

In the formula (11), L¹ represents a divalent linking group selected from an alkylene group, an alkenylene group, an alkynylene group, —O—, —CO— and groups composed of combinations thereof.

The alkylene group may have a cyclic structure. As a cyclic alkylene group, cicrohexylene is preferred, and 1,4-cyclohexylene is particularly preferred. As a chain alkylene group, a straight-chain alkylene group is preferred to a branched alkylene group.

Number of carbon atoms of an alkylene group is preferably 1-20, more preferably 1-15, further preferably 1-10, furthermore preferably 1-8, most preferably 1-6.

The alkenylene group and the alkynylene group preferably have a chain structure compared with a cyclic structure, more preferably a straight chain structure compared with a branched chain structure.

Number of carbon atoms of the alkenylene group and the alkynylene group is preferably 2-10, more preferably 2-8, further preferably 2-6, furthermore preferably 2-4, most preferably 2 (that is, vinylene or ethynylene). Number of carbon atoms of the arylene group is preferably 6-20, more preferably 6-16, further preferably 6-12.

In the molecular structure of the formula (11), an angle formed by Ar¹ and Ar² across L¹¹ is preferably 140 degrees or more.

As the rod-shaped compound, compounds represented by formula (12) below are more preferred.

Ar¹-L²-X-L³-Ar²: Formula (12)

wherein each of Ar¹ and Ar² represents an aromatic group independently from each other. The definition and example for the aromatic group are the same as those for Ar¹ and Ar² of the formula (11).

In the formula (12), each of L² and L³ represents, independently from each other, a divalent linking group selected from an alkylene group, —O—, —CO— and groups composed of combinations thereof.

The alkylene group preferably has a chain structure compared with a cyclic structure, and more preferably has a straight chain structure compared with a branched chain structure.

Number of carbon atoms of the alkylene group is preferably 1-10, more preferably 1-8, further preferably 1-6, furthermore preferably 1-4, most preferably 1 or 2 (that is, methylene or ethylene).

Particularly preferably, L² and L³ are —O—CO— or —CO—O—.

In the formula (12), X is 1,4-cyclohexylene, vinylene or ethynylene.

As specific examples of the compounds of formula (11) or (12), mentioned are the compounds of [Formula 1] to [Formula 11] in JP-A 2004-109657.

Two kinds or more of the rod-shaped compounds, which have a maximum absorption wavelength (λmax) of less than 250 nm in an ultraviolet spectrum of the solution, may be used simultaneously.

A rod-shaped compound can be synthesized according to methods described in references. As references, Mol. Cryst. Liq. Cryst., vol. 53, p 229 (1979); do. vol. 89, p 93 (1982); do. vol. 145, p 111 (1987); do. vol. 170, p 43 (1989); Journal of the American Chemical Society, vol. 113, p 1349 (1991); do. vol. 118, p 5346 (1996); do. vol. 92, p 1582 (1970); Journal of Organic Chemistry, vol. 40, p 420 (1975); and Tetrahedron, vol. 48, No. 16, p 3437 (1992) can be mentioned.

The rod-shaped aromatic compounds described in JP-A 2004-50516, pp. 11-14 may be used as the retardation enhancer.

As the retardation enhancer, one compound alone or two or more compounds as combined may be used. Using two or more different types of compounds as the retardation enhancer is preferred, as the retardation regulation range may be broadened and the retardation may be regulated in a desired range with ease.

The amount of the retardation enhancer to be added is preferably from 0.1 to 20% by mass to the cellulose acylate, more preferably from 0.5 to 10% by mass. In case where the cellulose acylate laminate film is formed according to a solvent casting method, the retardation enhancer may be added to the dope. Adding it may be effected in any timing, and for example, the retardation enhancer is dissolved in an organic solvent such as alcohol, methylene chloride, dioxolane or the like, and the resulting solution may be added to the cellulose acylate solution (dope), or the retardation enhancer may be directly added to the dope composition.

Especially preferably, the proportion of the discotic compound is from 10% to 90% relative to the total mass of the discotic compound and the rod-shaped compound, more preferably from 20% to 80%.

Preferred examples of other rod-shaped compounds than those shown in the above-mentioned patent publication are shown below.

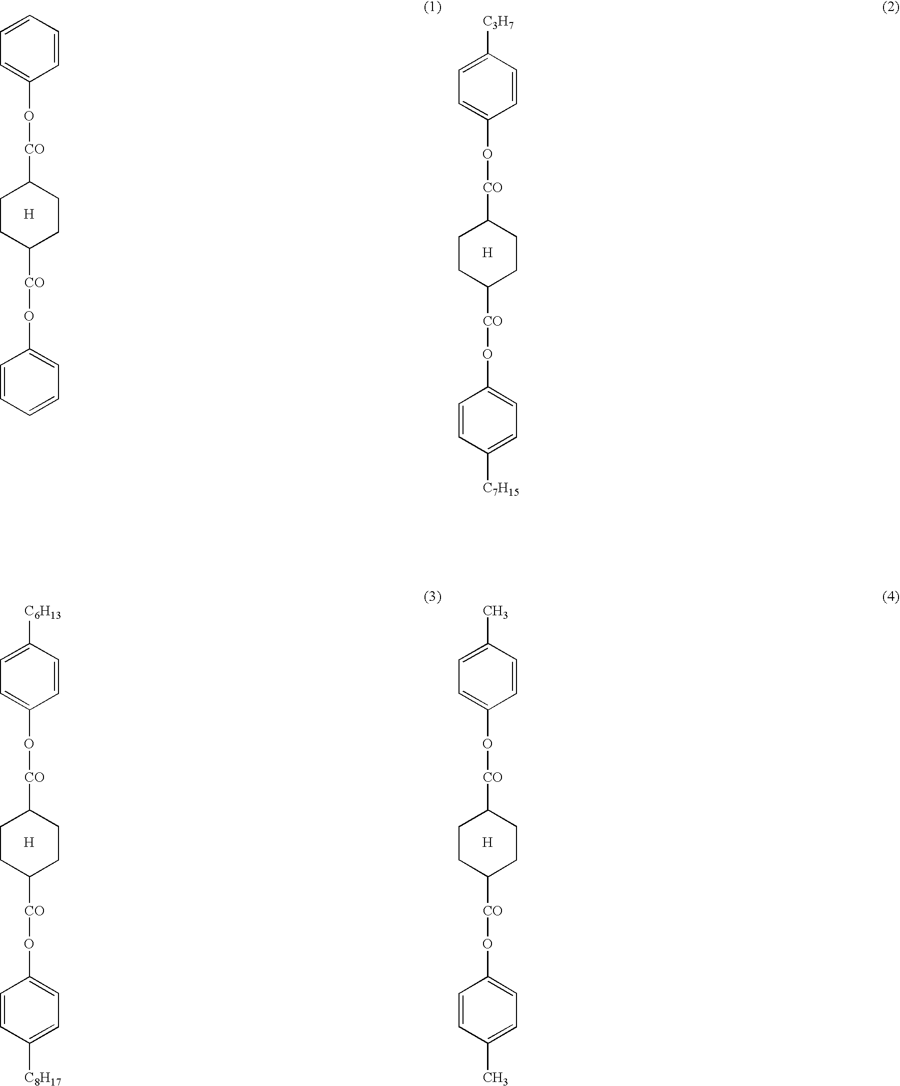

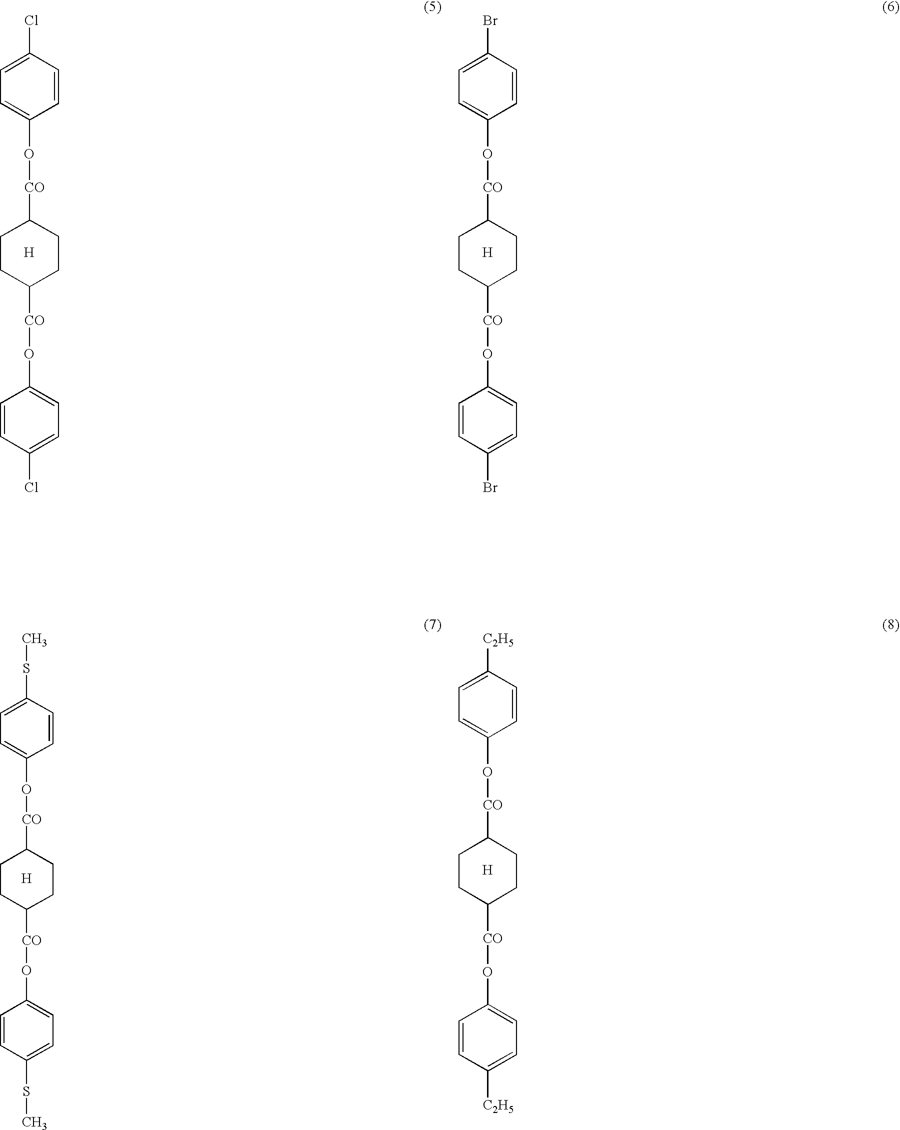

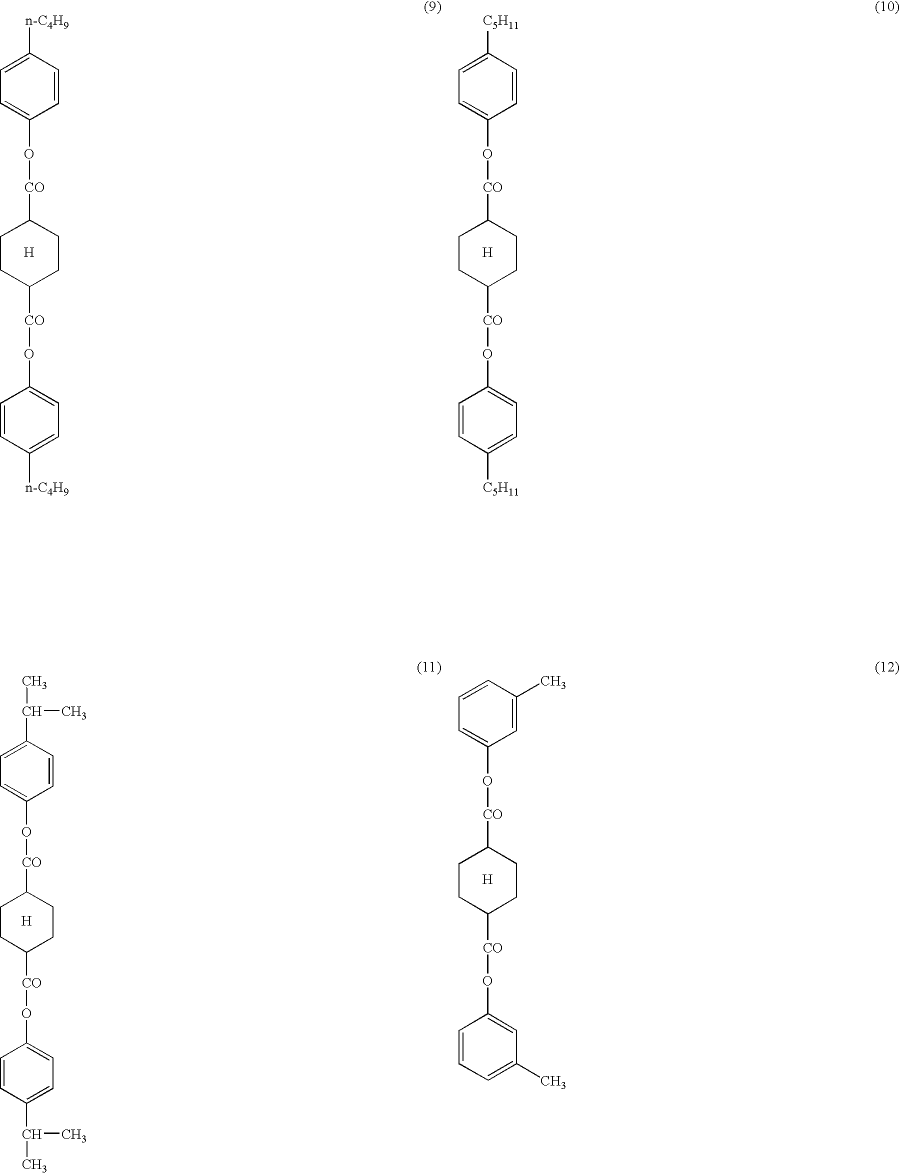

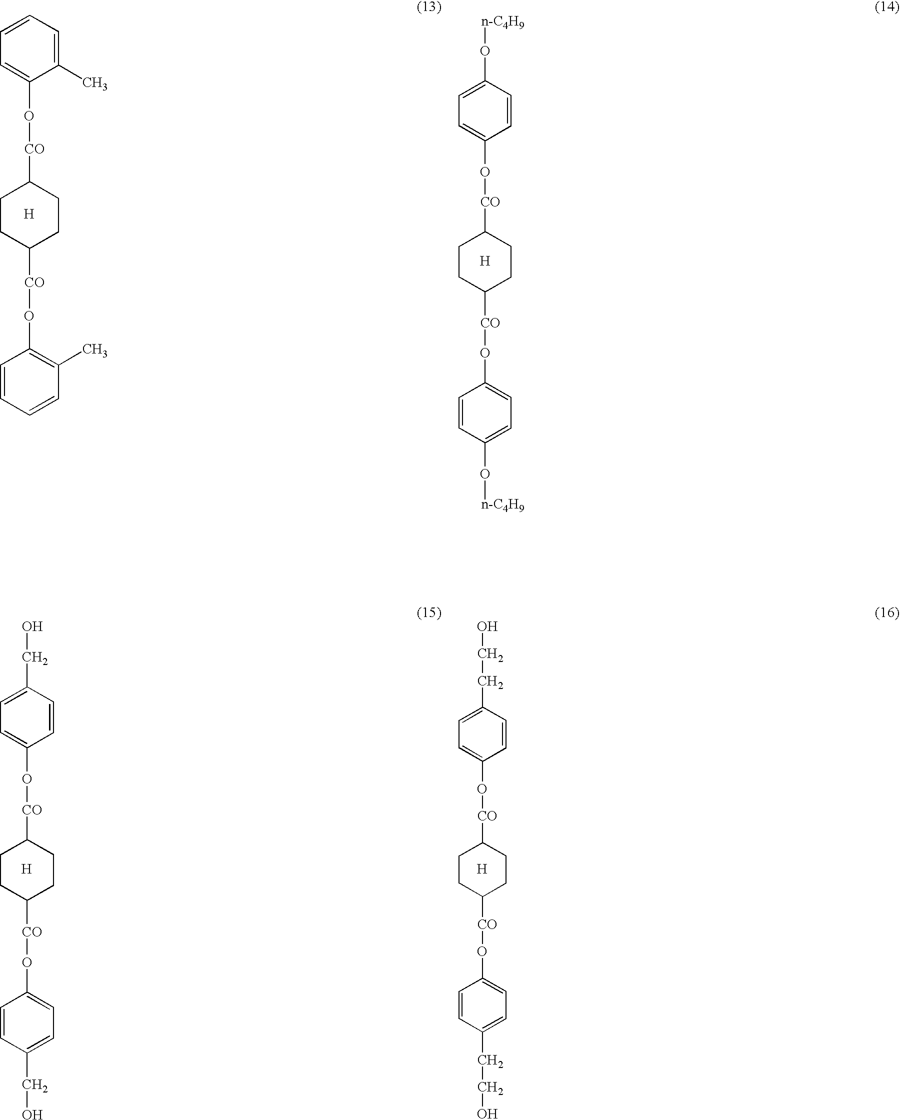

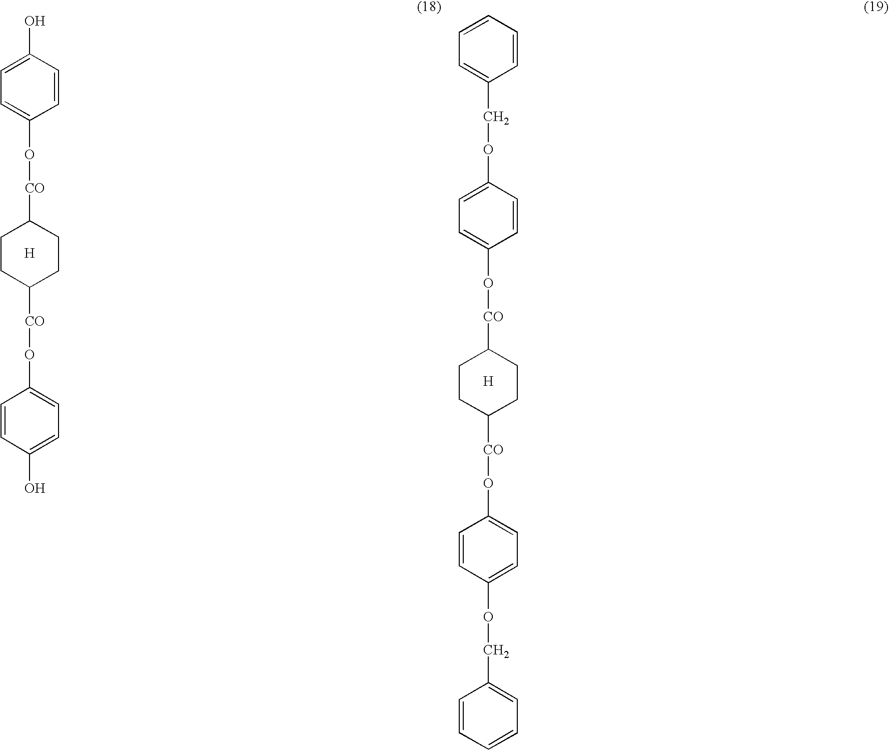

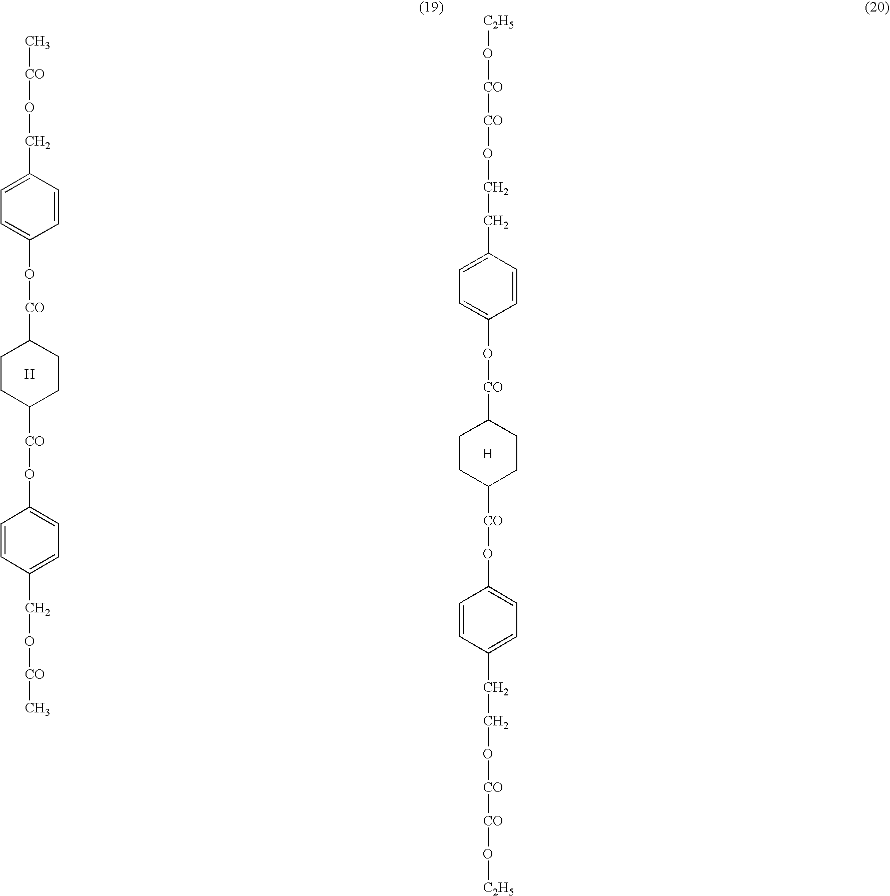

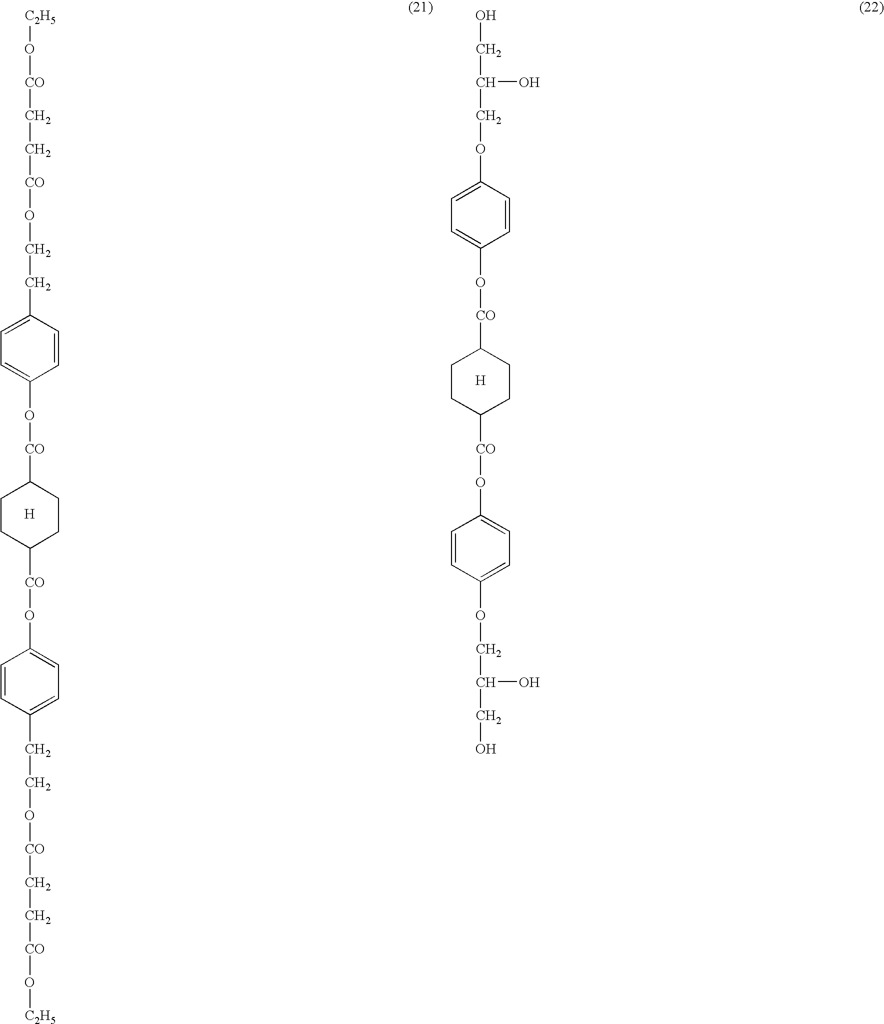

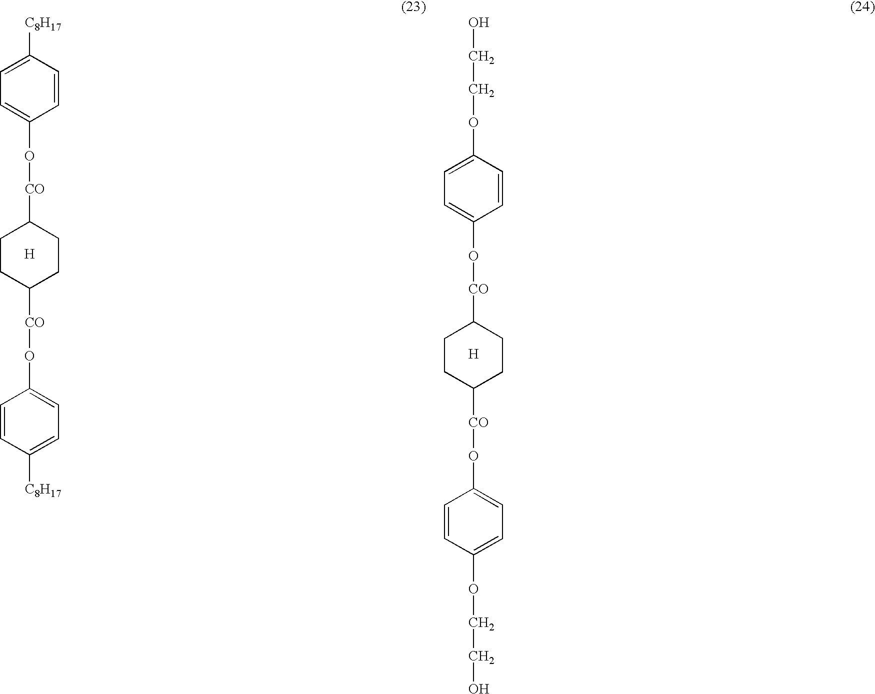

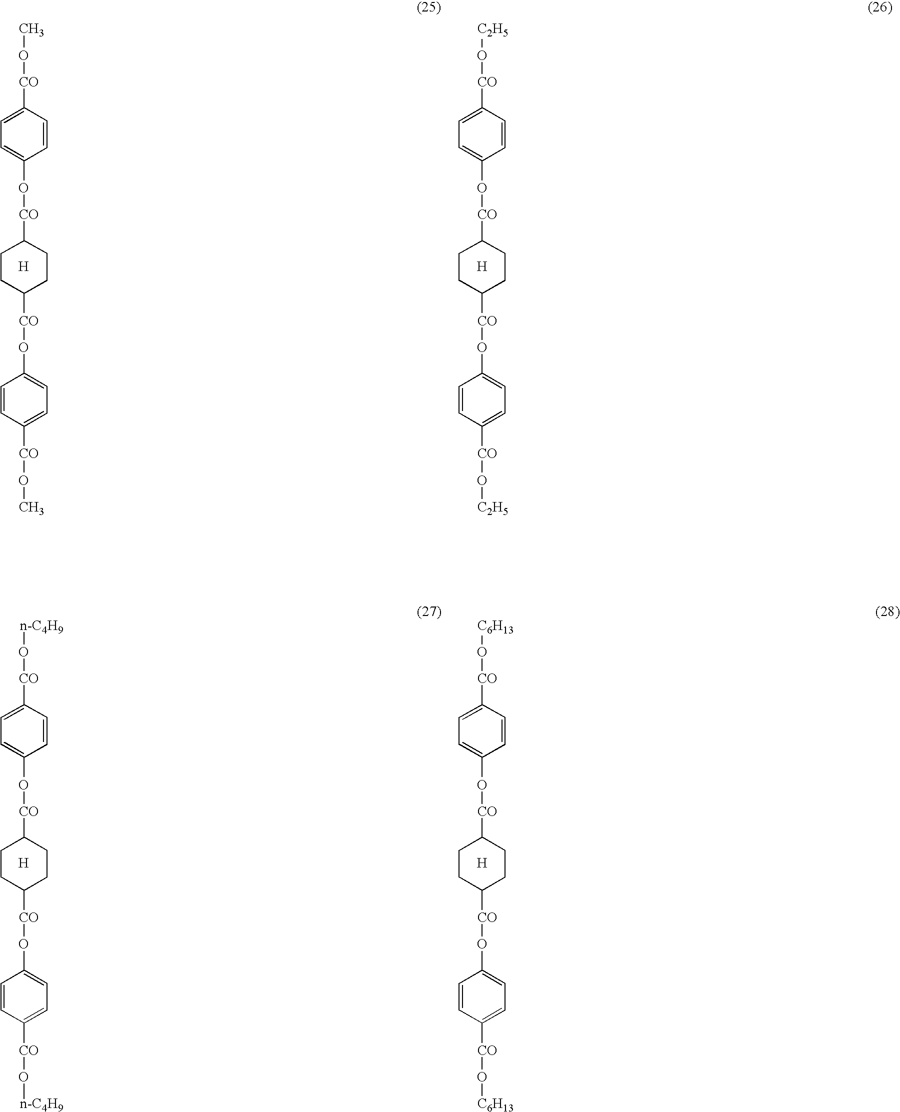

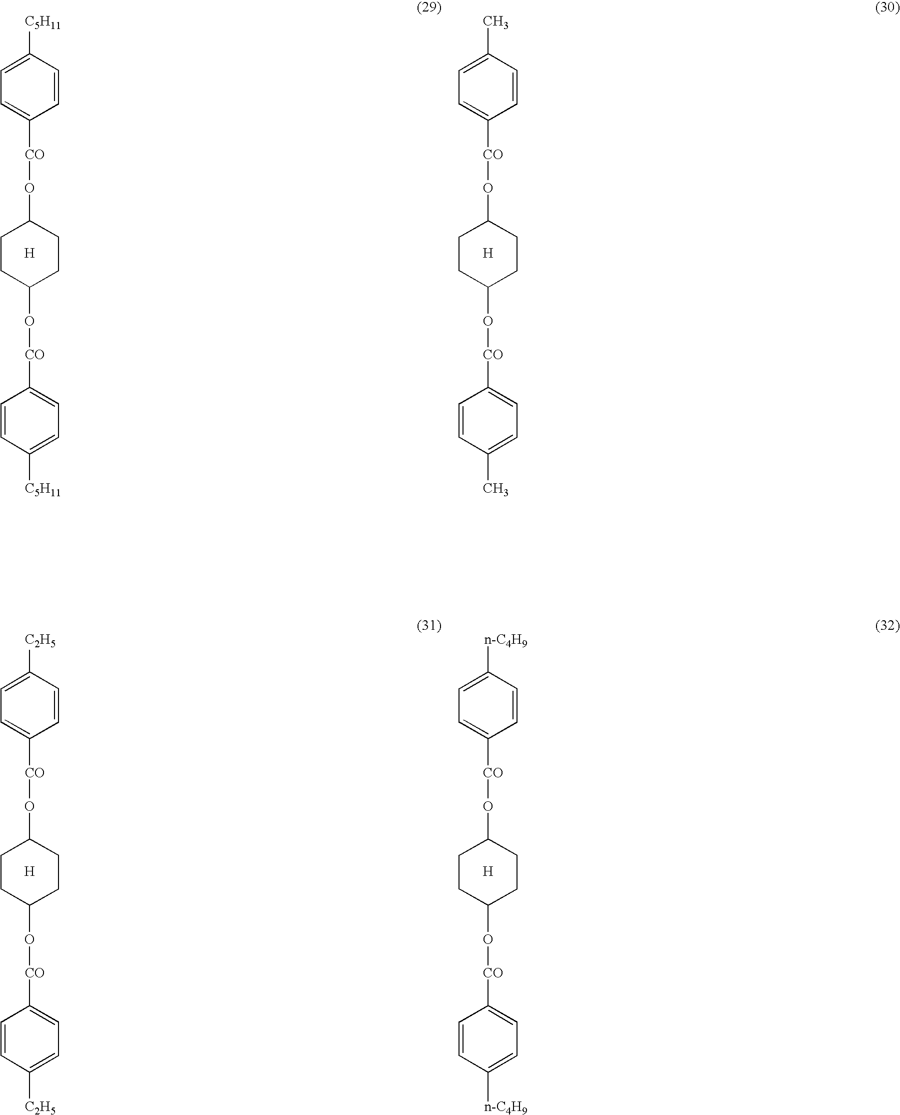

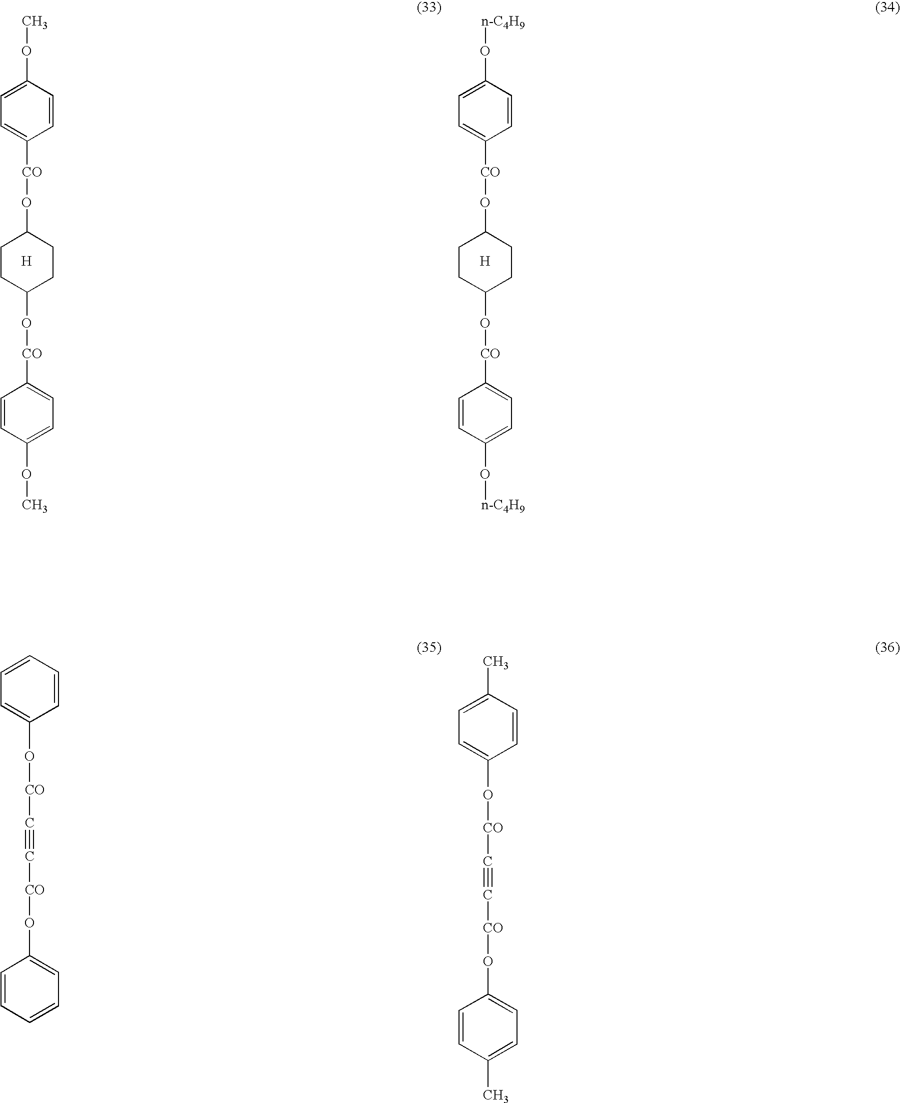

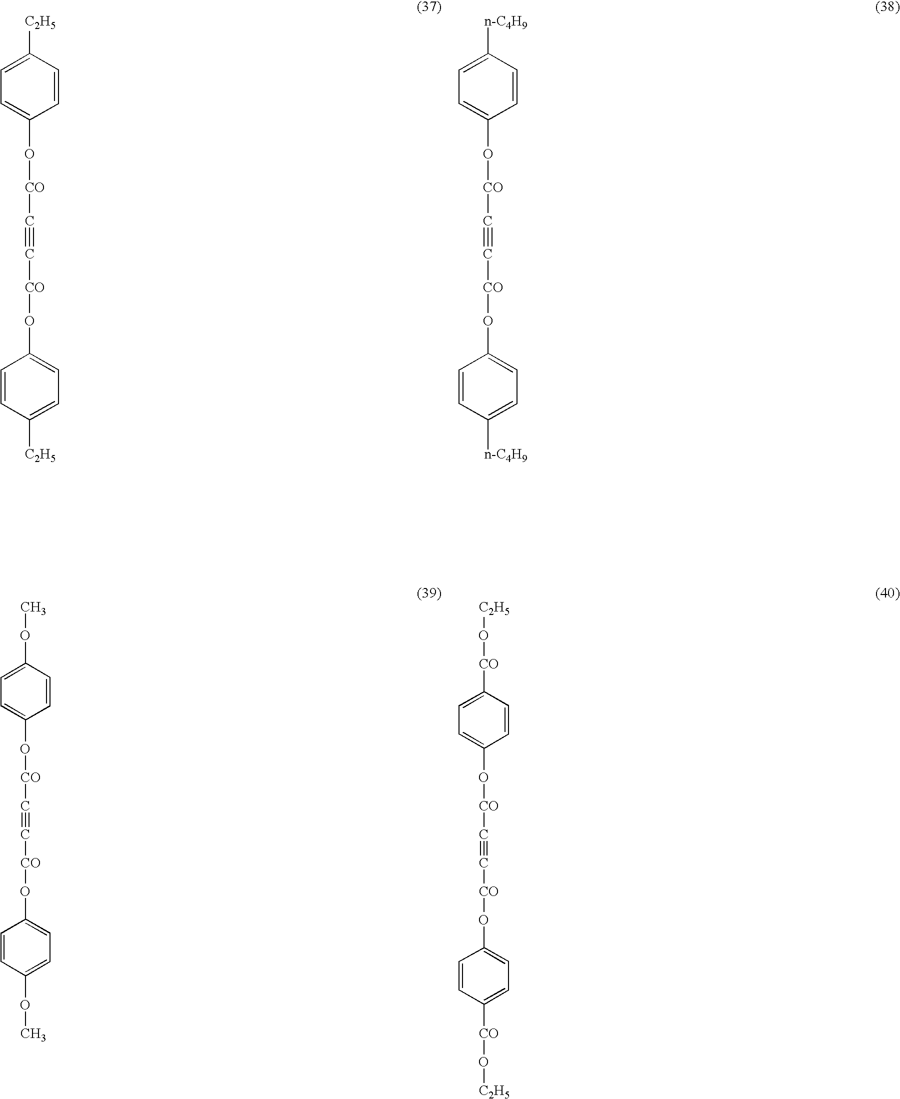

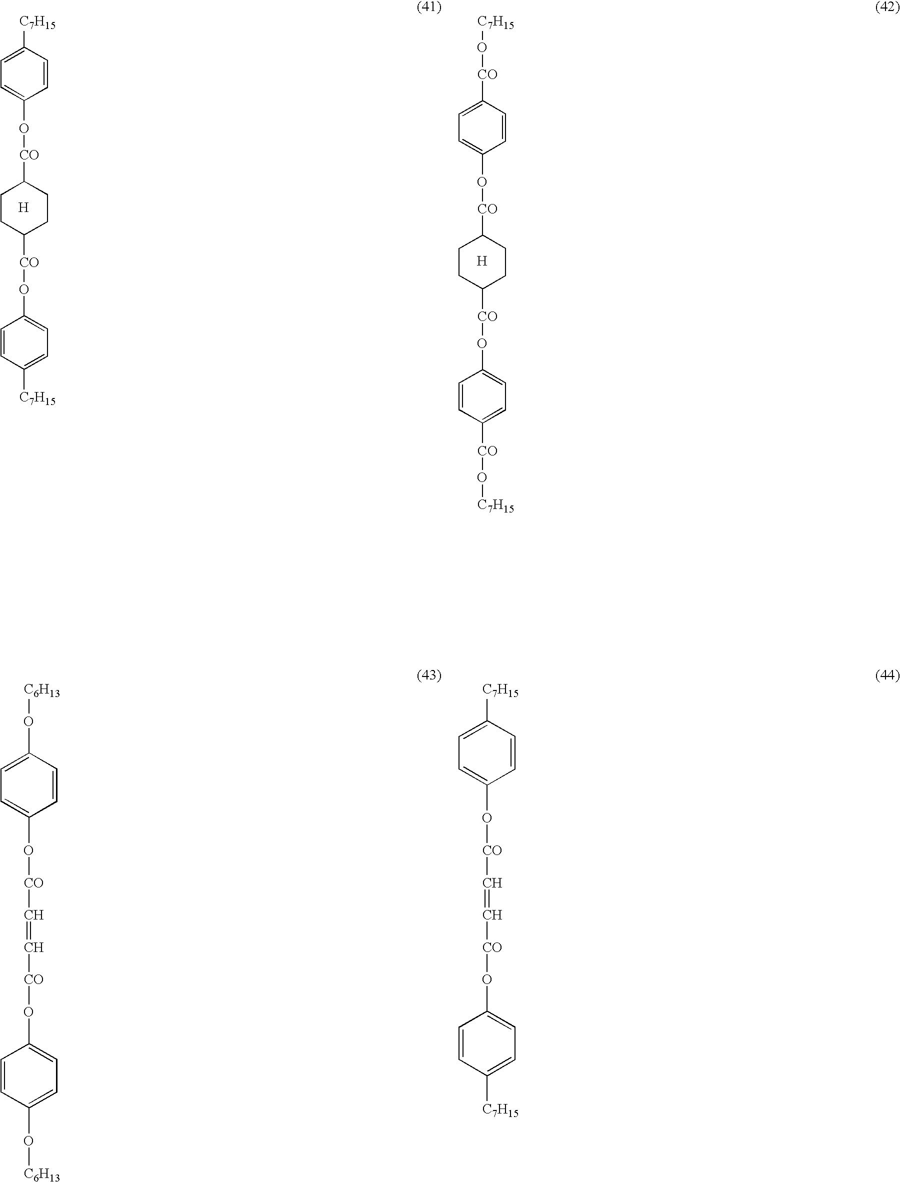

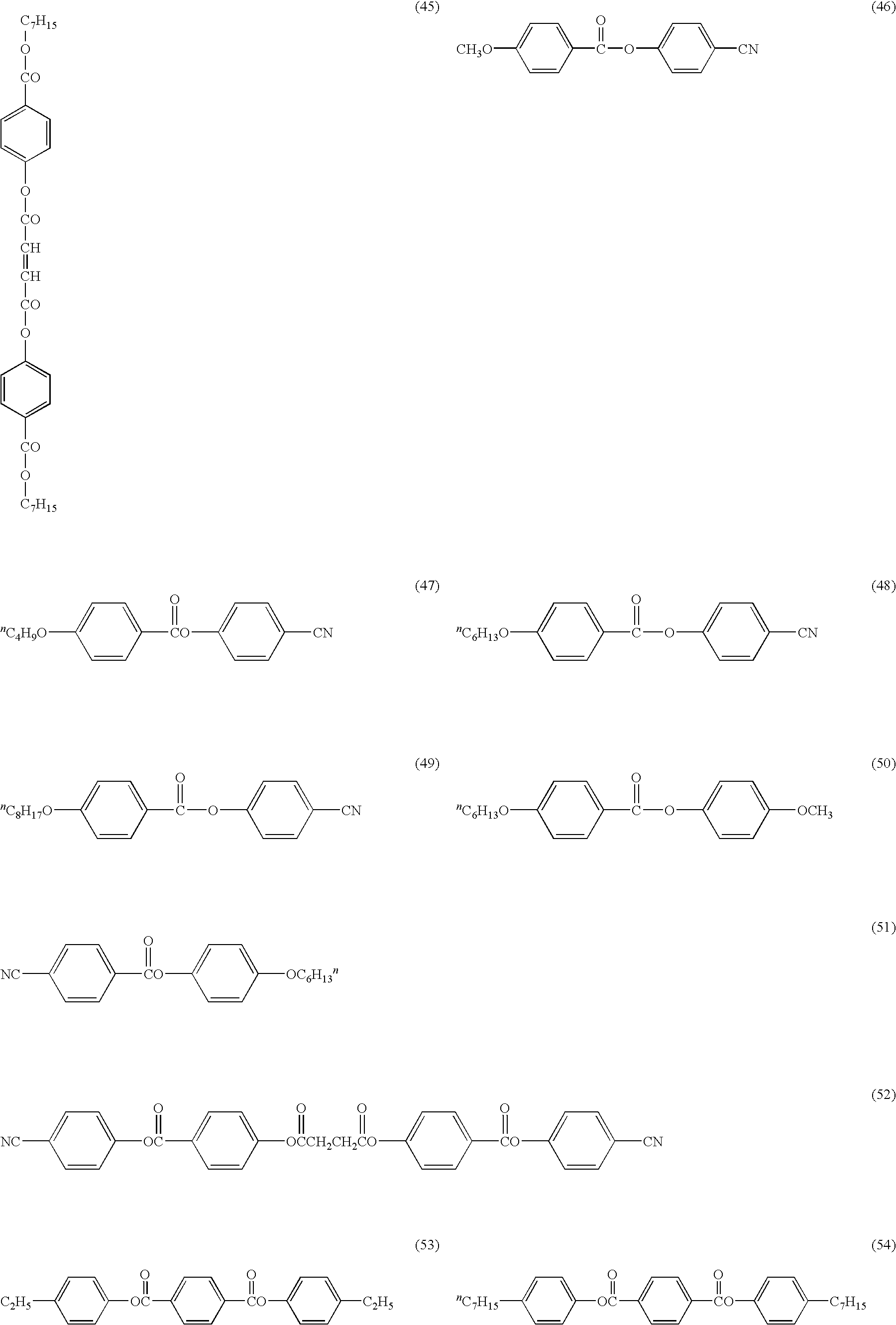

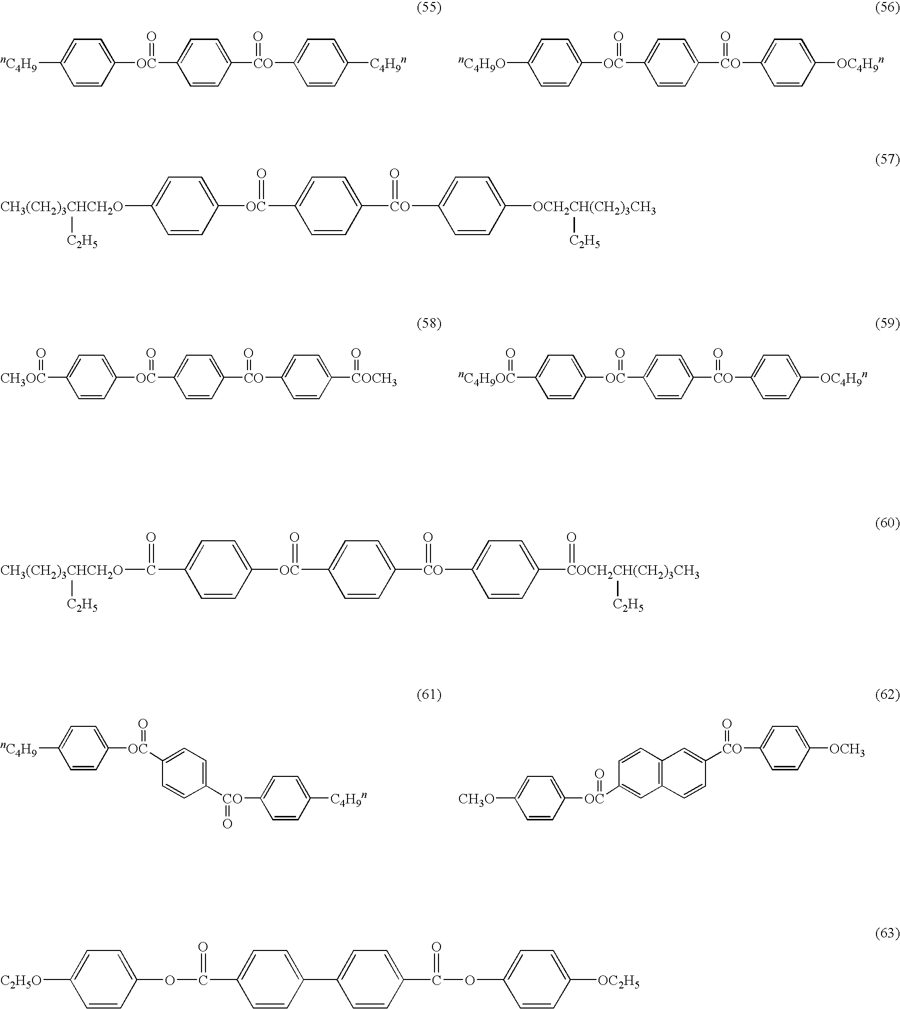

Specific examples (1)-(34), (41) and (42) have 2 asymmetric carbon atoms at 1- and 4-sites of the cyclohexane ring. However, since specific examples (1), (4)-(34), (41) and (42) have a symmetric molecular structure of meso form, there are no optical isomers (optical activity), and only geometric isomers (trans form and cis form) exist. The trans form (1-trans) and cis form (1-cis) of the specific example (1) are shown below.

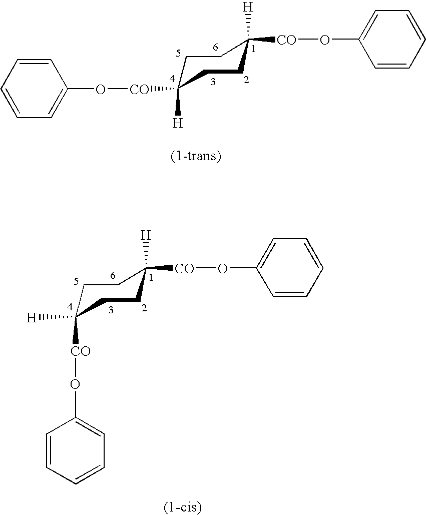

As described above, the rod-shaped compound preferably has a linear molecular structure. Therefore, a trans form is preferred to a cis form.

Specific examples (2) and (3) have optical isomers in addition to geometric isomers (4 kinds of isomers in total). As for the geometric isomers, similarly, the trans form is preferred to the cis form. There are no particular relative merits between the optical isomers, and any of D-, L- and racemic forms may be sufficient.

As for specific examples (43)-(45), there are the trans form and cis form due to the vinylene bond at the center. According to the same reason as described above, the trans form is preferred to the cis form.

As the retardation enhancer in the invention, also usable are polymer additives like the above-mentioned low-molecular-weight compounds. The polymer additives are selected from polyester polymers, styrenic polymers and acrylic polymers, and their copolymers, and are preferably aromatic polyesters.

The aromatic polyester polymers for use in the invention are obtained by copolymerizing the above-mentioned polyester polymers with a monomer having an aromatic ring. The monomer having an aromatic ring is at least one monomer selected from aromatic dicarboxylic acids having from 8 to 20 carbon atoms, and aromatic diols having from 6 to 20 carbon atoms.

The aromatic dicarboxylic acids for use in the film of the invention having from 8 to 20 carbon atoms include phthalic acid, terephthalic acid, isophthalic acid, 1,5-naphthalene dicarboxylic acid, 1,4-naphthalene dicarboxylic acid, 1,8-naphthalene dicarboxylic acid, 2,8-naphthalene dicarboxylic acid and 2,6-naphthalene dicarboxylic acid etc. Preferable aromatic dicarboxylic acids are phthalic acid, terephthalic acid and isophthalic acid.

The aromatic diols having from 6 to 20 carbon atoms, not limited, include Bisphenol A, 1,2-hydroxybenzene, 1,3-hydroxybenzene, 1,4-hydroxybenzene, 1,4-dimethylolbenzene, and preferably include bisphenol A, 1,4-hydroxybenzene and 1,4-dimethylolbenzene.

In the invention, the above-mentioned polyester is combined with at least one of aromatic dicarboxylic acids or aromatic diols, and the combination is not specifically defined. Different types of the respective ingredients may be combined with no problem. In the invention, especially preferred are high-molecular-weight additives the terminal of which is blocked with an alkyl group or an aromatic group, as so mentioned in the above; and for the blocking, the above-mentioned method may be employed.

The retardation enhancer in the invention is preferably an Re enhancer from the viewpoint of efficiently enhancing Re and realizing a suitable Nz factor. Of the retardation enhancers, the Re enhancer includes, for example, discotic compounds and rod-shaped compounds. Of those, preferred are triazine compounds having plural aromatic rings, and the above-mentioned rod-shaped compounds (1) to (7).

More preferably, the film of the invention contains a retardation enhancer in the skin B layer thereof from the viewpoint that the retardation enhancer can control the retardation of the core layer and the skin layer (as the case may be, it can enhance the expressibility of the optical properties of the film) thereby preventing the fluctuation of the retardation caused by the thickness unevenness of the core layer and the skin layer.

Even more preferably, the film of the invention contains a retardation enhancer in the core layer thereof, and contains, in the skin B layer thereof, a retardation enhancer the ability of which to enhance retardation is higher than that of the retardation enhancer in the core layer, from the viewpoint that the retardation enhancers can control the retardation of the core layer and the skin layer thereby preventing the fluctuation of the retardation of the film caused by the thickness unevenness of the core layer and the skin layer thereof.

Also preferably, the film of the invention contains a retardation reducer in the core layer thereof from the viewpoint that the retardation reducer can control the retardation of the core layer and the skin layer thereby preventing the fluctuation of the retardation of the film caused by the thickness unevenness of the core layer and the skin layer thereof; more preferably the film contains a retardation reducer in the core layer and contains a retardation enhancer in the skin B layer thereof.

Preferably, the film of the invention contains a retardation enhancer in the skin B layer thereof and contains a retardation reducer in the skin B layer from the viewpoint of controlling the balance of Re and Rth of the film. Also preferably, the core layer contains a retardation enhancer and the skin B layer contains a retardation enhancer the ability of which to enhance retardation is higher than that of the retardation enhancer in the core layer and further contains a retardation reducer, from the viewpoint of controlling the balance of Re and Rth of the film. Also preferably, the core layer contains a retardation enhancer and a retardation reducer, and the skin B layer contains a retardation enhancer the ability of which to enhance retardation is higher than that of the retardation enhancer in the core layer and further contains a retardation reducer, from the viewpoint of controlling the balance of Re and Rth of the film.

Preferably, the film of the invention contains at least one in-plane retardation Re enhancer selected from retardation enhancers, in at least one skin layer, from the viewpoint of realizing a suitable Nz factor and realizing uniform optical expressibility.

Preferably, the film of the invention contains at least one thickness-direction retardation Rth reducer selected from retardation reducers, in the core layer, from the viewpoint of realizing a suitable Nz factor and realizing uniform optical expressibility.

More preferably, the film of the invention contains at least one Re enhancer in at least one skin layer, and contains at least one Rth reducer in the core layer.

### (Other Additives)

The cellulose acyalete laminate film of the invention may contain any other additives if needs. The other additives include an antiaging agent, a UV absorbent, a release promoter, a matting agent, a lubricant, the plasticizer mentioned above, etc.

### (Antiaging Agent)

Any known antiaging agent (antioxidant) may be added to the cellulose acylate laminate film in the invention. For example, phenolic or hydroquinone-based antioxidants may be added, including 2,6-di-tert-butyl-4-methylphenol, 4,4′-thiobis-(6-tert-butyl-3-methylphenol), 1,1′-bis(4-hydroxyphenyl)cyclohexane, 2,2′-methylenebis(4-ethyl-6-tert-butylphenol), 2,5-di-tert-butylhydroquinone, pentaerythrityl tetrakis[3-(3,5-di-tert-butyl-4-hydroxyphenyl)propionate], etc. Also preferred are phosphorus-containing antioxidants such as tris(4-methoxy-3,5-diphenyl)phosphite, tris(nonylphenyl)phosphite, tris(2,4-di-tert-butylphenyl)phosphite, bis(2,6-di-tert-butyl-4-methylphenyl)pentaerythritol diphosphite, bis(2,4-di-tert-butylphenyl)pentaerythritol diphosphite, etc. The amount of the antiaging agent to be added may be from 0.05 to 5.0 parts by mass relative to 100 parts by mass of the cellulose acylate resin.

### (UV Absorbent)

From the viewpoint of preventing the deterioration of polarizers and liquid crystals, a UV absorbent is favorably added to the cellulose acylate laminate film in the invention. Preferably, the UV absorbent has an excellent UV-absorbing capability at a wavelength of at most 370 nm, and has little absorption of visible light having a wavelength of at least 400 nm, from the viewpoint of good liquid crystal display capability. Preferred examples of the UV absorbent for use in the invention include hindered phenol compounds, hydroxybenzophenone compounds, benzotriazole compounds, salicylate compounds, benzophenone compounds, cyanoacrylate compounds, nickel complex compounds, etc. Examples of the hindered phenol compounds include 2,6-di-tert-butyl-p-cresol, pentaerythrityl tetrakis[3-(3,5-di-tert-butyl-4-hydroxyphenyl)propionate], N,N′-hexamethylenebis(3,5-di-tert-butyl-4-hydroxy-hydrocinnamide), 1,3,5-trimethyl-2,4,6-tris(3,5-di-tert-butyl-4-hydroxybenzyl)benzene, tris-(3,5-di-tert-butyl-4-hydroxybenzyl)isocyanurate, etc. Examples of the benzotriazole compounds include 2-(2′-hydroxy-5′-methylphenyl)benzotriazole, 2,2-methylenebis(4-(1,1,3,3-tetramethylbutyl)-6-(2H-benzotriazol-2-yl)phenol), (2,4-bis(n-octylthio)-6-(4-hydroxy-3,5-di-tert-butylanilino)-1,3,5-triazine, triethylene glycol-bis[3-(3-tert-butyl-5-methyl-4-hydroxyphenyl)propionate], N,N′-hexamethylenebis(3,5-di-tert-butyl-4-hydroxy-hydrocinnamide), 1,3,5-trimethyl-2,4,6-tris(3,5-di-tert-butyl-4-hydroxybenzyl)benzene, 2-(2′-hydroxy-3′,5′-di-tert-butylphenyl)-5-chlorobenzotriazole, 2-(2′-hydroxy-3′,5′-di-tert-amylphenyl)-5-chlorobenzotriazole, 2,6-di-tert-butyl-p-cresol, pentaerythrityl tetrakis[3-(3,5-di-tert-butyl-4-hydroxyphenyl)propionate], etc. The amount of the UV absorbent to be added is preferably from 1 ppm to 1.0%, more preferably from 10 to 1000 ppm in terms of the ratio by mass thereof in the entire cellulose acylate laminate film.

### (Release Promoter)

Preferably, the film of the invention contains a release promoter from the viewpoint of further promoting the releasability thereof. The release promoter may be in the film, for example, in a ratio of from 0.001 to 1% by weight. Preferably, the content is at most 0.5% by weight since the releasing agent hardly separates from the film; and also preferably, the content is at least 0.005% by weight since a required release reduction effect may be realized. Accordingly, preferably, the content is from 0.005 to 0.5% by weight, more preferably from 0.01 to 0.3% by weight. The release promoter may be any known one, including organic and inorganic acid compounds, surfactants, chelating agents, etc. Above all, polycarboxylic acids and their esters are effective; and ethyl esters of citric acid are more effective.

Preferably, the film of the invention contains the release promoter in the skin B layer thereof.

### (Matting Agent)

In general, particles are added to the film of the invention for the purpose of preventing the film from being scratched while it is handled and preventing the transferability of the film from worsening. The particles are referred to as a matting agent, an antiblocking agent or an anti-creaking agent and are heretofore used in the art. Not specifically defined, the material of the particles may be any one capable of having the function as above. It may be a matting agent of an inorganic compound or a matting agent of an organic compound.

Preferred examples of the matting agent of an inorganic compound include silicon-containing inorganic compounds (e.g., silicon dioxide, calcined calcium silicate, hydrated calcium silicate, aluminium silicate, magnesium silicate, etc.), titanium oxide, zinc oxide, aluminium oxide, barium oxide, zirconium oxide, strontium oxide, antimony oxide, tin oxide, tin-antimony oxide, calcium carbonate, talc, clay, calcined kaolin, calcium phosphate, etc. More preferred are silicon-containing inorganic compounds and zirconium oxide. Particularly preferred is silicon dioxide since it can reduce the haze of cellulose acylate films. As fine particles of silicon dioxide, marketed productions can be used, including, for example, AEROSIL R972, R972V, R974, R812, 200, 200V, 300, R202, OX50 and TT600 (all of them are manufactured by NIPPON AEROSIL CO., LTD.) etc. As fine particles of zirconium oxide, for example, those available in the market under trade names of AEROSIL R976 and R811 (manufactured by NIPPON AEROSIL CO., LTD.) can be used.

Preferred examples of the matting agent of an organic compound include polymers such as silicone resins, fluororesins, acrylic resins, etc. Above all, more preferred are silicone resins. Of silicone resins, even more preferred are those having a three-dimensional network structure. For example, usable are commercial products of Tospearl 103, Tospearl 105, Tospearl 18, Tospearl 120, Tospearl 145, Tospearl 3120 and Tospearl 240 (all trade names by Toshiba Silicone), etc.

When the matting agent is added to a cellulose acylate solution, any method is employable with no problem, as long as it can produce a desired cellulose acylate solution. For example, the additive may be added in the stage where a cellulose acylate is mixed with a solvent; or the additive may be added to a mixture solution prepared from a cellulose acylate and a solvent. Further, the additive may be added to and mixed with a dope just before the dope is cast, and this is a so-called direct addition method, in which the ingredients may be on-line mixed by screw kneading. Concretely, preferred is a static mixer such as an in-line mixer. As the in-line mixer, for example, preferred is a static mixer, SWJ (Toray's static tubular mixer, Hi-Mixer, by Toray Engineering). Regarding the mode of in-line addition, JP-A 2003-053752 describes an invention of a method for producing a cellulose acylate film wherein, for the purpose of preventing concentration unevenness and particle aggregation, the distance L between the nozzle tip through which an additive liquid having a composition differing from that of the main material dope and the start end of an in-line mixer is controlled to be at most 5 times the inner diameter d of the main material feeding line, thereby preventing concentration unevenness and aggregation of matting particles, etc. The patent reference discloses a more preferred embodiment, in which the distance (L) between the nozzle tip opening through which an additive liquid having a composition differing from that of the main material dope and the start end of the in-line mixer is controlled to be at most 10 times the inner diameter (d) of the feeding nozzle tip opening, and the in-line mixer is a static non-stirring tubular mixer or a dynamic stirring tubular mixer. More concretely, the patent reference discloses that the flow ratio of the cellulose acylate film main material dope/in-line additive liquid is from 10/1 to 500/1, more preferably from 50/1 to 200/1. JP-A 2003-014933 discloses an invention of providing a retardation film which is free from a trouble of additive bleeding and a trouble of interlayer peeling and which has good lubricity and excellent transparency; and regarding the method of adding additives to the film, the patent reference says that the additive may be added to a dissolving tank, or the additive or a solution or dispersion of the additive may be added to the dope being fed in the process from the dissolving tank to a co-casting die, further describing that in the latter case, mixing means such as a static mixer is preferably provided for the purpose of enhancing the mixing efficiency therein.

Preferably, the film of the invention contains a matting agent in at least one of the skin A layer and the skin B layer for the purpose of enhancing the scratch resistance of the film by reducing the friction coefficient on the film surface, and for the purpose of preventing the film that is wide and long from being creaked and folded while it is rolled up. More preferably, a matting agent is added to both the skin A layer and the skin B layer of the film for the purpose of more effectively enhancing the scratch resistance of the film and preventing the film from being creaked.

In the film of the invention, the matting agent does not increase the haze of the film so far as a large amount of the agent is not added to the film. In fact, when the film containing a suitable amount of a matting agent is used in LCD, the film hardly brings disadvantages of contract reduction and bright spot formation. Not too small amount, the matting agent in the film can realize the creaking resistance and the scratch resistance of the film. From these viewpoints, the matting agent content is preferably from 0.01 to 5.0% by weight, more preferably from 0.03 to 3.0% by weight, even more preferably from 0.05 to 1.0% by weight.

### (Haze)

The cellulose acylate laminate film of the invention preferably has a haze of less than 1%, more preferably less than 0.5%. Having a haze of less than 1%, the transparency of the cellulose acylate film is enough high to use as a cellulose acylate laminate film.

### (Mean Water Content)

The cellulose acylate film of the invention preferably has an equilibrium water content of at most 4% at 25° C. and relative humidity 60%, more preferably at most 3%. Having a mean water content of at most 4%, the film may well answer to the ambient humidity change and is therefore favorable since the optical properties and the dimension thereof change little.

### (Re, Rth)

When the film of the invention is used as a retardation film, its retardation, Re and Rth may be suitably determined depending on the function of the optical film itself and on the design of the liquid-crystal cell to which the film is applied. In general, it is preferable that the in-plane retardation Re is 25 nm≦|Re|≦100 nm; and the thickness-direction retardation Rth is 50 nm≦|Rth|≦250 nm. More preferably, 30 nm≦|Re|≦80 nm, even more preferably 35 nm≦|Re|≦70 nm. Also preferably, 70 nm≦|Rth|≦240 nm, more preferably 90 nm≦|Rth|≦230 nm.

Re(λ) and Rth(λ) represent, herein, the retardation in the plane and the retardation in the thickness direction, respectively, at a wavelength of λ. Re(λ) is measured with KOBRA 21ADH or WR (by Oji Scientific Instruments) while allowing light having the wavelength of λ nm to enter in the normal direction of a film.

With the in-plane slow axis (determined by KOBRA 21ADH or WR) taken as the inclination axis (rotation axis) of the sample (in case where the sample has no slow axis, the rotation axis of the sample may be in any in-plane direction of the sample), Re(λ) of the sample is measured at 6 points in all thereof, up to +50° relative to the normal line direction of the sample at intervals of 10°, by applying a light having a wavelength of λ nm from the inclined direction of the sample.

With the slow axis taken as the inclination axis (rotation axis) (in case where the sample has no slow axis, the rotation axis of the sample may be in any in-plane direction of the film), the retardation values of the sample are measured in any inclined two directions; and based on the data and the mean refractive index and the inputted thickness of the sample, Rth may be calculated according to the following formulae (A) and (B).

The mean refractive index may be used values described in catalogs for various types of optical films. When the mean refractive index has not known, it may be measured with Abbe refractometer. The mean refractive index for major optical film is described below: cellulose acylate (1.48), cycloolefin polymer (1.52), polycarbonate (1.59), polymethylmethacrylate (1.49), polystyrene (1.59).

By inputting the value of these average refraction indices and thickness, KOBRA 21ADH or WR computes nx, ny, nz. From the computed nx, ny, nz, Nz=(nx−nz)/(nx−ny) is computed further.

$$Re ( θ ) = [ nx - \frac{ny \times nz}{\sqrt{\begin{matrix}{( ny sin ( {sin}^{- 1} ( \frac{sin ( - θ )}{nx} ) ) )}^{2} + \\ {( nz cos ( {sin}^{- 1} ( \frac{sin ( - θ )}{nx} ) ) )}^{2}\end{matrix}}} ] \times \frac{d}{cos \{ {sin}^{- 1} ( \frac{sin ( - θ )}{nx} ) \}} \qquad ( A )$$

The above Re(θ) represents the retardation in a direction that inclines in the degree of θ from the normal direction; and d is a thickness of the film.

Rth={(nx+ny)/2−nz}d (B)

In this, the mean refractive index n is needed as a parameter, and it is measured with an Abbe refractiometer (Atago's Abbe Refractiometer 2-T).

Nz factor may be suitably determined depending on the function of the optical film itself and on the design of the liquid-crystal cell to which the film is applied. The film of the invention preferably has an Nz factor represented by the following formula (7) is at most 7, more preferably at most 5.5, particularly preferably at most 4.5:

Nz factor=(Rth/Re)+0.5. (7)

### (ΔRe)

Preferably, the Re fluctuation (hereinafter this may be referred to as ΔRe) of the film of the invention is at most 10 nm from the viewpoint of reducing the visibility unevenness of the liquid-crystal display device to which the film is fitted. More preferably, it is at most 7 nm, even more preferably at most 5 nm.

### (ΔRth)

Also preferably, the Rth fluctuation (hereinafter this may be referred to as ΔRth) of the film of the invention is at most 10 nm from the viewpoint of reducing the visibility unevenness of the liquid-crystal display device to which the film is fitted. More preferably, it is at most 10 nm, even more preferably at most 7 nm.

ΔRth and ΔRe may be measured according to the method mentioned below. The film to be analyzed is equally divided into 11 divisions in any desired site in the cross direction of the film, and from the 10 points, the film is sampled at intervals of 0.2 m in the machine direction of the film in a total of 9 sections in every one line to give samples each having a size of 10 mm×10 mm. Thus collected, all 100 samples were tested for Rth; and the absolute value of the Rth difference between the sample having a largest Rth and the sample having a smallest Rth is taken as ΔRth. Similarly, the absolute value of the Re difference between the sample having a largest Re and the sample having a smallest Re of all the 100 samples is taken as ΔRe.

### (Film Thickness)

Preferably, the mean thickness of the core layer of the film of the invention is from 30 to 100 μm, more preferably from 30 to 80 μm, even more preferably from 30 to 70 μm. When the core layer has a mean thickness of at least 30 μm, the handlability of the film is favorably good in producing the film as a web. When the core layer has a mean thickness of at most 70 μm, the film may readily follow the ambient humidity change and may keep its optical properties.

In the film of the invention, the mean thickness of at least one of the skin A layer or the skin B layer is preferably from 0.2% to less than 25% of the mean thickness of the core layer. When it is at least 0.2%, then the releasability of the film may be enough, and the film may have reduced troubles of streaky surface unevenness, thickness unevenness and uneven optical properties of the film; and when less than 25%, the core layer may effectively exhibit its optical expressibility. In order that the laminate film can have satisfactory optical properties, the mean thickness of at least one of the skin A layer or the skin B layer is more preferably from 0.5 to 15% of the mean thickness of the core layer, even more preferably from 1.0 to 10%. Still more preferably, the mean thickness of both the skin A layer and the skin B layer is from 0.2% to less than 25% of the mean thickness of the core layer.

### (Film Width)

The film width of the film of the invention is preferably from 700 to 3000 mm, more preferably from 1000 to 2800 mm, particularly preferably from 1500 to 2500 mm.

The film of the invention is also preferably the film width thereof is from 700 to 3000 mm and ΔRe is at most 10 nm.

### [Production of Cellulose Acylate Laminate Film]

A method for producing a cellulose acylate laminate film of the invention (hereinafter referred to as a producing method of the invention) has a step of simultaneously or successively multilayer-casting a dope for a skin B layer containing a cellulose acylate satisfying the formula (2) and a dope for a core layer containing a cellulose acylate satisfying the formula (1) on a support in that order, a step of drying the multilayer-cast dope and peeling it from the support, a step of stretching the peeled film, wherein a retardation-controlling agent is added to at least one of the dope for the core layer or the dope for the skin B layer.

In the producing method of the invention, the film of the invention is produced according to a solvent casting method. In the solvent casting method, the film is produced with a solution in which a cellulose acylate is dissolved in organic solvents (hereinafter this may be referred to as “dope”).

The organic solvents are preferably selected from ethers having 3-12 carbon atoms, esters having 3-12 carbon atoms, ketones having 3-12 carbon atoms and halogenated hydrocarbons having 1-6 carbon atoms. The ethers, the ketones and the esters may have a cyclic structure. Compounds having two or more functional groups of ethers, esters and ketones (i.e., —O—, —CO— and —COO—) are also usable herein as the organic solvent; and they may have any other functional group such as an alcoholic hydroxyl group. In case where the organic solvent has two or more functional groups, the number of the carbon atoms constituting them may fall within a range of the number of carbon atoms that constitute the compound having any of those functional groups.

Examples of the ethers having 3-12 carbon atoms are diisopropyl ether, dimethoxymethane, dimethoxyethane, 1,4-dioxane, 1,3-dioxolane, tetrahydrofuran, anisole and phenetole.

Examples of the ketones having 3-12 carbon atoms are acetone, methyl ethyl ketone, diethyl ketone, diisobutyl ketone, cyclohexanone, methylcyclohexanone.

Examples of the esters having 3-12 carbon atoms are ethyl formate, propyl formate, pentyl formate, methyl acetate, ethyl acetate, pentyl acetate.

Examples of the organic solvents having plural functional groups are 2-ethoxyethyl acetate, 2-methoxyethanol and 2-butoxyethanol.

The number of the carbon atoms constituting the halogenohydrocarbon is preferably 1 or 2, most preferably 1. The halogen in the halogenohydrocarbon is preferably chlorine. The proportion of the hydrogen atoms in the halogenohydrocarbon substituted with a halogen is preferably from 25 to 75 mol %, more preferably from 30 to 70 mol %, even more preferably from 35 to 65 mol %, most preferably from 40 to 60 mol %. Methylene chloride is a typical halogenohydrocarbon.

Two or more different types of organic solvents may be mixed for use in the invention.

The cellulose acylate solution may be prepared according to an ordinary method. In one general method, the solution is processed at a temperature not lower than 0° C. (room temperature or high temperature). For preparing the solution, employable is a method and an apparatus for dope preparation according to an ordinary solvent casting method. In the ordinary method, preferably used is a halogenohydrocarbon (especially methylene chloride) as the organic solvent.

The amount of the cellulose acylate is so controlled that it may be in the solution in an amount of from 10 to 40% by mass. The amount of the cellulose acylate is preferably from 10 to 30% by mass. To the organic solvent (main solvent), polymer X and any additives mentioned above can be added.

The solution is prepared by stirring a cellulose acylate and an organic solvent at room temperature (0 to 40° C.). A high-concentration solution may be stirred under pressure and under heat. Concretely, a cellulose acylate and an organic solvent are put into a pressure chamber, then closed and stirred therein and under heat at a temperature within a range between the boiling point of the solvent at room temperature and the boiling point under the pressure. The heating temperature is generally 40° C. or higher, preferably from 60 to 200° C., more preferably from 80 to 110° C.

The ingredients may be put into the chamber after roughly premixed. They may be put into the chamber one after another. The chamber must be so planned that the contents therein could be stirred. An inert gas such as nitrogen gas or the like may be introduced into the chamber to pressurize it. The solvent vapor pressure may increase under heat, and this may be utilized in process. Alternatively, after the chamber is closed, the ingredients may be introduced thereinto under pressure.

Preferably, the contents in the chamber are heated in an external heating mode. For example, a jacket type heating unit may be used. A plate heater may be disposed outside the chamber, and a liquid may be circulated through the pipeline disposed in the heater to thereby heat the entire chamber.

Also preferably, a stirring blade may be disposed inside the chamber, with which the contents may be stirred. The stirring blade preferably has a length that reaches near the wall of the chamber. At the tip of the stirring blade, a scraper is preferably provided for renewing the liquid film formed on the wall of the chamber.

The chamber may be equipped with various meters such as a pressure gauge, a thermometer, etc. In the chamber, the ingredients are dissolved in the solvent. Thus prepared, the dope is taken out of the chamber after cooled, or after taken out of it, the dope may be cooled with a heat exchanger or the like.

The solution may also be prepared according to a cooling dissolution method. According to the cooling dissolution method, a cellulose acylate may be dissolved even in an organic solvent in which it can be hardly dissolved in an ordinary dissolution method. For the solvent in which a cellulose acylate can be dissolved in an ordinary dissolution method, the cooling dissolution method is advantageous in that a uniform solution can be prepared rapidly.

In the cooling dissolution method, first, a cellulose acylate is gradually added to an organic solvent at room temperature with stirring. The amount of the cellulose acylate is so controlled that the resulting mixture can contain it in an amount of from 10 to 40% by mass. The amount of the cellulose acylate is more preferably from 10 to 30% by mass. Further, any desired additives to be mentioned below may be added to the mixture.

Next, the mixture is cooled to −100 to −10° C. (preferably −80 to −10° C., more preferably −50 to −20° C., most preferably −50 to −30° C.). The cooling may be attained, for example, in a dry ice/methanol bath (−75° C.) or in a cooled diethylene glycol solution (−30 to −20° C.). Thus cooled, the mixture of cellulose acylate and organic solvent is solidified.

The cooling speed is preferably at least 4° C./min, more preferably at least 8° C./min, most preferably at least 12° C./min. The cooling speed is preferably higher, but its theoretical uppermost limit is 10000° C./sec, the technical uppermost limit is 1000° C./sec, and the practicable uppermost limit is 100° C./sec. The cooling speed is a value computed by dividing the difference between the temperature at the start of the cooling and the final cooling temperature by the time taken from the start of the cooling to the arrival to the final cooling temperature.

Further, this is heated at 0 to 200° C. (preferably 0 to 150° C., more preferably 0 to 120° C., most preferably 0 to 50° C.), and the cellulose acylate is thereby dissolved in the organic solvent. For the heating, the solid may be left at room temperature, or may be heated in a hot bath. The heating speed is preferably at least 4° C./min, more preferably at least 8° C./min, most preferably at least 12° C./min. The heating speed is preferably higher; but its theoretical uppermost limit is 10000° C./sec, the technical uppermost limit is 1000° C./sec, and the practicable uppermost limit is 100° C./sec. The cooling speed is a value computed by dividing the difference between the temperature at the start of the heating and the final heating temperature by the time taken from the start of the heating to the arrival to the final heating temperature.

As in the above, a uniform solution can be obtained. When the dissolution is insufficient, then the cooling and heating operation may be repeated. As to whether or not the dissolution is satisfactory may be determined merely by visually observing the outward appearance of the solution.

In the cooling dissolution method, preferably used is a closed container for the purpose of preventing the mixture from being contaminated with water from the dew formed in cooling. In the cooling and heating operation, preferably, the chamber is made under pressure in cooling and is made under reduced pressure in heating, to thereby shorten the dissolution time. For the mode under pressure and under reduced pressure, preferably used is a pressure chamber.

A 20 mas. % solution prepared by dissolving a cellulose acylate (having a total degree of acetyl substitution of 60.9%, and having a viscosity-average degree of polymerization of 299) in methyl acetate according to the cooling dissolution method has a pseudo-phase transition point between a sol state and a gel state at around 33° C., when analyzed through differential scanning calorimetry (DSC), and at a temperature lower than the point, the solution is in the form of a uniform gel. Accordingly, the solution must be stored at a temperature not lower than the pseudo-phase transition temperature, preferably at around a temperature of the gel-phase transition temperature plus 10° C. or so. However, the pseudo-phase transition temperature differs, depending on the total degree of acetyl substitution and the viscosity-average degree of polymerization of the cellulose acylate and on the solution concentration and the organic solvent used.

### (Co-Casting)

From two or more kind of the thus-prepared cellulose acylate solution (dope), a cellulose acylate laminate film can be produced according to a solvent casting method.

The dope is cast on a drum or a band, on which the solvent is evaporated away to form a film. Before case, the concentration of the dope is preferably so planned that the solid content thereof is from 18 to 35% by mass. Preferably, the surface of the drum or the band is finished to be a mirror face. The casting and drying method in solvent casting is described in U.S. Pat. Nos. 2,336,310, 2,367,603, 2,492,078, 2,492,977, 2,492,978, 2,607,704, 2,739,069, 2,739,070, British Patents 640731, 736892, JP-B 45-4554, 49-5614, JP-A 60-176834, 60-203430, 62-115035.

Preferably, the dope is cast on a drum or a band at a surface temperature of not higher than 10° C. After thus cast, preferably, this is dried by exposing to air for at least 2 seconds. The formed film is peeled away from the drum or the band, and then it may be dried with high-temperature air of which the temperature is stepwise changed from 100° C. to 160° C. to thereby remove the residual solvent by vaporization. This method is described in JP-B 5-17844. According to the method, the time to be taken from the casting to the peeling may be shortened. In carrying out the method, the dope must be gelled at the surface temperature of the drum or the band on which it is cast.

In the invention, the prepared cellulose acylate solution may be cast onto a smooth band or drum serving as a metal support, as a single-layer solution; or plural cellulose acylate solutions for 2 or more layers may be co-cast thereon. In case where plural cellulose acylate solutions are co-cast, the cellulose acylate-containing solution may be cast onto a metal support through plural casting mouths disposed around the support at intervals in the machine direction, and the co-cast solutions may be laminated on the support to give a film. For example, the methods described in JP-A 61-158414, 1-122419, 11-198285 are employable. The cellulose acylate solution may be cast through two casting mouths to form a film, for which, for example, employable are the methods described in JP-B 60-27562, JP-A 61-94724, 61-947245, 61-104813, 61-158413, 6-134933. Also employable herein is a cellulose acylate film co-casting method of casting a flow of a high-viscosity cellulose acylate solution as enveloped with a low-viscosity cellulose acylate solution thereby simultaneously extruding both the high-viscosity and low-viscosity cellulose acylate solutions, as in JP-A 56-162617. Preferred is an embodiment where the outer solution contains a larger amount of a poor solvent, alcohol than in the inner solution, as in JP-A 61-94724, 61-94725.

Two casting mouths may be used as follows: A film is formed on a metal support through the first casting mouth, then this is peeled, and on the other surface of the film opposite to that having kept in contact with the metal support, another film is formed through the second casting mouth. For example, the method is described in JP-B44-20235. The cellulose acylate solutions to be cast may be the same or different with no specific limitation. In order to make the plural cellulose acylate layers have various functions, cellulose acylate solutions corresponding to the desired functions may be cast through the respective casting mouths. The cellulose acylate solution, in the present invention, may be cast along with any other functional layers (e.g., adhesive layer, dye layer, antistatic layer, antihalation layer, UV absorbent layer, polarizing layer). In the producing method of the invention, a step for casting is a simultaneously or successively multilayer-casting.

In case where a single-layer film is formed according to a conventional technique, a high-concentration and high-viscosity cellulose acylate solution must be extruded out in order to make the formed film have a desired thickness; but in such a case, the stability of the cellulose acylate solution is poor therefore causing various problems of solid deposition to be fish eyes or to roughen the surface of the film. For solving the problems, plural cellulose acylate solutions are cast out through different casting mouths, whereby high-density solutions can be extruded out at the same time on a metal support, and as a result, the surface properties of the formed films are bettered and films having excellent surface properties can be produced. In addition, since such thick cellulose acylate solutions can be used and the drying load in the process can be reduced, and the film producibility is enhanced.

In co-casting, the thickness of the outer layer and the inner layer is not specifically defined. Preferably, the thickness of the outer layer is from 0.2 to 50% of the overall thickness of the film, more preferably from 2 to 30%. In co-casting of three or more layers, the total thickness of the layer adjacent to the metal support and the outermost layer adjacent to air is defined to be the thickness of the outer layer.

In another embodiment of co-casting, cellulose acylate solutions in which the density of the additives such as the above-mentioned plasticizer, UV absorbent, matting agent and the like differs may be co-cast to produce a cellulose acylate film having a laminate structure. For example, a cellulose acylate film having a constitution of skin layer/core layer/skin layer can be produced. For example, the matting agent may be much in the skin layer, or may be only in the skin layer. The plasticizer and the UV absorbent may be more in the core layer than in the skin layer, or may be only in the core layer. The type of the plasticizer and the UV absorbent may differ between the core layer and the skin layer. For example, a low-volatile plasticizer and/or UV absorbent may be in the skin layer, and a plasticizer of excellent plasticization or a UV absorbent of excellent UV absorption may be added to the core layer. An embodiment of adding a release agent to only the skin layer on the side of the metal support is also preferred. In order to gel the solution by cooling the metal support in a cooling drum method, a poor solvent, alcohol may be more in the skin layer than in the core layer, and this is also a preferred embodiment. Tg may differ between the skin layer and the core layer. Preferably, Tg of the skin layer is lower than that of the core layer. The viscosity of the cellulose acylate solution to be cast may differ between the skin layer and the core layer. Preferably, the viscosity of the solution for the skin layer is smaller than that for the core layer; however, the viscosity of the solution for the core layer may be smaller than that for the skin layer.

In the producing method of the invention, adding the retardation-controlling agent to at least one of the dope for the core layer or the dope for the skin B layer makes it possible to produce the cellulose acylate laminate film which fluctuation of retardation thereof is reduced. Preferable embodiment of adding the retardation-controlling agent to each layer may be to control the amount of the retardation-controlling agent in the dope for each layer as the amount of the retardation-controlling agent is preferable for each layer of the film of the invention.

In the producing method of the invention, the multilayer-cast dope is dried and then peeled from the support.

### (Drying)

A method of drying the web that is dried on a drum or belt and is peeled away from it is described. The web peeled away at the peeling position just before one lap of the drum or the belt is conveyed according to a method where the web is led to pass alternately through rolls disposed like a houndstooth check, or according to a method where the peeled web is conveyed in a non-contact mode while both sides of the web are held by clips or the like. The drying may be attained according to a method where air at a predetermined temperature is given to both surfaces of the web (film) being conveyed, or according to a method of using a heating means such as microwaves, etc. Rapid drying may damage the surface smoothness of the formed film. Therefore, in the initial stage of drying, the web is dried at a temperature at which the solvent does not bubble, and after having gone on in some degree, the drying may be preferably attained at a high temperature. In the drying step after peeled away from the support, the film tends to shrink in the machine direction or in the cross direction owing to solvent evaporation. The shrinkage may be larger in drying at a higher temperature. Preferably, the shrinkage is inhibited as much as possible for bettering the surface condition of the film to be formed. From this viewpoint, for example, preferred is a method (tenter method) where the entire drying step or a part of the drying step is carried out with both sides of the web held with clips or pins so as to keep the width of the web, as in JP-A 62-46625. The drying temperature in the drying step is preferably from 100 to 145° C. The drying temperature, the drying air amount and the drying time may vary depending on the solvent used, and are therefore suitably selected in accordance with the type and the combination of the solvent to be used. In producing the film of the invention, the web (film) peeled away from the support is stretched preferably when the residual solvent amount in the web is less than 120% by mass.

The residual solvent amount may be represented by the following formula:

Residual Solvent Amount (% by mass)={(M−N)/N}100

wherein M means the mass of the web at an undefined point, and N means the mass of the web having the mass M, dried at 110° C. for 3 hours. When the residual solvent amount in the web is too much, then the web could not enjoy the effect of its stretching; but when too small, stretching the web is extremely difficult, and the web may be broken. More preferably, the residual solvent amount in the web is from 10 to 50% by mass, even more preferably from 12 to 35% by mass. In case where the draw ratio in stretching is too small, the film could not have a sufficient retardation; but when too large, the film could not be stretched and would be broken.

### (Stretching)

The producing method of the invention includes a step of stretching the peeled film, after the step of drying the multilayer-cast dope and peeling it from the support.

In the invention, the film produced according to a solution casting method and having a residual solvent amount falling within a specific range can be stretched, not heated at a high temperature; however, preferably, the film is stretched while dried, as the processing process may be shortened. That is, in the invention, the peeled film may be stretched while the residual solvent is exist or after the peeled film has dried. However, when the temperature of the web is too high, then the plasticizer may evaporate away, and therefore, the temperature range is preferably from room temperature (15° C.) to 145° C. A method of stretching the film in two directions perpendicular to each other is effective for controlling the film refractivity, Nx, Ny and Nz to fall within the range of the invention. For example, when the film is stretched in the casting direction and when the shrinkage in the cross direction is too large, then the value Nz may increase too much. In this case, the problem may be solved by reducing the cross shrinkage of the film and by stretching the film in the cross direction. In case where the film is stretched in the cross direction, the film may have a refractivity distribution in the cross direction. This often occurs, for example, when a tenter method is employed for film stretching. This is a phenomenon to be caused by the generation of the shrinking force in the center part of the film while the edges of the film are kept fixed, and this may be considered as a so-called bowing phenomenon. Also in this case, the bowing phenomenon can be prevented by stretching the film in the casting direction, whereby the retardation distribution in the cross direction can be reduced. Further, by stretching the film in two directions perpendicular to each other, the film thickness fluctuation may be reduced. When the film thickness fluctuation of a cellulose acylate film is too large, then the distribution fluctuation thereof may also be large. The film thickness fluctuation of the cellulose acylate film is preferably within a range of ±3%, more preferably within a range of ±1%. For the above-mentioned objects, the method of stretching the film in two directions perpendicular to each other is effective, and the draw ratio in stretching in two directions perpendicular to each other is preferably from 1.2 to 2.0 times in one direction and from 0.7 to 1.0 time in the other direction. The mode of stretching the film by from 1.2 to 2.0 times in one direction and by from 0.7 to 1.0 time in the other direction means that the distance between the clips and the pins supporting the film is made to be from 0.7 to 1.0 times the distance therebetween before the stretching.

In general, in case where the film is stretched in the cross direction by 1.2 to 2.0 times, using a biaxial stretching tenter, a shrinking force acts on the perpendicular direction thereof, or that is, on the machine direction of the film.

Accordingly, when the film is stretched while a force is kept applied only in one direction, then the width of the film in the other direction perpendicular to that one direction may shrink. The method means that the shrinking degree is controlled without control of the width of the film, or that is, this means that the distance between the clips or the pins for width control is defined to be from 0.7 to 1.0 time the distance therebetween before stretching. In this case, a force of shrinking the film in the machine direction acts on the film owing to the stretching in the cross direction. The distance kept between the clips or the pins in the machine direction makes it possible to prevent any unnecessary tension from being given to the film in the machine direction thereof. The method of stretching the web is not specifically defined. For example, there are mentioned a method of providing plural rolls each running at a different peripheral speed and stretching the film in the machine direction based on the peripheral speed difference between the rolls, a method of holding both sides of the web with clips or pins and expanding the distance between the clips or pins in the machine direction to thereby stretch the film in the machine direction, or expanding the distance therebetween in the cross direction to thereby stretch the film in the cross direction, and a method of expanding the distance both in the machine direction and in the cross direction to thereby stretch film in both the machine and cross directions. Needless-to-say, these methods may be combined. In the so-called tenter method, preferably, the clip parts are driven according to a linear driving system, by which the film may be smoothly stretched with little risk of breaking, etc.

The producing method of the invention preferably includes a step of again stretching the film after the step of peeling and stretching the film, from the view point of improving the optical expressibility, particularly enlarging the optical expressibility range by reducing the Nz factor, etc.

### [Polarizer]

The cellulose acylate laminate film of the invention is preferably for use in the retardation film of a polarizer for its high optical expressibility.

The polarizer of the invention includes the cellulose acylate laminate film of the invention. As mentioned above, a polarizer is constructed by laminating a polarizer-protective film on at least one surface of a polarizing element. The polarizing element may be any conventional one. For example, this is prepared by processing a hydrophilic polymer film such as a polyvinyl alcohol film with a dichroic dye such as iodine. Not specifically defined, the cellulose acylate laminate film may be stuck to the polarizing element in any desired manner, for which, for example, an adhesive of an aqueous solution of a water-soluble polymer may be used. Preferably, the water-soluble polymer adhesive is an aqueous solution of completely-saponified polyvinyl alcohol.

Preferred embodiments of the constitution of the polarizer of the invention include a constitution of polarizer-protective film/polarizing element/polarizer-protective film/liquid crystal cell/cellulose acylate laminate film of the invention/polarizing element/polarizer-protective film; or a constitution of polarizer-protective film/polarizing element/cellulose acylate laminate film of the invention/liquid crystal cell/cellulose acylate laminate film of the invention/polarizing element/polarizer-protective film. In particular, the polarizer of the invention is favorably stuck to a TN-mode, VA-mode or OCB-mode liquid crystal cell, thereby constructing liquid crystal displays excellent in viewing angle and visibility with little coloration. In particular, the polarizer comprising the cellulose acylate laminate film of the invention is excellent in the low degradation under high-temperature high-humidity condition, and therefore can maintain stable performance for a long period of time under high-temperature high-humidity condition.

### [Liquid Crystal Display Device]

The cellulose acylate laminate film and the polarizer comprising the film of the invention are usable in liquid crystal cells and liquid crystal display devices of various display modes. For these, proposed are various modes of TN (twisted nematic), IPS (in-plane switching), FLC (ferroelectric liquid crystal), AFLC (anti-ferroelectric liquid crystal), OCB (optically compensatory bend), STN (super twisted nematic), VA (vertically aligned) and HAN (hybrid aligned nematic) modes.

The OCB-mode liquid-crystal cell is a bend-alignment mode liquid crystal cell, in which the rod-shaped liquid-crystal molecules in the upper part of the liquid-crystal cell and those in the lower part thereof are aligned in the direction substantially oppositely (symmetrically) to each other. The OCB-mode liquid-crystal cell is disclosed in U.S. Pat. Nos. 4,583,825 and 5,410,422. Since the rod-shaped liquid-crystal molecules are aligned symmetrically between the upper part and the lower part of the liquid-crystal cell therein, the bend-alignment mode liquid-crystal cell has a self-optically compensating function. The bend-alignment mode liquid-crystal display device has the advantage of rapid response speed.

In the VA-mode liquid crystal cell, rod-shaped liquid crystal molecules are aligned substantially vertically under no voltage application.

The VA-mode liquid crystal cell includes, in addition to (1) the VA-mode liquid crystal cell of a narrow sense, where rod-shaped liquid crystal molecules are aligned substantially vertically under no voltage application and are aligned horizontally under voltage application (described in JP-A 2-176625), (2) a multidomained VA-mode (MVA-mode) liquid crystal cell with enlarged viewing angles (in SID 97, Digest of Tech. Papers (preprints) 28 (1997), 845), (3) a liquid crystal cell of an n-ASM mode in which the rod-shaped liquid crystal molecules are aligned substantially vertically under no voltage application and are aligned in twisted multi-domains under voltage application (in Sharp Technical Report, No. 80, p. 11), and (4) a liquid crystal cell of a SURVIVAL mode (in Monthly Journal of Display, May, p. 14 (1999)).

The VA-mode liquid crystal display device contains a liquid crystal cell and two polarizers disposed on both sides thereof. The liquid crystal cell carries a liquid crystal between two electrode substrates. In one embodiment of a transmission-type liquid crystal display device of the invention, one film of the invention is disposed between the liquid crystal cell and one polarizer, or two films of the invention are between the liquid crystal cell and both polarizers.

In another embodiment of a transmission-type liquid crystal display device of the invention, an optically-compensatory sheet comprising the film of the invention is used as the transparent protective film of the polarizer to be disposed between the liquid crystal cell and the polarizing element. The optically-compensatory sheet may be used as only the protective film for one polarizer (between the liquid crystal cell and the polarizing element), or the optically-compensatory sheet may be used as the two protective films for both polarizers (between the liquid crystal cell and the polarizing element). In case where the optically-compensatory sheet is used only for one polarizer, preferably, the sheet serves as the protective film on the liquid crystal cell side of the backlight-side polarizer adjacent to the liquid crystal cell. When stuck to the liquid crystal cell, preferably, the film of the invention is on the VA-cell side. The protective film may be any ordinary cellulose film, and is preferably thinner than the film of the invention. For example, its thickness is preferably from 40 to 80 μm. Not limited thereto, the film includes commercial KC4UX2M (by Konica-Opto, 40 μm), KC5UX (by Konica-Opto, 60 μm), TD80 (by FUJIFILM, 80 μm), etc.

### EXAMPLES

The characteristics of the invention are described more concretely with reference to the following Examples. In the following Examples, the material used, its amount and the ratio, the details of the treatment and the treatment process may be suitably modified or changed. Accordingly, the invention should not be limitatively interpreted by the Examples mentioned below.

### (Preparation of Cellulose Acylate)

According to the method described in JP-A 10-45804 and 08-231761, a cellulose acylate was produced, and its degree of substitution was measured. Concretely, as a catalyst, sulfuric acid was added in an amount of 7.8 parts by mass relative to 100 parts by mass of cellulose, and a carboxylic acid as a material for the acyl group was added for acylation at 40° C. In this process, the type and the amount of the carboxylic acid were controlled to thereby control the type and the degree of acyl substitution. After the acylation, the product was ripened at 40° C. The low-molecular-weight ingredient of the cellulose acylate was washed away with acetone.

### Example 1 to 19

A cellulose acylate dope mentioned below was prepared and was a dope for the core layer.

(Preparation of Cellulose Acylate Dope for the Core Layer)

| | | |
|---|---|---|
| Cellulose acylate resin: shown in Table 1 below | 100 | mas. pts. |
| Retardation enhancer: shown in Table 1 below, | | |
| in an amount shown in Table 2 (unit, mas. pt.). | | |
| Dichloromethane | 406 | mas. pts. |
| Methanol | 61 | mas. pts. |

(Preparation of Cellulose Acylate Dope for the Skin B Layer)

| | | |
|---|---|---|
| Cellulose acylate resin: shown in Table 1 below | 100 | mas. pts. |
| Matting agent: compound G shown below | 0.05 | mas. pts. |
| Release promoter: compound H shown below | 0.03 | mas. pts. |
| Dichloromethane | 406 | mas. pts. |
| Methanol | 61 | mas. pts. |

(Preparation of Cellulose Acylate Dope for the Skin A Layer)

| | | |
|---|---|---|
| Cellulose acylate resin: shown in Table 1 below | 100 | mas. pts. |
| Retardation enhancer: shown in Table 1 below, | | |
| in an amount shown in Table 2 (unit, mas. pt.). | | |
| Matting agent: compound G shown below | 0.05 | mas. pts. |
| Dichloromethane | 406 | mas. pts. |
| Methanol | 61 | mas. pts. |

TABLE 1

| | Total degree of | Degree of | Degree of |
|---|---|---|---|
| Cellulose | acyl | acetyl | propionyl |
| acylate | substitution Z | substitution X | substitution Y |
| DAC1 | 2.45 | 2.45 | 0 |
| DAC2 | 2.15 | 2.15 | 0 |
| DAC3 | 2.65 | 2.65 | 0 |
| CAP1 | 2.38 | 1.54 | 0.84 |
| TAC1 | 2.82 | 2.82 | 0 |
| TAC2 | 2.93 | 2.93 | 0 |

### (Re Enhancer)

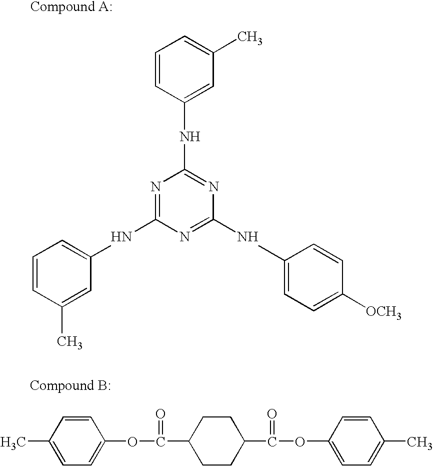

Compound C: terephthalic acid/succinic acid/ethylene glycol copolymer in a copolymerization ratio of 1/1/2, having a molecular weight of 2000.

### (Rth Reducer)

Compound D: triphenyl phosphate/biphenyldiphenyl phosphate copolymer in a copolymerization ratio of 1/1.

Compound E: methyl methacrylate, having a molecular weight of 1200.

Compound F: succinic acid/adipic acid/ethylene glycol copolymer in a copolymerization ratio of 3/2/5, having a molecular weight of 2000.

### (Matting Agent)

Compound G: Nippon Aerosil's Aerosil 972 (trade name, silicon dioxide particles having a mean particle size of 15 nm and a Mohs hardness of about 7).

### (Release Promoter)

Release Promoter: partial ethyl ester of citric acid.

### (Solution Casting)

Each cellulose acylate dope was put into a mixing tank, and stirred to dissolve the constitutive ingredients, and then each was filtered through a paper filter having a mean pore size of 34 μm and through a sintered metal filter having a mean pore size of 10 μm, thereby preparing each cellulose acylate dope.

Next, the core layer dope, the skin A layer dope and the skin B layer dope thus prepared in the manner as above were cast to produce films of Examples.

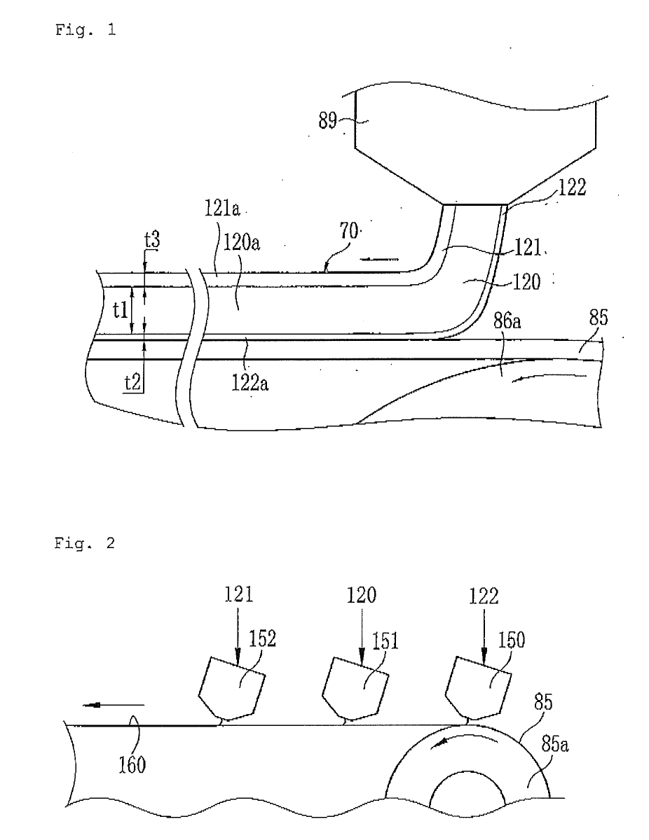

These three dopes were co-cast onto the running casting band 85 through the casting die 89, as in FIG. 1. In this multilayer casting process, the casting rate of each dope was controlled so that the thickness of the core layer could be the largest and that the thickness of the stretched film could be as shown in Table 2 and Table 3 below, thereby producing the cast film 70. The width of the film is shown in Table 3 below.

Next, the cast film 70 was peeled away from the casting band 85 to be a wet film 75. Then this was dried in the transfer zone 77 and the tenter 78 to be a film 76. The film 76 was fed to the drying chamber 80, in which it was fully dried while being wound around and transferred by a large number of rollers 105. Finally, this was wound up around the winding roller 110 in the winding chamber 82 to be a film product 76. Just after peeled, the dope had a residual solvent content of about 30% by mass.

### (Stretching)

Using a tenter, the width of the film was expanded to a draw ratio of 30%, and then relaxed at 140° C. for 60 seconds, thereby giving a cellulose acylate laminate film. The film thickness was shown in Table 2 and 3 below.

### (Evaluation of Film Properties)

The properties of the cellulose acylate laminate films were evaluated according to the methods mentioned below. The results were shown in Table 3 below.

### (Retardation)

Using KOBRA 21ADH (by Oji Scientific Instruments) and according to the method mentioned in the above, Re and Rth was determined. Nz factor was calculated with the determined Re and Rth. The fluctuation of Re and Rth of the film were also measured according to the method mentioned in the above.

### (Releasability)

The releasability of the films of Examples was evaluated according to the evaluation criteria mentioned below.
5: The film peeled very well, and after peeled, the film had no visible optical unevenness.
4: The film peeled well, and after peeled, the film had a little visible optical unevenness.
3: The film peeled, and after peeled, the film had no visible streaky thickness unevenness but had some visible optical unevenness.
2: The film did not peel well, and after peeled, the film had visible streaky thickness unevenness.
1: The film peeled very poorly, and while peeled, the film was partly stretched.

### Comparative Examples 1 to 4

Films of Comparative Examples were produced in the same manner as in Examples, for which, however, the dopes and the filming conditions were changed as in Table 2 below. The properties of the films were evaluated like in Examples. The results are shown in Table 3 below.

TABLE 2

| | Core layer | | | | Skin B layer | | | | | |
|---|---|---|---|---|---|---|---|---|---|---|
| | | Retardation | | | | Retardation | | Matting | Release | |
| | | controlling agent | | | | controlling agent | | agent | promoter | |
| | | | Amount | | | | Amount | (parts | (parts | |
| | Cellulose | | (parts by | Thickness | Cellulose | | (parts by | by | by | Thickness |
| | Acylate | Type | weight) | (μm) | Acylate | Type | weight) | weight) | weight) | (μm) |
| Comp. EX. 1 | DAC1 | — | | 45 | Nothing | | | | | |
| Comp. EX. 2 | DAC1 | — | | 45 | TAC1 | — | | — | — | 0.2 |
| Example 1 | DAC1 | — | | 45 | TAC1 | — | | — | — | 2 |
| Example 2 | DAC1 | — | | 43 | TAC1 | A | 4 | — | — | 2 |
| Example 3 | DAC1 | — | | 41 | TAC1 | A | 4 | — | — | 2 |
| Example 4 | DAC1 | D | 10 | 43 | TAC1 | A | 4 | — | — | 2 |
| Example 5 | DAC1 | D | 10 | 41 | TAC1 | A | 4 | Nothing | 0.05 | 2 |
| Example 6 | DAC1 | D | 10 | 41 | TAC1 | A | 4 | 0.12 | 0.05 | 2 |
| Example 7 | DAC1 | D | 10 | 41 | TAC1 | A | 4 | 0.12 | 0.05 | 2 |
| Example 8 | DAC1 | E | 15 | 41 | TAC1 | A | 4 | 0.12 | 0.05 | 2 |
| Example 9 | DAC1 | F | 20 | 41 | TAC1 | A | 4 | 0.12 | 0.05 | 2 |
| Example 10 | DAC2 | D | 10 | 41 | TAC1 | A | 4 | 0.12 | 0.05 | 2 |
| Example 11 | DAC3 | E | 15 | 41 | TAC1 | A | 4 | 0.12 | 0.05 | 2 |
| Example 12 | DAC3 | F | 20 | 41 | TAC1 | A | 4 | 0.12 | 0.05 | 2 |
| Example 13 | DAC1 | A | 2 | 39 | TAC2 | B | 4 | 0.12 | 0.05 | 3 |
| Example 14 | DAC1 | A | 2 | 39 | TAC2 | C | 4 | 0.12 | 0.05 | 3 |
| Comp. EX. 3 | CAP1 | A | 2 | 39 | Nothing | | | | | |
| Example 15 | CAP1 | A | 2 | 39 | TAC2 | B | 4 | 0.12 | 0.05 | 3 |
| Example 16 | DAC1 | A | 3 | 39 | TAC2 | C | 4 | 0.12 | 0.05 | 3 |
| | | F | 10 | | | | | | | |
| Example 17 | DAC1 | A | 3 | 42 | TAC2 | C | 4 | 0.12 | 0.05 | 1 |
| | | F | 10 | | | | | | | |
| Example 18 | DAC1 | A | 3 | 40 | TAC2 | C | 4 | 0.12 | 0.05 | 5 |
| | | F | 10 | | | | | | | |
| Example 19 | DAC1 | A | 3 | 68 | TAC2 | C | 4 | 0.12 | 0.05 | 5 |
| | | F | 10 | | | | | | | |
| Comp. EX. 4 | TAC1 | D | 10 | 52 | TAC1 | A | 4 | Nothing | 0.05 | 2 |

| | Skin A layer | | | | |
|---|---|---|---|---|---|
| | | Retardation | | Matting | |
| | | controlling agent | | agent | |
| | | | Amount | (parts | |
| | Cellulose | | (parts by | by | Thickness |
| | Acylate | Type | weight) | weight) | (μm) |
| Comp. EX. 1 | Nothing | | | | |
| Comp. EX. 2 | Nothing | | | | |
| Example 1 | Nothing | | | | |
| Example 2 | Nothing | | | | |
| Example 3 | TAC1 | A | 4 | Nothing | 2 |
| Example 4 | Nothing | | | | |
| Example 5 | TAC1 | A | 4 | 0.12 | 2 |
| Example 6 | TAC1 | A | 4 | 0.12 | 2 |
| Example 7 | TAC1 | A | 4 | 0.12 | 2 |
| Example 8 | TAC1 | A | 4 | 0.12 | 2 |
| Example 9 | TAC1 | A | 4 | 0.12 | 2 |
| Example 10 | TAC1 | A | 4 | 0.12 | 2 |
| Example 11 | TAC1 | A | 4 | 0.12 | 2 |
| Example 12 | TAC1 | A | 4 | 0.12 | 2 |
| Example 13 | TAC2 | B | 4 | 0.12 | 3 |
| Example 14 | TAC2 | C | 4 | 0.12 | 3 |
| Comp. EX. 3 | Nothing | | | | |
| Example 15 | TAC2 | B | 4 | 0.12 | 3 |
| Example 16 | TAC2 | C | 4 | 0.12 | 3 |
| Example 17 | TAC2 | C | 4 | 0.12 | 2 |
| Example 18 | TAC2 | C | 4 | 0.12 | 15 |
| Example 19 | TAC2 | C | 4 | 0.12 | 7 |
| Comp. EX. 4 | TAC1 | A | 4 | 0.12 | 2 |

TABLE 3

| | Film | | | | | | | |
|---|---|---|---|---|---|---|---|---|
| | Optical properties | | | | | | | |
| | Re | Rth | | ΔRe | ΔRth | Thickness | Width | |
| | (mm) | (mm) | Nz factor | (mm) | (mm) | (μm) | (mm) | Releasability |
| Comp. EX. 1 | 40 | 108 | 3.2 | 14 | 16 | 45 | 1950 | 1 |
| Comp. EX. 2 | 42 | 110 | 3.1 | 13 | 15 | 45 | 1950 | 2 |
| Example 1 | 42 | 110 | 3.1 | 10 | 11 | 47 | 2500 | 3 |
| Example 2 | 45 | 122 | 3.2 | 6 | 7 | 45 | 2500 | 4 |
| Example 3 | 46 | 122 | 3.2 | 6 | 6 | 45 | 2500 | 4 |
| Example 4 | 45 | 115 | 3.1 | 6 | 8 | 45 | 2500 | 4 |
| Example 5 | 43 | 115 | 3.2 | 5 | 7 | 45 | 2500 | 5 |
| Example 6 | 42 | 113 | 3.2 | 5 | 8 | 45 | 2500 | 5 |
| Example 7 | 44 | 112 | 3 | 5 | 7 | 45 | 2500 | 5 |
| Example 8 | 43 | 120 | 3.3 | 7 | 8 | 45 | 2500 | 5 |
| Example 9 | 48 | 118 | 3 | 5 | 7 | 45 | 2500 | 5 |
| Example 10 | 45 | 115 | 3.1 | 6 | 5 | 45 | 2500 | 5 |
| Example 11 | 44 | 118 | 3.2 | 5 | 5 | 45 | 2500 | 5 |
| Example 12 | 55 | 134 | 2.9 | 4 | 4 | 45 | 2500 | 5 |
| Example 13 | 58 | 130 | 2.7 | 6 | 7 | 45 | 2500 | 5 |
| Example 14 | 54 | 130 | 2.9 | 5 | 6 | 45 | 2500 | 5 |
| Comp. EX. 3 | 62 | 143 | 2.8 | 11 | 14 | 39 | 2500 | 1 |
| Example 15 | 60 | 141 | 2.9 | 5 | 7 | 45 | 2500 | 5 |
| Example 16 | 55 | 125 | 2.8 | 3 | 3 | 45 | 2500 | 5 |
| Example 17 | 50 | 120 | 2.9 | 3 | 4 | 45 | 2500 | 5 |
| Example 18 | 62 | 165 | 3.2 | 5 | 9 | 60 | 2500 | 5 |
| Example 19 | 65 | 212 | 3.8 | 6 | 8 | 80 | 3000 | 5 |
| Comp. EX. 4 | 14 | 60 | 4.8 | 6 | 5 | 56 | 2500 | 5 |

Table 3 confirms that Examples 1 to 19 of the invention gave good cellulose acylate laminate films all having high Re and Rth with little optical unevenness of ΔRe and ΔRth, and the films all peeled well from the support.

On the other hand, the film of Comparative Example 1 was produced by single casting of cellulose acylate DAC1 alone having a low degree of substitution, and its releasability was extremely bad. In addition, it had large ΔRe and ΔRth. The film of Comparative Example 2 was produced by co-casting of a low-substitution cellulose acylate DAC1 as a core layer and a high-substitution cellulose acylate TAC1 as a skin B layer, in which, however, a retardation-controlling agent was not added to any of the core layer dope and the skin B layer dope. The releasability of the film was slightly improved, but ΔRe and ΔRth thereof were both large. The film of Comparative Example 3 was produced by single casting of a cellulose acetate propionate CAP1 alone as a core layer to which a retardation-controlling agent was added. Its ΔRe and ΔRth were slightly improved, but its releasability was extremely bad. The film of Comparative Example 4 is an embodiment of a core layer of TAC1, that is, all the core layer, the skin B layer and the skin A layer of the film were formed of the cellulose triacetate TAC1, and a retardation-controlling agent was added to every layer. However, the optical expressibility of the film was bad.

The above-mentioned three types of dopes were co-cast onto the running casting band 85 through the casting die 89, as in FIG. 2. In this successive multilayer casting process, the casting rate of each dope was controlled so that the thickness of the core layer could be the largest and that the thickness of the stretched film could be as shown in Table 2 and Table 3 below, thereby producing the cast film 70. Thus produced film was also evaluated in the same manner as above, and its evaluation results were the same as above.

The present disclosure relates to the subject matter contained in Japanese Patent Application No. 224959/2008 filed on Sep. 2, 2008, which is expressly incorporated herein by reference in its entirety. All the publications referred to in the present specification are also expressly incorporated herein by reference in their entirety.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined claims set forth below.

What is claimed is:

1. A cellulose acylate laminate film containing a core layer and a skin B layer, in which:
the core layer is thicker than the skin B layer
the core layer contains a cellulose acylate satisfying the following formula (1):
2.0<Z1<2.7, (1)
wherein Z1 means a total degree of acyl substitution of the cellulose acylate of the core layer,
the skin B layer contains cellulose acylate satisfying the following formula (2):
2.7<Z2, (2)
wherein Z2 means a total degree of acyl substitution of the cellulose acylate of the skin layer,
at least one of the core layer and the skin B layer contains a retardation-controlling agent, and
the film is stretched.

2. The cellulose acylate laminate film according to claim 1, wherein the skin B layer contains a retardation enhancer.

3. The cellulose acylate laminate film according to claim 1, wherein the core layer contains a retardation enhancer, and the skin B layer contains a retardation enhancer having a retardation-enhancing ability higher than that of the retardation enhancer in the core layer.

4. The cellulose acylate laminate film according to claim 1, wherein the core layer contains a retardation reducer.

5. The cellulose acylate laminate film according to claim 2, wherein the skin B layer contains a retardation reducer.

6. The cellulose acylate laminate film according to claims 1, which has a skin A layer containing a cellulose acylate satisfying the following formula (2), on the side of the core layer opposite to the skin layer B:
2.7<Z2, (2)
wherein Z2 means a total degree of acyl substitution of the cellulose acylate of the skin layer.

7. The cellulose acylate laminate film according to claims 1, wherein the in-plane retardation, Re, at a wavelength of 590 nm satisfies 25 nm≦|Re|≦100 nm, and the thickness-direction retardation, Rth, at a wavelength of 590 nm satisfies 50 nm≦|Rth|≦250 nm.

8. The cellulose acylate laminate film according to claims 1, wherein at least one skin layer contains at least one in-plane retardation enhancer.

9. The cellulose acylate laminate film according to claims 1, wherein the core layer contains at least one thickness-direction retardation reducer.

10. The cellulose acylate laminate film according to claims 1, wherein at least one skin layer contains at least one in-plane retardation enhancer and the core layer contains at least one thickness-direction retardation reducer.

11. The cellulose acylate laminate film according to claims 1, wherein the core layer has a mean thickness of from 30 to 100 μm, and at least one of the skin A layer and the skin B layer has a mean thickness of from 0.2% to less than 25% of the mean thickness of the core layer.

12. The cellulose acylate laminate film according to claims 1, wherein the film width is from 700 to 3000 mm and the fluctuation of the in-plane retardation of the film in the film width direction is at most 10 nm.

13. The cellulose acylate laminate film according to claims 1, wherein the fluctuation of the thickness-direction retardation of the film in the film width direction is at most 10 nm.

14. The cellulose acylate laminate film according to claims 1, wherein at least one of the skin A layer and the skin B layer contains a matting agent.

15. The cellulose acylate laminate film according to claims 1, wherein the cellulose acylate of the core layer satisfies the following formulae (3) and (4):
1.0<X1<2.7, (3)
wherein X1 means a degree of acetyl substitution of the cellulose acylate of the core layer,
0≦Y1<1.5, (4)
wherein Y1 means a total degree of substitution with acyl having at least 3 carbon atoms of the cellulose acylate of the core layer.

16. The cellulose acylate laminate film according to claims 1, wherein the cellulose acylate of the skin A layer and the cellulose acylate of the skin B layer satisfy the following formulae (5) and (6):
1.2<X2<3.0, (5)
wherein X2 means a degree of acetyl substitution of the cellulose acylate of each skin layer,
0≦Y2<1.5, (6)
wherein Y2 means a total degree of substitution with acyl having at least 3 carbon atoms of the cellulose acylate of each skin layer.

17. The cellulose acylate laminate film according to claim 1, wherein the acyl group of the cellulose acylate has from 2 to 4 carbon atoms.

18. The cellulose acylate laminate film according to claim 1, which has an Nz factor represented by the following formula (7) of at most 7:
Nz factor=(Rth/Re)+0.5. (7)

19. The cellulose acylate film according to claim 1, wherein the cellulose acylate is a cellulose acetate.

20. The cellulose acylate laminate film according to claims 1, wherein the skin B layer contains a release promoter.

21. A method for producing a cellulose acylate laminate film, comprising:
simultaneously or successively multilayer-casting a dope for a skin B layer containing a cellulose acylate satisfying the following formula (2) and a dope for a core layer containing a cellulose acylate satisfying the following formula (1) on a support in that order,
drying the multilayer-cast dope and peeling it from the support, and
stretching the peeled film,
wherein at least one of the dope for the core layer and the dope for the skin B layer contains a retardation-controlling agent:
2.0<Z1<2.7, (1)
wherein Z1 means a total degree of acyl substitution of the cellulose acylate of the core layer,
2.7<Z2, (2)
wherein Z2 means a total degree of acyl substitution of the cellulose acylate of the skin layer.

22. The method for producing a cellulose acylate laminate film according to claim 21, which comprises stretching the film again after peeling and stretching the film.

23. A cellulose acylate laminate film, produced by:
simultaneously or successively multilayer-casting a dope for a skin B layer containing a cellulose acylate satisfying the following formula (2) and a dope for a core layer containing a cellulose acylate satisfying the following formula (1) on a support in that order,
drying the multilayer-cast dope and peeling it from the support, and
stretching the peeled film,
wherein at least one of the dope for the core layer and the dope for the skin B layer contains a retardation-controlling agent:
2.0<Z1<2.7, (1)
wherein Z1 means a total degree of acyl substitution of the cellulose acylate of the core layer,
2.7<Z2, (2)
wherein Z2 means a total degree of acyl substitution of the cellulose acylate of the skin layer.

24. A polarizer containing a cellulose acylate laminate film containing a core layer and a skin B layer, in which:
the core layer is thicker than the skin B layer
the core layer contains a cellulose acylate satisfying the following formula (1):
2.0<Z1<2.7, (1)
wherein Z1 means a total degree of acyl substitution of the cellulose acylate of the core layer,
the skin B layer contains cellulose acylate satisfying the following formula (2):
2.7<Z2, (2)
wherein Z2 means a total degree of acyl substitution of the cellulose acylate of the skin layer,
at least one of the core layer and the skin B layer contains a retardation-controlling agent, and
the film is stretched.

25. A liquid crystal display device containing a cellulose acylate laminate film containing a core layer and a skin B layer, in which:
the core layer is thicker than the skin B layer
the core layer contains a cellulose acylate satisfying the following formula (1):
2.0<Z1<2.7, (1)
wherein Z1 means a total degree of acyl substitution of the cellulose acylate of the core layer,
the skin B layer contains cellulose acylate satisfying the following formula (2):
2.7<Z2, (2)
wherein Z2 means a total degree of acyl substitution of the cellulose acylate of the skin layer,
at least one of the core layer and the skin B layer contains a retardation controlling agent, and
the film is stretched.
